(19) United States
(12) Patent Application Publication
(10) Pub. No.: US 2026/0214215 A1
(43) Pub. Date: Jul. 23, 2026

(54) APPARATUS AND METHOD FOR ENCODING AND DECODING IMAGE BY USING INTRA PREDICTION

(71) Applicant: SAMSUNG ELECTRONICS CO., LTD., Suwon-si (KR)

(72) Inventors: Jeeyoon PARK, Suwon-si (KR); Minsoo PARK, Suwon-si (KR); Minwoo PARK, Suwon-si (KR); Kwangpyo CHOI, Suwon-si (KR)

(73) Assignee: SAMSUNG ELECTRONICS CO., LTD., Suwon-si (KR)

(21) Appl. No.: 19/566,388

(22) Filed: Mar. 13, 2026

Related U.S. Application Data
(63) Continuation of application No. PCT/KR2024/010379, filed on Jul. 18, 2024.

(30) Foreign Application Priority Data
Sep. 13, 2023 (KR) 10-2023-0122067
Apr. 16, 2024 (KR) 10-2024-0050953

(51) Int. Cl. H04N 19/11; H04N 19/176

(52) U.S. Cl. CPC H04N 19/11; H04N 19/176

(57) ABSTRACT

An image decoding method includes obtaining gradient information that satisfies a predetermined condition, from a plurality of previous blocks of an image decoded prior to a current block of the image, wherein the gradient information that satisfies the predetermined condition comprises a first value corresponding to at least one intra prediction mode, and a second value corresponding to an intensity of the first value; generating gradient information of the current block based on the gradient information that satisfies the predetermined condition; determining an intra prediction mode of the current block, based on the gradient information of the current block; generating a prediction block of the current block by performing intra prediction on the current block using the intra prediction mode of the current block; and reconstructing the current block based on the prediction block.

### CROSS-REFERENCE TO RELATED APPLICATIONS

This application is a continuation of International Application No. PCT/KR2024/010379, filed on Jul. 18, 2024, which is based on and claims priority Korean Provisional Application No. 10-2023-0122067, filed on Sep. 13, 2023, and Korean Patent Application No. 10-2024-0050953, filed on Apr. 16, 2024, in the Korean Ministry of Intellectual Property, the disclosures of which are incorporated by reference herein in their entireties.

### BACKGROUND

### 1. Field

The present disclosure relates to image encoding and decoding, and more particularly, to an apparatus and method for encoding and decoding an image by using intra prediction.

### 2. Description of Related Art

In image encoding and decoding, an image is split into blocks, and each of the blocks may be prediction encoded and prediction decoded via inter prediction or intra prediction.

Inter prediction refers to a technology for compressing an image by removing temporal redundancy between images. In the inter prediction, blocks of a current image may be predicted by using a reference image. A reference block that is most similar to a current block may be searched for in a predetermined search range within the reference image. The current block may be predicted based on the reference block, and a residual block may be generated by subtracting, from the current block, a prediction block generated as a result of the prediction.

In standards such as H.264 Advanced Video Coding (AVC) and High Efficiency Video Coding (HEVC), in order to predict a motion vector of a current block, a motion vector of previously-encoded blocks adjacent to the current block or blocks included in a previously-encoded image may be used as a motion vector predictor of the current block. A motion vector difference that is a difference between the motion vector and the motion vector predictor of the current block may be signaled to a decoder by using a predetermined scheme.

Intra prediction is a method of compressing an image by removing spatial redundancy within the image. In the intra prediction, a prediction block may be generated based on neighboring pixels of a current block according to an intra prediction mode. A residual block may be generated by subtracting the prediction block from the current block.

The residual block generated via the inter prediction or the intra prediction may be delivered to a decoder via transformation and quantization. The decoder may perform dequantization and inverse-transformation on the residual block, and may reconstruct the current block by combining the prediction block and the residual block of the current block. The decoder may remove artifacts within the reconstructed current block by filtering the reconstructed current block in a regular manner.

### SUMMARY

Provided are an image encoding method and apparatus and an image decoding method and apparatus which may improve performance of prediction encoding and prediction decoding with respect to a current block.

Further, provided are an image encoding method and apparatus and an image decoding method and apparatus which may the amount of data required to signal an intra prediction mode.

Further, provided art an image encoding method and apparatus and an image decoding method and apparatus which may reduce a bit rate of a bitstream.

The technical features aimed to be achieved in the present disclosure are not limited to the aforementioned technical features, and other unstated technical features will be clearly understood by one of ordinary skill in the art in view of descriptions below.

According to an aspect of the disclosure, an image decoding method includes: obtaining gradient information that satisfies a predetermined condition, from a plurality of previous blocks of an image decoded prior to a current block of the image, wherein the gradient information that satisfies the predetermined condition includes a first value corresponding to at least one intra prediction mode, and a second value corresponding to an intensity of the first value; generating gradient information of the current block based on the gradient information that satisfies the predetermined condition; determining an intra prediction mode of the current block, based on the gradient information of the current block; generating a prediction block of the current block by performing intra prediction on the current block using the intra prediction mode of the current block; and reconstructing the current block based on the prediction block.

According to an aspect of the disclosure, an image decoding apparatus includes: at least one memory storing at least one instruction; and at least one processor, wherein the at least one instruction, when executed by the at least one processor individually or collectively, causes the image decoding apparatus to: obtain gradient information that satisfies a predetermined condition, from a plurality of previous blocks of an image decoded prior to a current block of the image, wherein the gradient information that satisfies the predetermined condition includes a first value corresponding to at least one intra prediction mode, and a second value corresponding to an intensity of the first value, generate gradient information of the current block based on the gradient information that satisfies the predetermined condition, determine an intra prediction mode of the current block, based on the gradient information of the current block, generate a prediction block of the current block by performing intra prediction on the current block using the intra prediction mode of the current block, and reconstruct the current block based on the prediction block.

According to an aspect of the disclosure, an image encoding method includes: obtaining gradient information that satisfies a predetermined condition, from a plurality of previous blocks of an image encoded prior to a current block of the image, wherein the gradient information that satisfies the predetermined condition includes a first value corresponding to at least one intra prediction mode, and a second value corresponding to an intensity of the first value; generating gradient information of the current block based on the gradient information that satisfies the predetermined condition; determining an intra prediction mode of the current block, based on the gradient information of the current block; generating a prediction block of the current block by performing intra prediction on the current block using the intra prediction mode of the current block; and encoding the current block based on the prediction block of the current block.

According to an aspect of the disclosure, an image encoding apparatus includes: at least one memory storing at least one instruction; and at least one processor, wherein the at least one instruction, when executed by the at least one processor individually or collectively, causes the image encoding apparatus to: obtain gradient information that satisfies a predetermined condition, from a plurality of previous blocks of an image encoded prior to a current block of the image, wherein the gradient information that satisfies the predetermined condition includes a first value corresponding to at least one intra prediction mode, and a second value corresponding to an intensity of the first value, generate gradient information of the current block based on the gradient information that satisfies the predetermined condition, determine an intra prediction mode of the current block, based on the gradient information of the current block, generate a prediction block of the current block by performing intra prediction on the current block using the intra prediction mode of the current block, and encode the current block based on the prediction block of the current block.

According to an aspect of the disclosure, a computer-readable recording medium has recorded thereon instructions that are executed by at least one processor to perform an image encoding method including: obtaining gradient information that satisfies a predetermined condition, from a plurality of previous blocks of an image encoded prior to a current block of the image, wherein the gradient information that satisfies the predetermined condition includes a first value corresponding to at least one intra prediction mode, and a second value corresponding to an intensity of the first value, generating gradient information of the current block based the gradient information that satisfies the predetermined condition, determining an intra prediction mode of the current block, based on the gradient information of the current block, generating a prediction block of the current block by performing intra prediction on the current block using the intra prediction mode of the current block, and encoding the current block based on the prediction block.

According to an aspect of the disclosure, a computer-readable recording medium has recorded thereon instructions that are executed by at least one processor to perform an image decoding method including: obtaining gradient information that satisfies a predetermined condition, from a plurality of previous blocks of an image decoded prior to a current block of the image, wherein the gradient information that satisfies the predetermined condition includes a first value corresponding to at least one intra prediction mode, and a second value corresponding to an intensity of the first value, generating gradient information of the current block based the gradient information that satisfies the predetermined condition, determining an intra prediction mode of the current block, based on the gradient information of the current block, generating a prediction block of the current block by performing intra prediction on the current block using the intra prediction mode of the current block, and reconstructing the current block based on the prediction block of the current block.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an image decoding apparatus according to an embodiment;

FIG. 2 illustrates a block diagram of an image encoding apparatus according to an embodiment;

FIG. 3 illustrates a process of determining at least one coding unit by splitting a current coding unit, according to an embodiment;

FIG. 4 illustrates a process of determining at least one coding unit by splitting a non-square coding unit, according to an embodiment;

FIG. 5 illustrates a process of splitting a coding unit based on at least one of block shape information and split shape mode information, according to an embodiment;

FIG. 6 illustrates a method of determining a predetermined coding unit from among an odd number of coding units, according to an embodiment;

FIG. 7 illustrates an order of processing a plurality of coding units when the plurality of coding units are determined by splitting a current coding unit, according to an embodiment;

FIG. 8 illustrates a process of determining that a current coding unit is to be split into an odd number of coding units, when the coding units are not processable in a predetermined order, according to an embodiment;

FIG. 9 illustrates a process of determining at least one coding unit by splitting a first coding unit, according to an embodiment;

FIG. 10 illustrates that a shape into which a second coding unit is splittable is restricted when the second coding unit having a non-square shape, which is determined when a first coding unit is split, satisfies a predetermined condition, according to an embodiment;

FIG. 11 illustrates a process of splitting a square coding unit when split shape mode information is unable to indicate that the square coding unit is split into four square coding units, according to an embodiment;

FIG. 12 illustrates that a processing order between a plurality of coding units may be changed depending on a process of splitting a coding unit, according to an embodiment;

FIG. 13 illustrates a process of determining a depth of a coding unit as a shape and size of the coding unit change, when the coding unit is recursively split such that a plurality of coding units are determined, according to an embodiment;

FIG. 14 illustrates depths that are determinable based on shapes and sizes of coding units, and part indexes (PIDs) that are for distinguishing the coding units, according to an embodiment;

FIG. 15 illustrates that a plurality of coding units are determined based on a plurality of predetermined data units included in a picture, according to an embodiment;

FIG. 16 illustrates coding units that may be determined in each picture when a combination of shapes into which a coding unit is splittable is different for each picture, according to an embodiment;

FIG. 17 illustrates various shapes of a coding unit which may be determined based on split shape mode information that may be represented in binary code, according to an embodiment;

FIG. 18 illustrates other shapes of a coding unit which may be determined based on split shape mode information that may be represented in binary code, according to an embodiment;

FIG. 19 is a block diagram of an image encoding and decoding system that performs loop filtering, according to an embodiment;

FIG. 20 is a block diagram illustrating a configuration of an image decoding apparatus according to an embodiment;

FIG. 21 is a diagram illustrating an intra prediction mode according to an embodiment;

FIG. 22 is a flowchart of an image decoding method according to an embodiment;

FIG. 23 is a diagram illustrating an example of a method of calculating a gradient, according to an embodiment;

FIG. 24 is a diagram illustrating a method of calculating a gradient, according to an embodiment;

FIG. 25 is a diagram for describing a method of generating gradient information, according to an embodiment;

FIG. 26 is a diagram illustrating a method of deriving an intra prediction mode from a neighboring block, according to an embodiment;

FIG. 27 is a diagram for describing a process of generating an intra prediction sample, according to an embodiment;

FIG. 28 is a diagram for describing a method of adaptively determining a weight, according to an embodiment;

FIG. 29 is a diagram for describing a method of storing gradient information, according to an embodiment;

FIG. 30 is a diagram for describing a method of generating gradient information of a current block by using gradient information of a previous block, according to an embodiment;

FIG. 31 is a diagram for describing a method of generating gradient information of a current block by using gradient information of a previous block, according to an embodiment;

FIG. 32 is a diagram for describing an intra prediction method of referring to gradient information of a previous block, according to an embodiment;

FIG. 33 is a diagram for describing a method of generating gradient information of a current block by using gradient information of a previous block, according to an embodiment;

FIG. 34 is a diagram for describing a method of generating gradient information of a current block by using gradient information of a previous block, according to an embodiment;

FIG. 35 is a diagram of an example of locations of spatial and temporal neighboring blocks, according to an embodiment;

FIG. 36 is a diagram for describing a method of referring to gradient information in an inter mode, according to an embodiment;

FIG. 37 is a diagram illustrating locations of neighboring blocks used in intra prediction, according to an embodiment;

FIG. 38 is a diagram illustrating an example of an intra prediction method for a chroma block, according to an embodiment;

FIG. 39 is a flowchart of an image decoding method, according to an embodiment;

FIG. 40 is a block diagram illustrating a configuration of an image encoding apparatus according to an embodiment; and

FIG. 41 is a flowchart of an image encoding method according to an embodiment.

### DETAILED DESCRIPTION

As the present disclosure allows for various changes and numerous embodiments, particular embodiments will be illustrated in the drawings and described in detail in the written descriptions. However, this is not intended to limit the present disclosure to particular modes of practice, and it is to be appreciated that all changes, equivalents, and substitutes that do not depart from the spirit and technical scope of the present disclosure are encompassed in the present disclosure.

In the descriptions of embodiments, detailed explanations of the related art may be omitted when it is deemed that they may unnecessarily obscure the essence of the present disclosure. Also, numerals (e.g., “first”, “second”, and the like) in descriptions of embodiments are used only to distinguish one element from another element.

Throughout the present disclosure, the expression “at least one of a, b or c” indicates only a, only b, only c, both a and b, both a and c, both b and c, or all of a, b, and c.

Throughout the specification, when an element is referred to as being “connected to” or “coupled with” another element, it can be directly connected to or coupled with the other element, or it can be indirectly connected to or coupled with the other element by having an intervening element interposed therebetween.

In the present specification, regarding an element represented as a “unit” or a “module”, two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another element.

In the present disclosure, an “image” may refer to a picture, a still image, a frame, a moving picture including a plurality of consecutive still images, or a video.

In the present disclosure, a “sample” may refer to data allocated to a sampling position of an image, i.e., data to be processed. For example, a pixel within a frame of a spatial domain may correspond to a sample. A unit including a plurality of samples may be defined as a block.

In the present disclosure, entropy decoding with respect to a block or a unit may indicate a process of obtaining a syntax element of the block or the unit from a bitstream (or bits included in the bitstream), or a process of obtaining a bin string corresponding to the syntax element.

In the present disclosure, entropy encoding with respect to a block or a unit may indicate a process of generating a bitstream (or bits included in the bitstream) from a syntax element of the block or the unit, or a process of generating the bitstream (or the bits included in the bitstream) from a bin string corresponding to the syntax element.

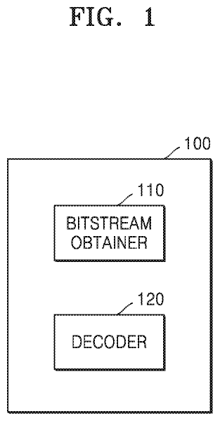

Hereinafter, with reference to FIGS. 1 to 41, an image encoding method and apparatus, and an image decoding method and apparatus, based on coding units and transform units of a tree structure, according to embodiments, will be described.

FIG. 1 illustrates a block diagram of an image decoding apparatus 100 according to an embodiment.

The image decoding apparatus 100 may include a bitstream obtainer 110 and a decoder 120. The bitstream obtainer 110 and the decoder 120 may include or be implemented as at least one processor. Also, the bitstream obtainer 110 and the decoder 120 may include memory storing instructions to be executed by the at least one processor.

The bitstream obtainer 110 may receive a bitstream. The bitstream includes information about an image encoded by an image encoding apparatus 200 to be described below. Also, the bitstream may be transmitted from the image encoding apparatus 200. The image encoding apparatus 200 and the image decoding apparatus 100 may be connected by wire or wirelessly, and the bitstream obtainer 110 may receive the bitstream by wire or wirelessly. The bitstream obtainer 110 may receive the bitstream from a storage medium such as an optical medium, a hard disk, or the like. The decoder 120 may reconstruct an image based on information obtained from the received bitstream. The decoder 120 may obtain, from the bitstream, a syntax element for reconstructing the image. The decoder 120 may reconstruct the image based on the syntax element.

According to detailed descriptions of an operation of the image decoding apparatus 100, the bitstream obtainer 110 may receive the bitstream.

The image decoding apparatus 100 may perform an operation of obtaining, from a bitstream, a bin string corresponding to a split shape mode of a coding unit. The image decoding apparatus 100 may perform an operation of determining a split rule of the coding unit. Also, the image decoding apparatus 100 may perform an operation of splitting the coding unit into a plurality of coding units, based on at least one of the bin string corresponding to the split shape mode and the split rule. The image decoding apparatus 100 may determine an allowable first range of a size of the coding unit, according to a height to width ratio of the coding unit, so as to determine the split rule. The image decoding apparatus 100 may determine an allowable second range of the size of the coding unit, according to the split shape mode of the coding unit, so as to determine the split rule.

Hereinafter, splitting of a coding unit will be described in detail according to an embodiment of the present disclosure.

First, one picture may be split into one or more slices or one or more tiles. One slice or one tile may be a sequence of one or more largest coding units (coding tree units (CTUs)). According to an embodiment, one slice may include one or more tiles, or one slice may include one or more CTUs. A slice including one or more tiles may be determined within a picture.

There is a largest coding block (coding tree block (CTB)) conceptually compared to a largest coding unit (CTU). The largest coding block (CTB) indicates an N×N block including N×N samples (where, N is an integer). Each color component may be split into one or more largest coding blocks.

A largest coding unit (CTU) of a case where a picture includes three sample arrays (sample arrays for Y, Cr, and Cb components) is a unit including a largest coding block of a luma sample, two corresponding largest coding blocks of chroma samples, and syntax structures used to encode the luma sample and the chroma samples. A largest coding unit of a case where a picture is a monochrome picture is a unit including a largest coding block of a monochrome sample and syntax structures used to encode the monochrome samples. A largest coding unit of a case where a picture is a picture encoded in color planes separated according to color components is a unit including syntax structures used to encode the picture and samples of the picture.

One largest coding block (CTB) may be split into M×N coding blocks including M×N samples (where, M and N are integers).

A coding unit (CU) of a case where a picture has sample arrays for Y, Cr, and Cb components is a unit including a coding block of a luma sample, two corresponding coding blocks of chroma samples, and syntax structures used to encode the luma sample and the chroma samples. A coding unit of a case where a picture is a monochrome picture is a unit including a coding block of a monochrome sample and syntax structures used to encode the monochrome samples. A coding unit of a case where a picture is a picture encoded in color planes separated according to color components is a unit including syntax structures used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a predetermined size including a predetermined number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, the present disclosure is not limited thereto.

For example, information about a largest size of a luma coding block may be obtained from a bitstream. For example, the largest size of the luma coding block indicated by the information about the largest size of the luma coding block may be one of 4×4, 8×8, 16×16, 32×32, 64×64, 128×128, and 256×256.

For example, information about a luma block size difference and a largest size of a luma coding block that may be split into two may be obtained from a bitstream. The information about the luma block size difference may refer to a size difference between a luma largest coding unit and a largest luma coding block that may be split into two. Accordingly, when the information about the largest size of the luma coding block that may be split into two and the information about the luma block size difference obtained from the bitstream are combined with each other, a size of the luma largest coding unit may be determined. A size of a chroma largest coding unit may be determined by using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a largest size of a luma coding block that is binary splittable is obtained from a bitstream, the largest size of the luma coding block that is binary splittable may be variably determined. In contrast, a largest size of a luma coding block that is ternary splittable may be fixed. For example, the largest size of the luma coding block that is ternary splittable in an I-picture may be 32×32, and the largest size of the luma coding block that is ternary splittable in a P-picture or a B-picture may be 64×64.

Also, a largest coding unit may be hierarchically split into coding units based on split shape mode information obtained from a bitstream. At least one of information indicating whether to perform quad splitting, information indicating whether to perform multi-splitting, split direction information, and split type information may be obtained as the split shape mode information from the bitstream.

For example, the information indicating whether to perform quad splitting may indicate whether a current coding unit is to be quad split (QUAD_SPLIT) or not.

When the current coding unit is not quad split, the information indicating whether to perform multi-splitting may indicate whether the current coding unit is to be no longer split (NO_SPLIT) or to be binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode SPLIT_TT_VER.

The image decoding apparatus 100 may obtain, from the bitstream, the bin string of the split shape mode information. A form of the bitstream received by the image decoding apparatus 100 may include fixed length binary code, unary code, truncated unary code, pre-determined binary code, or the like. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether not to split a coding unit, a split direction, and a split type, based on one bin string.

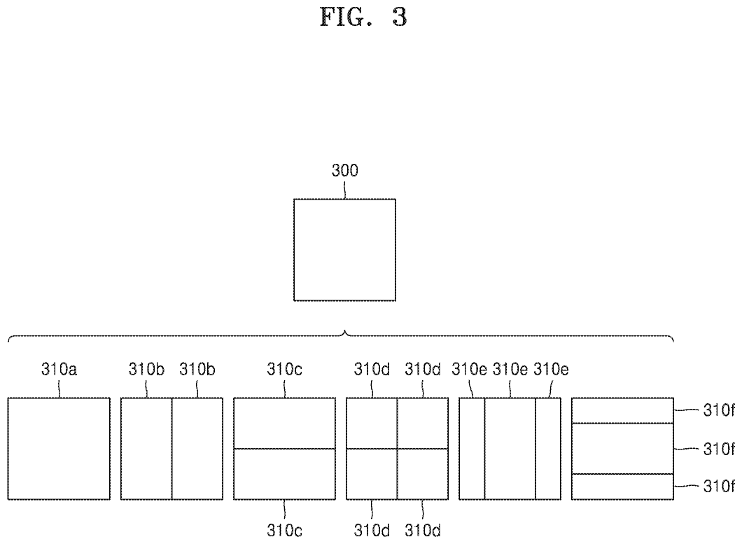

The coding unit may be smaller than or equal to the largest coding unit. For example, because a largest coding unit is a coding unit having a largest size, the largest coding unit is one of coding units. When split shape mode information about a largest coding unit indicates that splitting is not performed, a coding unit determined in the largest coding unit has the same size as that of the largest coding unit. When split shape mode information about a largest coding unit indicates that splitting is performed, the largest coding unit may be split into coding units. Also, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 to 16.

Also, one or more prediction blocks for prediction may be determined from a coding unit. The prediction block may be equal to or smaller than the coding unit. Also, one or more transform blocks for transformation may be determined from a coding unit. The transform block may be equal to or smaller than the coding unit.

The shapes and sizes of the transform block and prediction block may not be related to each other.

In another embodiment, prediction may be performed by using a coding unit as a prediction unit. Also, transformation may be performed by using a coding unit as a transform block.

The splitting of the coding unit will be described in detail with reference to FIGS. 3 to 16. A current block and a neighboring block of the present disclosure may indicate one of the largest coding unit, the coding unit, the prediction block, and the transform block. Also, the current block of the current coding unit is a block that is currently being decoded or encoded or a block that is currently being split. The neighboring block may be a block reconstructed prior to the current block. The neighboring block may be spatially or temporally adjacent to the current block. The neighboring block may be located at one of bottom-left, left, top-left, top, top-right, right, bottom-right of the current block.

FIG. 3 illustrates a process, performed by the image decoding apparatus 100, of determining at least one coding unit by splitting a current coding unit, according to an embodiment.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a height to width ratio, or size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information of the coding unit to be a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information of the coding unit to be a non-square shape. When the shape of the coding unit is non-square, the image decoding apparatus 100 may determine the height to width ratio among the block shape information of the coding unit to be at least one of 1:2, 2:1, 1:4, 4:1, 1:8, 8:1, 1:16, 16:1, 1:32, or 32:1. Also, the image decoding apparatus 100 may determine whether the coding unit is in a horizontal direction or a vertical direction, based on the length of the width and the length of the height of the coding unit. Also, the image decoding apparatus 100 may determine the size of the coding unit, based on at least one of the length of the width, the length of the height, or the area of the coding unit.

According to an embodiment, the image decoding apparatus 100 may determine the shape of the coding unit by using the block shape information, and may determine a splitting method of the coding unit by using the split shape mode information. That is, a coding unit splitting method indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus 200 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. Also, the image decoding apparatus 100 may determine split shape mode information regarding the smallest coding unit to be “no split”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. Also, the image decoding apparatus 100 may determine the size of the smallest coding unit to be 4×4. The image decoding apparatus 100 may obtain split shape mode information indicating “no split” with respect to the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information of a current coding unit 300 indicates a square shape, the decoder 120 may determine that a coding unit 310a having the same size as the current coding unit 300 is not split, based on the split shape mode information indicating no split, or may determine coding units 310b, 310c, 310d, 310e, 310f, etc. split based on the split shape mode information indicating a predetermined splitting method.

Referring to FIG. 3, according to an embodiment, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Predetermined splitting methods of splitting the square coding unit will be described in detail below in relation to various embodiments.

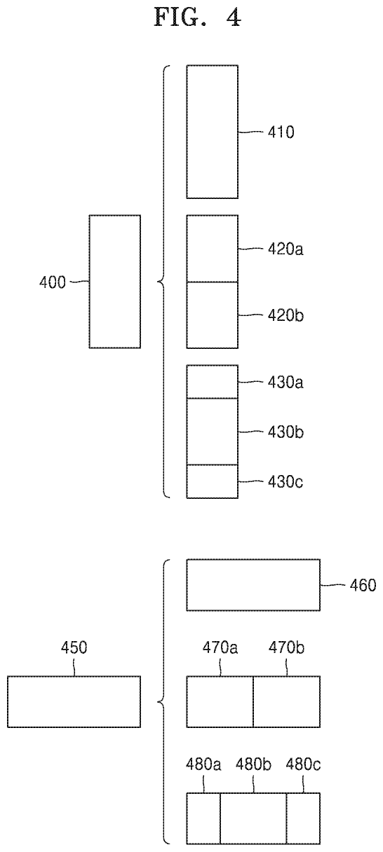

FIG. 4 illustrates a process, performed by the image decoding apparatus 100, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a predetermined splitting method, based on split shape mode information. Referring to FIG. 4, when the block shape information of a current coding unit 400 or 450 indicates a non-square shape, the image decoding apparatus 100 may determine that a coding unit 410 or 460 having the same size as the current coding unit 400 or 450 is not split, based on the split shape mode information indicating no split, or may determine coding units 420a, 420b, 430a, 430b, 430c, 470a, 470b, 480a, 480b, and 480c split based on the split shape mode information indicating a predetermined splitting method. Predetermined splitting methods of splitting a non-square coding unit will be described in detail below in relation to various embodiments.

According to an embodiment, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment, when the image decoding apparatus 100 splits the non-square current coding unit 400 or 450 based on the split shape mode information, the image decoding apparatus 100 may consider the location of a long side of the non-square current coding unit 400 or 450 so as to split a current coding unit. For example, the image decoding apparatus 100 may determine a plurality of coding units by splitting the current coding unit 400 or 450 in a direction of splitting a long side of the current coding unit 400 or 450, in consideration of the shape of the current coding unit 400 or 450.

According to an embodiment, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a height to width ratio of the current coding unit 400 or 450 may be 4:1 or 1:4. When the height to width ratio is 4:1, the block shape information may be a horizontal direction because the length of the width is longer than the length of the height. When the height to width ratio is 1:4, the block shape information may be a vertical direction because the length of the width is shorter than the length of the height. The image decoding apparatus 100 may determine to split a current coding unit into the odd number of blocks, based on the split shape mode information. Also, the image decoding apparatus 100 may determine a split direction of the current coding unit 400 or 450, based on the block shape information of the current coding unit 400 or 450. For example, when the current coding unit 400 is in the vertical direction, the image decoding apparatus 100 may determine the coding units 430a, 430b, and 430c by splitting the current coding unit 400 in the horizontal direction. Also, when the current coding unit 450 is in the horizontal direction, the image decoding apparatus 100 may determine the coding units 480a, 480b, and 480c by splitting the current coding unit 450 in the vertical direction.

According to an embodiment, the image decoding apparatus 100 may determine the odd number of coding units included in the current coding unit 400 or 450, and not all the determined coding units may have the same size. For example, a predetermined coding unit 430b or 480b from among the determined odd number of coding units 430a, 430b, and 430c, or 480a, 480b, and 480c may have a size different from the size of the other coding units 430a and 430c, or 480a and 480c. That is, coding units that may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and in addition, may put a predetermined restriction on at least one coding unit from among the odd number of coding units generated by splitting the current coding unit 400 or 450. Referring to FIG. 4, the image decoding apparatus 100 may set a decoding process regarding the coding unit 430b or 480b to be different from that of the other coding units 430a and 430c, or 480a or 480c, the coding unit 430b or 480b being located at the center among the three coding units 430a, 430b, and 430c or 480a, 480b, and 480c generated as the current coding unit 400 or 450 is split. For example, the image decoding apparatus 100 may restrict the coding unit 430b or 480b at the center location to be no longer split or to be split only a predetermined number of times, unlike the other coding units 430a and 430c, or 480a and 480c.

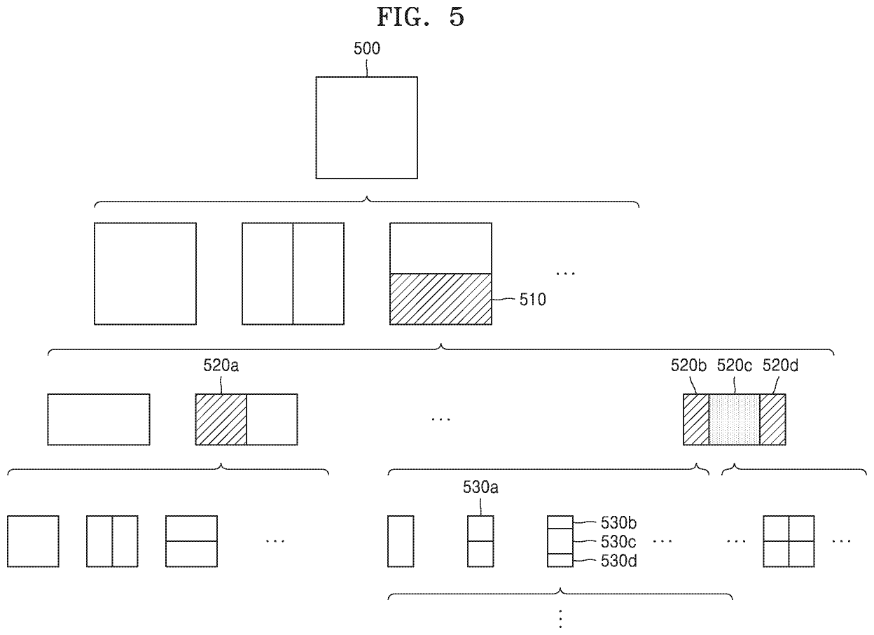

FIG. 5 illustrates a process, performed by the image decoding apparatus 100, of splitting a coding unit based on at least one of block shape information or split shape mode information, according to an embodiment.

According to an embodiment, the image decoding apparatus 100 may determine to split or not to split a square first coding unit 500 into coding units, based on at least one of the block shape information or the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after a coding unit is split. For example, a second coding unit may be determined by splitting a first coding unit, and a third coding unit may be determined by splitting the second coding unit. Hereinafter, it will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, or 520b, 520c, and 520d based on the split shape mode information. The image decoding apparatus 100 may obtain the split shape mode information, and may obtain a plurality of various-shaped second coding units (e.g., the second coding unit 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information of the first coding unit 500, the second coding unit 510 may also be split into the third coding units (e.g., 520a, or 520b, 520c, and 520d) based on the split shape mode information of the second coding unit 510. That is, a coding unit may be recursively split based on the split shape mode information of each coding unit. Therefore, a square coding unit may be determined by splitting a non-square coding unit, and a non-square coding unit may be determined by recursively splitting the square coding unit.

Referring to FIG. 5, a predetermined coding unit from among the odd number of third coding units 520b, 520c, and 520d determined by splitting the non-square second coding unit 510 (e.g., a coding unit at a center location or a square coding unit) may be recursively split. According to an embodiment, the square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on the split shape mode information. Also, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a predetermined restriction on a predetermined third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a predetermined splitting method (e.g., split into only four coding units or split by using a splitting method of the second coding unit 510), or to be split only a predetermined number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a predetermined location in the current coding unit.

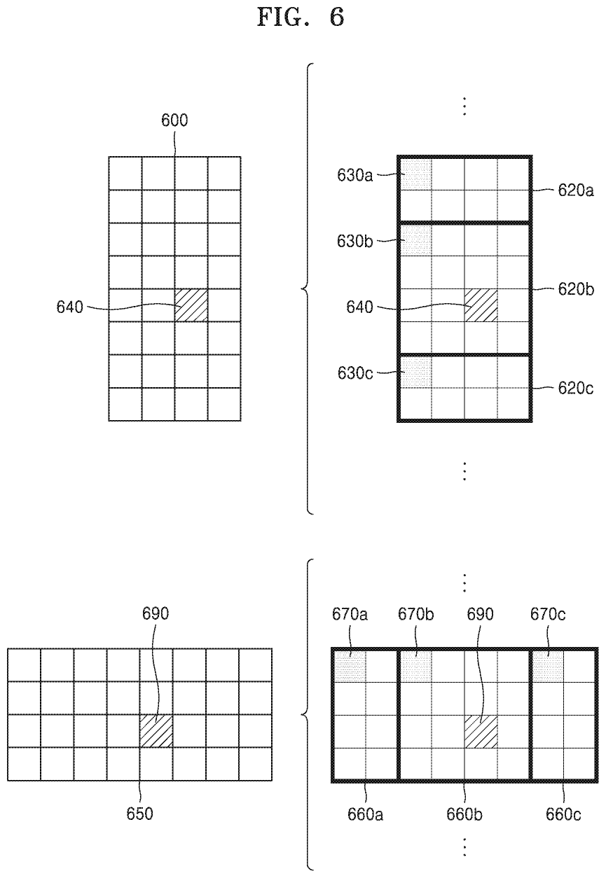

FIG. 6 illustrates a method, performed by the image decoding apparatus 100, of determining a predetermined coding unit from among an odd number of coding units, according to an embodiment.

Referring to FIG. 6, split shape mode information of a current coding unit 600 or 650 may be obtained from a sample of a predetermined location (e.g., a sample 640 or 690 of a center location) from among a plurality of samples included in the current coding unit 600 or 650. However, the predetermined location in the current coding unit 600, from which at least one piece of the split shape mode information may be obtained, is not limited to the center location in FIG. 6, and may include various locations included in the current coding unit 600 (e.g., top, bottom, left, right, top-left, bottom-left, top-right, and bottom-right locations). The image decoding apparatus 100 may obtain the split shape mode information from the predetermined location and may determine to split or not to split the current coding unit into various-shaped and various-sized coding units.

According to an embodiment, when the current coding unit is split into a predetermined number of coding units, the image decoding apparatus 100 may select one of the coding units. Various methods may be used to select one of a plurality of coding units, and descriptions of the methods will be described below in relation to various embodiments.

According to an embodiment, the image decoding apparatus 100 may split the current coding unit into a plurality of coding units, and may determine a coding unit at a predetermined location.

According to an embodiment, image decoding apparatus 100 may use information indicating locations of the odd number of coding units so as to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of predetermined samples included in the coding units 620a, 620b, and 620c. In detail, the image decoding apparatus 100 may determine the coding unit 620b at the center location by determining the locations of the coding units 620a, 620b, and 620c based on information indicating locations of top-left samples 630a, 630b, and 630c of the coding units 620a, 620b, and 620c.

According to an embodiment, the information indicating the locations of the top-left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the top-left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the top-left sample 630a of the above coding unit 620a may include coordinates (xa, ya), information indicating the location of the top-left sample 630b of the middle coding unit 620b may include coordinates (xb, yb), and information indicating the location of the top-left sample 630c of the lower coding unit 620c may include coordinates (xc, yc). The image decoding apparatus 100 may determine the middle coding unit 620b by using the coordinates of the top-left samples 630a, 630b, and 630c which are included in the coding units 620a, 620b, and 620c, respectively. For example, when the coordinates of the top-left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the top-left samples 630a, 630b, and 630c may include coordinates indicating absolute locations in the picture, or may use coordinates (dxb, dyb) indicating a relative location of the top-left sample 630b of the middle coding unit 620b and coordinates (dxc, dyc) indicating a relative location of the top-left sample 630c of the lower coding unit 620c with reference to the location of the top-left sample 630a of the above coding unit 620a. A method of determining a coding unit at a predetermined location by using coordinates of a sample included in the coding unit, as information indicating a location of the sample, is not limited to the above-described method, and may include various arithmetic methods of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a predetermined criterion. For example, the image decoding apparatus 100 may select the coding unit 620b that has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the top-left sample 630a of the above coding unit 620a, the coordinates (xb, yb) that is the information indicating the location of the top-left sample 630b of the middle coding unit 620b, and the coordinates (xc, yc) that is the information indicating the location of the top-left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the above coding unit 620a to be the width of the current coding unit 600. The image decoding apparatus 100 may determine the height of the above coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit by using the width or height of the current coding unit or the widths or heights of the above and middle coding units 620a and 620b. The image decoding apparatus 100 may determine a coding unit that has a size different from that of the others, based on the determined widths and heights of the coding units 620a, 620b, and 620c. Referring to FIG. 6, the image decoding apparatus 100 may determine the middle coding unit 620b that has a size different from the size of the above and lower coding units 620a and 620c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units that are determined based on coordinates of samples, and thus, various methods of determining a coding unit at a predetermined location by comparing the sizes of coding units that are determined based on coordinates of predetermined samples may be used.

The image decoding apparatus 100 may determine the width or height of each of the coding units 660a, 660b, and 660c by using the coordinates (xd, yd) that is information indicating the location of a top-left sample 670a of the left coding unit 660a, the coordinates (xe, ye) that is information indicating the location of a top-left sample 670b of the middle coding unit 660b, and the coordinates (xf, yf) that is information indicating a location of the top-left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 600. According to an embodiment, the image decoding apparatus 100 may determine the width or height of the right coding unit 660c by using the width or height of the current coding unit 650 or the widths or heights of the left and middle coding units 660a and 660b. The image decoding apparatus 100 may determine a coding unit that has a size different from that of the others, based on the determined widths and heights of the coding units 660a, 660b, and 660c. Referring to FIG. 6, the image decoding apparatus 100 may determine the middle coding unit 660b that has a size different from the sizes of the left and right coding units 660a and 660c, as the coding unit of the certain location. However, the above-described method, performed by the image decoding apparatus 100, of determining a coding unit having a size different from the size of the other coding units merely corresponds to an example of determining a coding unit at a predetermined location by using the sizes of coding units that are determined based on coordinates of samples, and thus, various methods of determining a coding unit at a predetermined location by comparing the sizes of coding units that are determined based on coordinates of certain samples may be used.

However, locations of samples considered to determine locations of coding units are not limited to the above-described top-left locations, and information about arbitrary locations of samples included in the coding units may be used.

According to an embodiment, the image decoding apparatus 100 may select a coding unit at a predetermined location from among an odd number of coding units determined by splitting the current coding unit, by considering the shape of the current coding unit. For example, when the current coding unit has a non-square shape, a width of which is longer than a height, the image decoding apparatus 100 may determine the coding unit at the predetermined location in a horizontal direction. That is, the image decoding apparatus 100 may determine one of coding units at different locations in a horizontal direction and may put a restriction on the coding unit. When the current coding unit has a non-square shape, a height of which is longer than a width, the image decoding apparatus 100 may determine the coding unit at the predetermined location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units so as to determine the coding unit at the predetermined location from among the even number of coding units. The image decoding apparatus 100 may determine an even number of coding units by splitting (binary-splitting) the current coding unit, and may determine the coding unit at the predetermined location by using the information about the locations of the even number of coding units. An operation related thereto may correspond to the operation of determining a coding unit at a predetermined location (e.g., a center location) from among an odd number of coding units, which has been described in detail above in relation to FIG. 6, and thus, detailed descriptions thereof are not provided here.

According to an embodiment, when a non-square current coding unit is split into a plurality of coding units, predetermined information about a coding unit at a predetermined location may be used in a splitting operation to determine the coding unit at the predetermined location from among the plurality of coding units. For example, the image decoding apparatus 100 may use at least one of block shape information or split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, predetermined information for identifying the coding unit at the predetermined location may be obtained from a predetermined sample included in a coding unit to be determined. Referring to FIG. 6, the image decoding apparatus 100 may use the split shape mode information that is obtained from a sample at a predetermined location in the current coding unit 600 (e.g., a sample at a center location of the current coding unit 600) to determine a coding unit at a predetermined location from among the plurality of the coding units 620a, 620b, and 620c determined by splitting the current coding unit 600 (e.g., a coding unit at a center location from among a plurality of split coding units). That is, the image decoding apparatus 100 may determine the sample at the predetermined location by considering a block shape of the current coding unit 600, may determine the coding unit 620b including a sample, from which certain information (e.g., the split shape mode information) may be obtained, from among the plurality of coding units 620a, 620b, and 620c determined by splitting the current coding unit 600, and may put a predetermined restriction on the coding unit 620b. Referring to FIG. 6, according to an embodiment, the image decoding apparatus 100 may determine the sample 640 at the center location of the current coding unit 600 as the sample from which the predetermined information may be obtained, and may put a predetermined restriction on the coding unit 620b including the sample 640, in a decoding operation. However, the location of the sample from which the predetermined information may be obtained is not limited to the above-described location, and may include arbitrary locations of samples included in the coding unit 620b to be determined for a restriction.

According to an embodiment, the location of the sample from which the predetermined information may be obtained may be determined based on the shape of the current coding unit 600. According to an embodiment, the block shape information may indicate whether the current coding unit has a square or non-square shape, and the location of the sample from which the predetermined information may be obtained may be determined based on the shape. For example, the image decoding apparatus 100 may determine a sample located on a boundary for splitting at least one of a width or a height of the current coding unit in half, as the sample from which the predetermined information may be obtained, by using at least one of information about the width of the current coding unit or information about the height of the current coding unit. As another example, when the block shape information of the current coding unit indicates a non-square shape, the image decoding apparatus 100 may determine one of samples adjacent to a boundary for splitting a long side of the current coding unit in half, as the sample from which the predetermined information may be obtained.

According to an embodiment, when the current coding unit is split into a plurality of coding units, the image decoding apparatus 100 may use the split shape mode information so as to determine a coding unit at a predetermined location from among the plurality of coding units. According to an embodiment, the image decoding apparatus 100 may obtain the split shape mode information from a sample at a predetermined location in a coding unit, and may split the plurality of coding units, which are generated by splitting the current coding unit, by using the split shape mode information, which is obtained from the sample of the predetermined location in each of the plurality of coding units. That is, a coding unit may be recursively split based on the split shape mode information that is obtained from the sample at the predetermined location in each coding unit. An operation of recursively splitting a coding unit has been described above in relation to FIG. 5, and thus, detailed descriptions thereof are not provided here.

According to an embodiment, the image decoding apparatus 100 may determine one or more coding units by splitting the current coding unit, and may determine an order of decoding the one or more coding units, based on a predetermined block (e.g., the current coding unit).

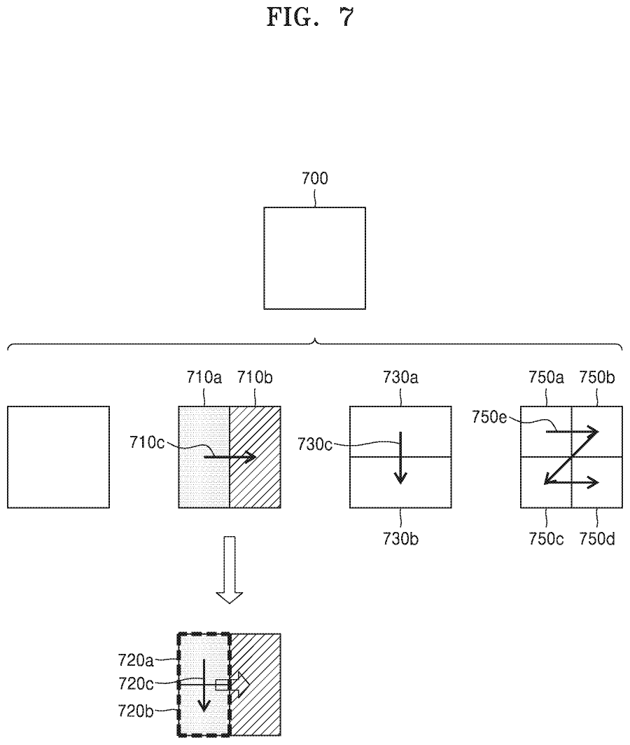

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a, 750b, 750c, and 750d by splitting the first coding unit 700 in vertical and horizontal directions, based on split shape mode information.

Referring to FIG. 7, the image decoding apparatus 100 may determine to process the second coding units 710a and 710b that are determined by splitting the first coding unit 700 in a vertical direction, in a horizontal direction order 710c. The image decoding apparatus 100 may determine to process the second coding units 730a and 730b that are determined by splitting the first coding unit 700 in a horizontal direction, in a vertical direction order 730c. The image decoding apparatus 100 may determine to process the second coding units 750a, 750b, 750c, and 750d that are determined by splitting the first coding unit 700 in vertical and horizontal directions, in a predetermined order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a, 710b, 730a, 730b, 750a, 750b, 750c, and 750d by splitting the first coding unit 700, and may recursively split each of the determined plurality of coding units 710a, 710b, 730a, 730b, 750a, 750b, 750c, and 750d. A splitting method of the plurality of coding units 710a, 710b, 730a, 730b, 750a, 750b, 750c, and 750d may correspond to a splitting method of the first coding unit 700. Accordingly, each of the plurality of coding units 710a, 710b, 730a, 730b, 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. As the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and it should be understood that various methods may be used to independently process coding units that are split and determined to various shapes, in a predetermined order.

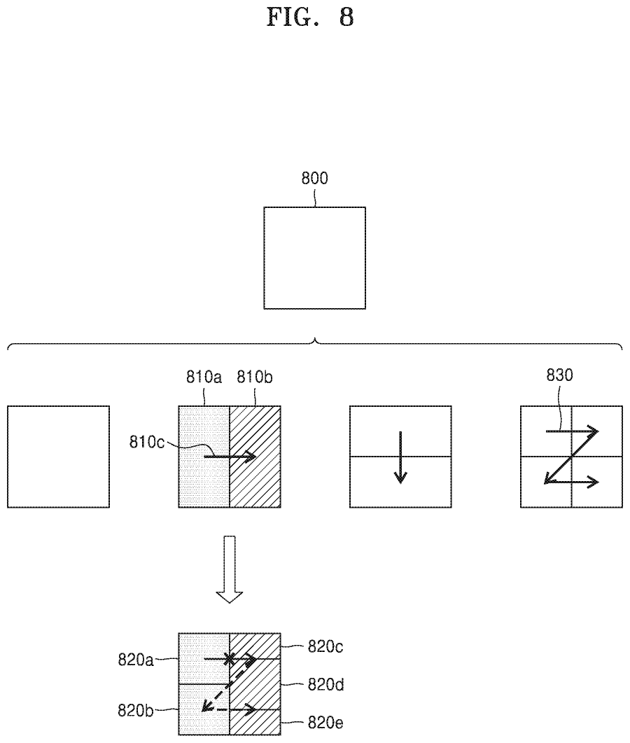

FIG. 8 illustrates a process, performed by the image decoding apparatus 100, of determining that a current coding unit is to be split into an odd number of coding units, when the coding units are not processable in a predetermined order, according to an embodiment.

According to an embodiment, the image decoding apparatus 100 may determine whether the current coding unit is split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c, 820d and 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether that is any coding unit being split into an odd number of coding units, by determining whether the third coding units 820a and 820b, and 820c, 820d, and 820e are processable in a predetermined order. Referring to FIG. 8, the image decoding apparatus 100 may determine the third coding units 820a and 820b, and 820c, 820d and 820e by recursively splitting the first coding unit 800. The image decoding apparatus 100 may determine whether any of the first coding unit 800, the second coding units 810a and 810b, and the third coding units 820a and 820b, and 820c, 820d and 820e are split into an odd number of coding units, based on at least one of the block shape information or the split shape mode information. For example, the right second coding unit 810b among the second coding units 810a and 810b may be split into an odd number of third coding units 820c, 820d, and 820e. A processing order of a plurality of coding units included in the first coding unit 800 may be a predetermined order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the predetermined order.

According to an embodiment, the image decoding apparatus 100 may determine whether the third coding units 820a and 820b, and 820c, 820d and 820e included in the first coding unit 800 satisfy the condition for processing in the predetermined order, and the condition relates to whether at least one of a width or height of the second coding units 810a and 810b is split in half along a boundary of the third coding units 820a and 820b, and 820c, 820d and 820e. For example, the third coding units 820a and 820b that are determined when the height of the left second coding unit 810a of the non-square shape is split in half may satisfy the condition. It may be determined that the third coding units 820c, 820d, and 820e do not satisfy the condition because the boundaries of the third coding units 820c, 820d, and 820e that are determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a predetermined restriction on a coding unit at a predetermined location from among the split coding units, and the restriction or the predetermined location is described above in relation to various embodiments, and thus, detailed descriptions thereof are not provided here.

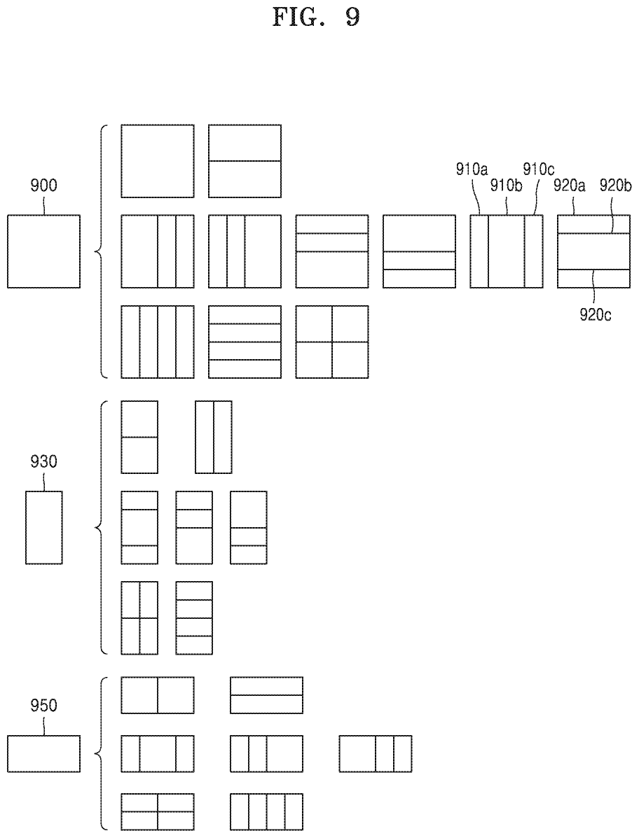

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on split shape mode information obtained via the bitstream obtainer 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units that are second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a predetermined order, and the condition relates to whether at least one of a width or a height of the first coding unit 900 is split in half along a boundary of the second coding units 910a, 910b, 910c, 920a, 920b, and 920c. Referring to FIG. 9, as boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the predetermined order. In addition, as boundaries of the second coding units 920a, 920b, and 920c determined by splitting the square first coding unit 900 in a horizontal direction do not split the height of the first coding unit 900 in half, it may be determined that the first coding unit 900 does not satisfy the condition for processing in the predetermined order. When the condition is not satisfied as described above, the image decoding apparatus 100 may determine disconnection of a scan order, and may determine that the first coding unit 900 is split into an odd number of coding units, based on a result of the determination. According to an embodiment, when a coding unit is split into an odd number of coding units, the image decoding apparatus 100 may put a predetermined restriction on a coding unit at a predetermined location from among the split coding units, and the restriction or the predetermined location is described above in relation to various embodiments, and thus, detailed descriptions thereof are not provided here.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

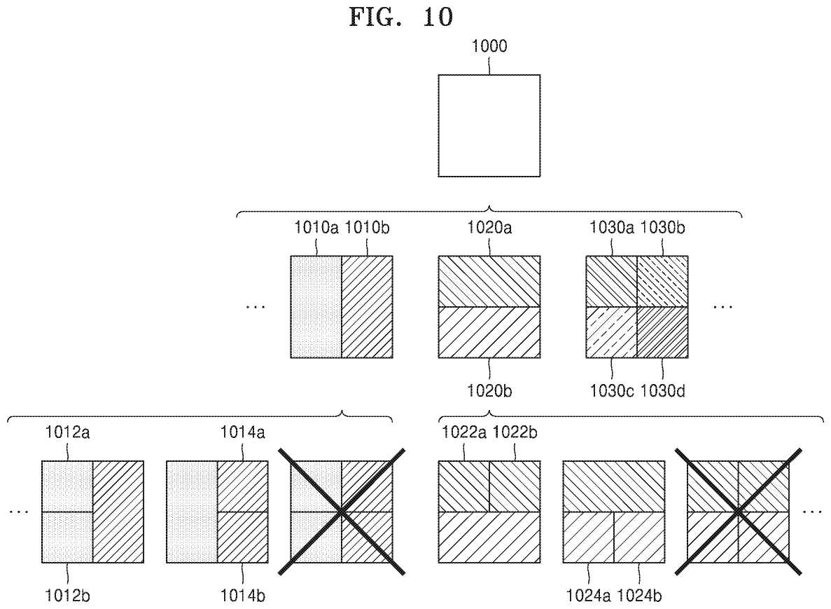

FIG. 10 illustrates that a shape into which a second coding unit is splittable is restricted when the second coding unit having a non-square shape, which is determined when the image decoding apparatus 100 splits a first coding unit 1000, satisfies a predetermined condition, according to an embodiment.

According to an embodiment, the image decoding apparatus 100 may determine to split the square first coding unit 1000 into non-square second coding units 1010a, 1010b, 1020a, and 1020b, based on split shape mode information obtained via the bitstream obtainer 110. The second coding units 1010a, 1010b, 1020a, and 1020b may be independently split. Accordingly, the image decoding apparatus 100 may determine to split or not to split each of the second coding units 1010a, 1010b, 1020a, and 1020b into a plurality of coding units, based on the split shape mode information of each of the second coding units 1010a, 1010b, 1020a, and 1020b. According to an embodiment, the image decoding apparatus 100 may determine third coding units 1012a and 1012b by splitting the non-square left second coding unit 1010a that is determined by splitting the first coding unit 1000 in a vertical direction, in a horizontal direction. However, when the left second coding unit 1010a is split in a horizontal direction, the image decoding apparatus 100 may restrict the right second coding unit 1010b not to be split in a horizontal direction in which the left second coding unit 1010a is split. When third coding units 1014a and 1014b are determined by splitting the right second coding unit 1010b in a same direction, the third coding units 1012a and 1012b or 1014a and 1014b may be determined in a manner that the left and right second coding units 1010a and 1010b are independently split in a horizontal direction. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b which is determined by splitting the first coding unit 1000 in a horizontal direction, in a vertical direction. However, when a second coding unit (e.g., the above second coding unit 1020a) is split in a vertical direction, for the above-described reason, the image decoding apparatus 100 may restrict the other second coding unit (e.g., the lower second coding unit 1020b) not to be split in a vertical direction in which the above second coding unit 1020a is split.

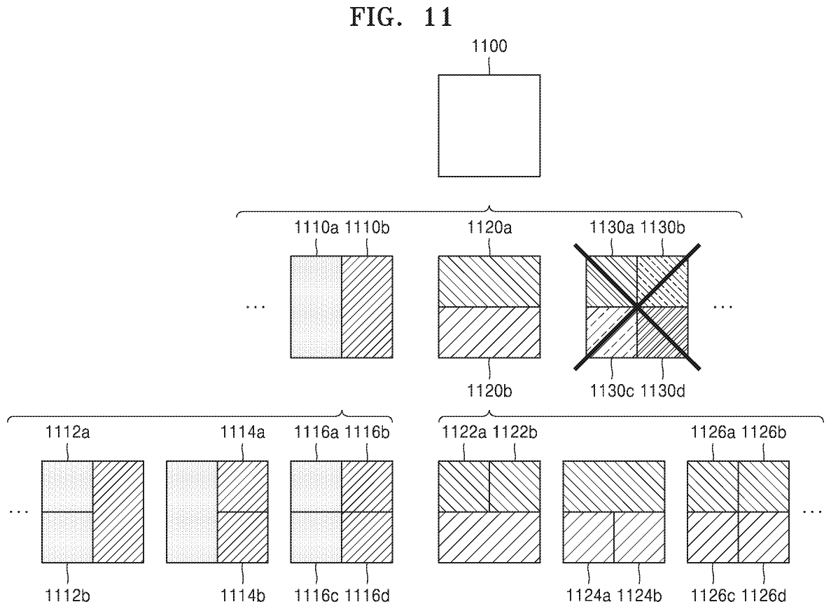

FIG. 11 illustrates a process, performed by the image decoding apparatus 100, of splitting a square coding unit when split shape mode information is unable to indicate that the square coding unit is split into four square coding units, according to an embodiment.

According to an embodiment, the image decoding apparatus 100 may determine second coding units 1110a, 1110b, 1120a, 1120b, etc. by splitting a first coding unit 1100, based on split shape mode information. The split shape mode information may include information about various methods of splitting a coding unit but, the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. Based on the split shape mode information, the image decoding apparatus 100 may determine the non-square second coding units 1110a, 1110b, 1120a, 1120b, etc.

According to an embodiment, the image decoding apparatus 100 may independently split the non-square second coding units 1110a, 1110b, 1120a, 1120b, etc. Each of the second coding units 1110a, 1110b, 1120a, 1120b, etc. may be recursively split in a predetermined order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

In another example, the image decoding apparatus 100 may determine square third coding units 1122a and 1122b by splitting the above second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the above and lower second coding units 1120a and 1120b in a vertical direction. In this case, coding units having the same shape as the four square second coding units 1130a, 1130b, 1130c, and 1130d split from the first coding unit 1100 may be determined.

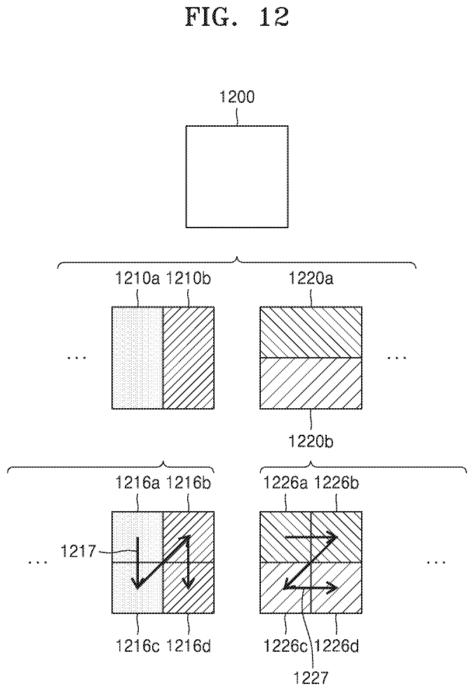

FIG. 12 illustrates that a processing order between a plurality of coding units may be changed depending on a process of splitting a coding unit, according to an embodiment.

According to an embodiment, the image decoding apparatus 100 may split a first coding unit 1200, based on split shape mode information. When a block shape indicates a square shape and the split shape mode information indicates to split the first coding unit 1200 in at least one of a horizontal direction or a vertical direction, the image decoding apparatus 100 may determine second coding units (for examples, second coding units 1210a, 1210b, 1220a, 1220b, etc.) by splitting the first coding unit 1200. Referring to FIG. 12, the non-square second coding units 1210a, 1210b, 1220a, and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a vertical direction. An operation of splitting the second coding units 1210a, 1210b, 1220a, and 1220b is described above with reference to FIG. 11, and thus, detailed descriptions thereof are not provided here.

According to an embodiment, the image decoding apparatus 100 may process coding units in a predetermined order. An operation of processing coding units in a predetermined order is described above with reference to FIG. 7, and thus, detailed descriptions thereof are not provided here. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d, based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the above second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. Accordingly, by recursively splitting a coding unit in different manners based on the split shape mode information, the image decoding apparatus 100 may process a plurality of coding units in different orders even when the coding units are eventually determined to be the same shape.

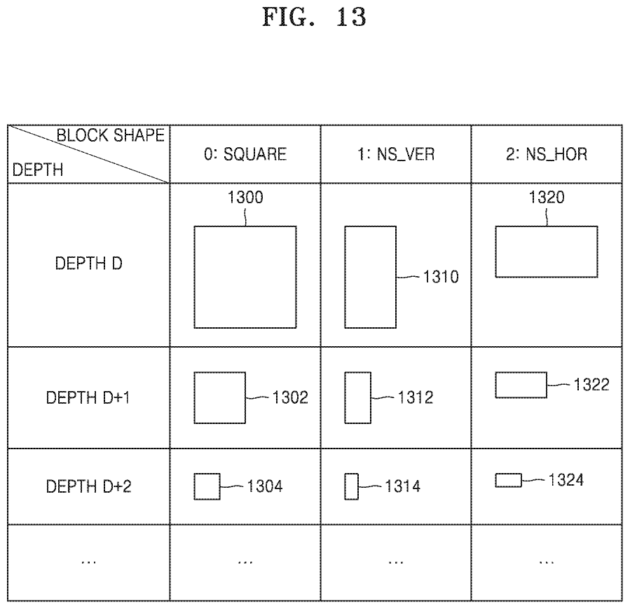

FIG. 13 illustrates a process of determining a depth of a coding unit as a shape and size of the coding unit change, when the coding unit is recursively split such that a plurality of coding units are determined, according to an embodiment.

According to an embodiment, the image decoding apparatus 100 may determine the depth of the coding unit, based on a predetermined criterion. For example, the predetermined criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. Hereinafter, a coding unit having an increased depth is expressed as a coding unit of a deeper depth.

Referring to FIG. 13, according to an embodiment, the image decoding apparatus 100 may determine a second coding unit 1302 and a third coding unit 1304 of deeper depths by splitting a square first coding unit 1300 based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of deeper depths by splitting a non-square first coding unit 1310 or 1320 based on block shape information indicating a non-square shape (e.g., the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width or a height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit (e.g., the second coding unit 1302, 1312, 1322, etc.) by splitting at least one of a width or a height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width of a height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit (e.g., the third coding unit 1304, 1314, 1324, etc.) by splitting at least one of a width or a height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit (e.g., the third coding unit 1304, 1314, 1324, etc.) by splitting at least one of a width or a height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

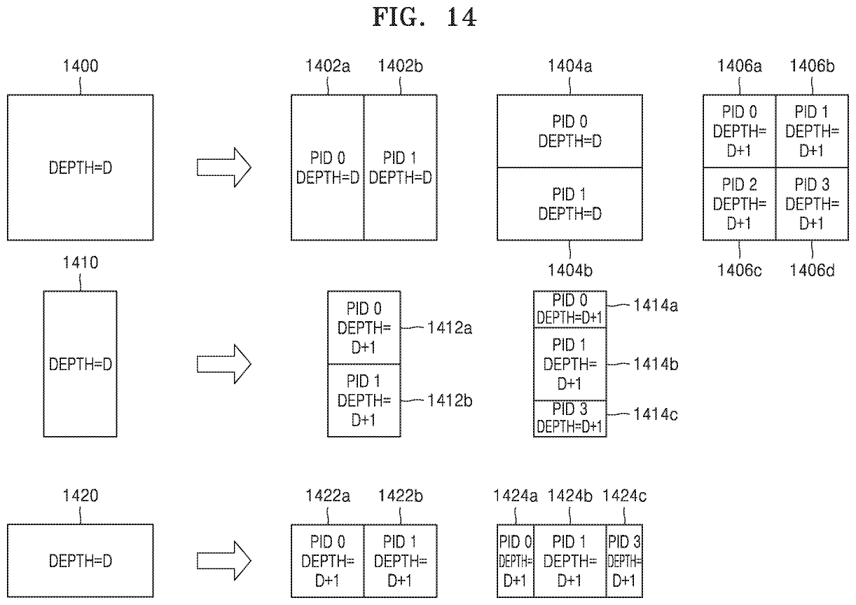

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of a vertical direction or a horizontal direction based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to an embodiment, a depth of the second coding units 1402a and 1402b, 1404a and 1404b, and 1406a, 1406b, 1406c, and 1406d, which are determined based on the split shape mode information of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 1400 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is deeper than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, depths of the second coding units 1412a and 1412b, and 1414a, 1414b, and 1414c, or 1422a and 1422b, and 1424a, 1424b, and 1424c that are determined based on the split shape mode information of the non-square first coding unit 1410 or 1420 may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is deeper than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is deeper than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus, may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify the respective coding units. According to an embodiment, the PID may be obtained from a sample of a predetermined location of each coding unit (e.g., a top-left sample).

According to an embodiment, the image decoding apparatus 100 may determine a coding unit at a predetermined location from among the split coding units, by using the PIDs for distinguishing the coding units. According to an embodiment, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units so as to determine a coding unit at a center location from among the coding units. The image decoding apparatus 100 may determine the coding unit 1414b having a PID corresponding to a middle value among the PIDs of the coding units, as the coding unit at the predetermined location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus, may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a predetermined location among an odd number of coding units (e.g., a coding unit of a center location) has a size different from that of the other coding units. In this case, the image decoding apparatus 100 may determine the coding unit of the center location, which has a different size, by using PIDs of the coding units. However, the PIDs and the size or location of the coding unit of the predetermined location are not limited to the above-described examples, and various PIDs and various locations and sizes of coding units may be used.

According to an embodiment, the image decoding apparatus 100 may use a predetermined data unit where a coding unit starts to be recursively split.

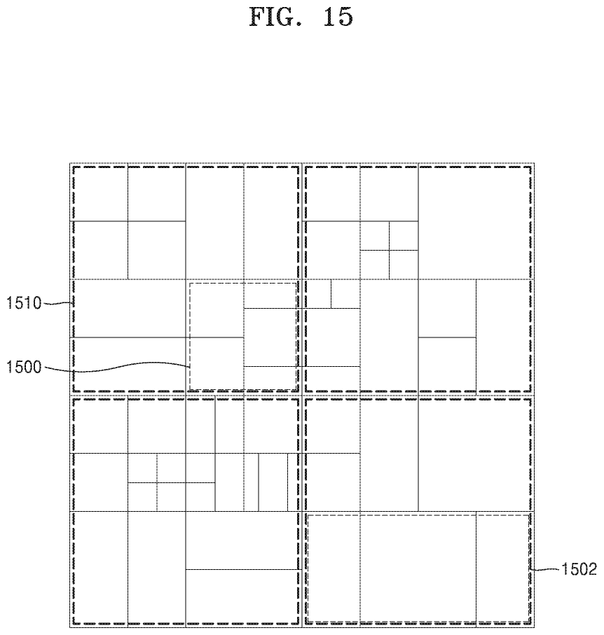

FIG. 15 illustrates that a plurality of coding units are determined based on a plurality of predetermined data units included in a picture, according to an embodiment.

According to an embodiment, a certain data unit may be defined as a data unit where a coding unit starts to be recursively split by using split shape mode information. That is, the predetermined data unit may correspond to a coding unit of an uppermost depth, which is used to determine a plurality of coding units split from a current picture. In the following descriptions, for convenience of descriptions, the predetermined data unit is referred to as a reference data unit.

According to an embodiment, the reference data unit may have a predetermined size and a predetermined size shape. According to an embodiment, the reference data unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information of each reference data unit. The operation of splitting the reference data unit may correspond to a splitting operation using a quadtree structure.

According to an embodiment, the image decoding apparatus 100 may previously determine the smallest size allowed for the reference data units included in the current picture. Accordingly, the image decoding apparatus 100 may determine various reference data units having sizes equal to or greater than the smallest size, and may determine one or more coding units by using the split shape mode information with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, tiles, tile groups, largest coding units, or the like).

According to an embodiment, the bitstream obtainer 110 of the image decoding apparatus 100 may obtain, from a bitstream, at least one of reference coding unit shape information or reference coding unit size information with respect to each of the various data units. An operation of splitting the square reference coding unit 1500 into one or more coding units is described above with reference to the operation of splitting the current coding unit 300 of FIG. 3, and an operation of splitting the non-square reference coding unit 1502 into one or more coding units is described above with reference to the operation of splitting the current coding unit 400 or 450 of FIG. 4. Thus, detailed descriptions thereof are not provided here.

According to an embodiment, the image decoding apparatus 100 may use a PID for identifying the size and shape of reference coding units, to determine the size and shape of reference coding units according to some data units previously determined based on a predetermined condition. That is, the bitstream obtainer 110 may obtain, from the bitstream, only the PID for identifying the size and shape of reference coding units with respect to each slice, slice segment, tile, tile group, or largest coding unit which is a data unit satisfying a predetermined condition (e.g., a data unit having a size equal to or smaller than a slice) among the various data units (e.g., sequences, pictures, slices, slice segments, tiles, tile groups, largest coding units, or the like). The image decoding apparatus 100 may determine the size and shape of reference data units with respect to each data unit, which satisfies the predetermined condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size or the shape of reference coding units corresponding to the PID for identifying the size and shape of reference coding units may be previously determined. That is, the image decoding apparatus 100 may determine at least one of the size or the shape of reference coding units included in a data unit serving as a unit for obtaining the PID, by selecting the previously determined at least one of the size or the shape of reference coding units based on the PID.

According to an embodiment, the image decoding apparatus 100 may use one or more reference coding units included in a largest coding unit 1510. That is, a largest coding unit split from a picture may include one or more reference coding units, and coding units may be determined by recursively splitting each reference coding unit. According to an embodiment, at least one of a width or a height of the largest coding unit may be integer times at least one of the width or the height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information or the split shape mode information according to various embodiments.

According to an embodiment, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit or each reference coding unit, and may use the obtained syntax element.

Hereinafter, a method of determining a split rule, according to an embodiment of the present disclosure, will be described in detail.

The image decoding apparatus 100 may determine a split rule of an image. The split rule may be previously determined between the image decoding apparatus 100 and the image encoding apparatus 200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, or a tile group header. The image decoding apparatus 100 may determine the split rule differently according to frames, slices, tiles, temporal layers, largest coding units, or coding units.

The image decoding apparatus 100 may determine the split rule based on a block shape of a coding unit. The block shape may include a size, shape, a height to width ratio, and a direction of the coding unit. The image encoding apparatus 200 and the image decoding apparatus 100 may previously determine to determine the split rule based on block shape information of a coding unit. However, the present disclosure is not limited thereto. The image decoding apparatus 100 may determine the split rule, based on information obtained from a bitstream received from the image encoding apparatus 200.

The shape of the coding unit may include a square and a non-square. When the lengths of the width and height of the coding unit are the same, the image decoding apparatus 100 may determine the shape of the coding unit to be a square. Also, when the lengths of the width and height of the coding unit are not the same, the image decoding apparatus 100 may determine the shape of the coding unit to be a non-square.

A size of the coding unit may include various sizes such as 4×4, 8×4, 4×8, 8×8, 16×4, 16×8, . . . , 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. Also, the image decoding apparatus 100 may apply the same split rule to coding units having the same lengths of long sides.

The height to width ratio of the coding unit may include 1:2, 2:1, 1:4, 4:1, 1:8, 8:1, 1:16, 16:1, 32:1, 1:32, or the like. Also, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

To determine the split rule, based on the size of the coding unit, may be a split rule pre-determined between the image encoding apparatus 200 and the image decoding apparatus 100. Also, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

Also, the image decoding apparatus 100 may determine the split rule such that coding units generated via different splitting paths do not have the same block shape. However, the present disclosure is not limited thereto, and the coding units generated via different splitting paths have the same block shape. The coding units generated via the different splitting paths may have different decoding processing orders. As the decoding processing orders are described above with reference to FIG. 12, details thereof are not provided here.

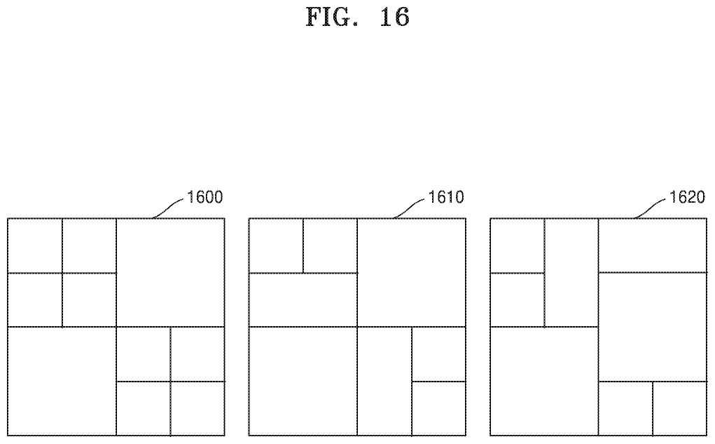

FIG. 16 illustrates coding units that may be determined in each picture when a combination of shapes into which a coding unit is splittable is different for each picture, according to an embodiment.

Referring to FIG. 16, the image decoding apparatus 100 may determine a combination of split shapes into which a coding unit is splittable to be different in each picture. For example, the image decoding apparatus 100 may decode an image by using a picture 1600 being splittable into four coding units, a picture 1610 being splittable into two or four coding units, and a picture 1620 being splittable into two, three, or four coding units among one or more pictures included in the image. In order to split the picture 1600 into a plurality of coding units, the image decoding apparatus 100 may use only split shape information indicating a split into four square coding units. In order to split the picture 1610, the image decoding apparatus 100 may use only split shape information indicating a split into two or four coding units. In order to split the picture 1620, the image decoding apparatus 100 may use only split shape information indicating a split into two, three, or four coding units. The combination of split shapes is merely an embodiment for describing an operation of the image decoding apparatus 100, and thus, should not be interpreted only for the embodiment, and it should be interpreted that a combination of various split shapes may be used in each predetermined data unit.

According to an embodiment, the bitstream obtainer 110 of the image decoding apparatus 100 may obtain a bitstream including an index indicating a combination of split shape information for each predetermined data unit (e.g., each sequence, each picture, each slice, each slice segment, each tile, each tile group, etc.). For example, the bitstream obtainer 110 may obtain an index indicating a combination of split shape information from a sequence parameter set, a picture parameter set, a slice header, a tile header, or a tile group header. The image decoding apparatus 100 may determine, by using the obtained index, a combination of split shapes into which a coding unit is splittable in each predetermined data unit, and thus, may use a combination of different split shapes in each predetermined data unit.

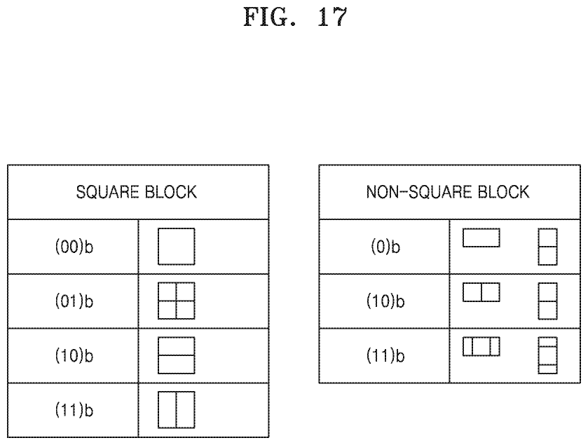

FIG. 17 illustrates various shapes of a coding unit which may be determined based on split shape mode information that may be represented in binary code, according to an embodiment.

According to an embodiment, the image decoding apparatus 100 may split a coding unit into various shapes by using block shape information and split shape mode information obtained via the bitstream obtainer 110. A shape into which a coding unit is splittable may correspond to various shapes including shapes described above in the embodiments.

Referring to FIG. 17, the image decoding apparatus 100 may split a square coding unit in at least one direction among a horizontal direction and a vertical direction, based on the split shape mode information, and may split a non-square coding unit in a horizontal direction or a vertical direction.

According to an embodiment, when it is possible for the image decoding apparatus 100 to split a square coding unit into four square coding units in a horizontal direction and a vertical direction, split shapes for the square coding unit which may be indicated by the split shape mode information may be four shapes. According to an embodiment, the split shape mode information may be represented in 2-bit binary code, and binary code may be allocated to each split shape. For example, when a coding unit is not split, split shape mode information may be represented as (00)b, when a coding unit is split in a horizontal direction and a vertical direction, split shape mode information may be represented as (01)b, when a coding unit is split in a horizontal direction, split shape mode information may be represented as (10)b, and when a coding unit is split in a vertical direction, split shape mode information may be represented as (11)b.

According to an embodiment, when the image decoding apparatus 100 splits a non-square coding unit in a horizontal direction or a vertical direction, split shape types that may be indicated by split shape mode information may be determined based on the number of splits into which a coding unit is divided. Referring to FIG. 17, according to an embodiment, the image decoding apparatus 100 may split a non-square coding unit into three coding units. The image decoding apparatus 100 may split a coding unit into two coding units, and in this case, split shape mode information may be represented as (10)b. The image decoding apparatus 100 may split a coding unit into three coding units, and in this case, split shape mode information may be represented as (11)b. The image decoding apparatus 100 may determine not to split a coding unit, and in this case, split shape mode information may be represented as (0)b. That is, the image decoding apparatus 100 may not use fixed length coding (FLC) but may use variable length coding (VLC) so as to use binary code indicating split shape mode information.

According to an embodiment, referring to FIG. 17, binary code of split shape mode information indicating no split of a coding unit may be represented as (0)b. In a case where binary code of split shape mode information indicating no split of a coding unit is set in (00)b, even when there is no split shape mode information set in (01)b, binary code of 2-bit split shape mode information has to be all used. However, as shown in FIG. 17, in a case where three split shapes for a non-square coding unit are used, the image decoding apparatus 100 may determine no split of a coding unit even when 1-bit binary code (0)b is used as split shape mode information, a bitstream may be efficiently used. However, it should not be interpreted that a split shape of a non-square coding unit which is indicated by split shape mode information is limited to three shapes shown in FIG. 17, and it should be interpreted that the split shape corresponds to various shapes including the embodiments described above.

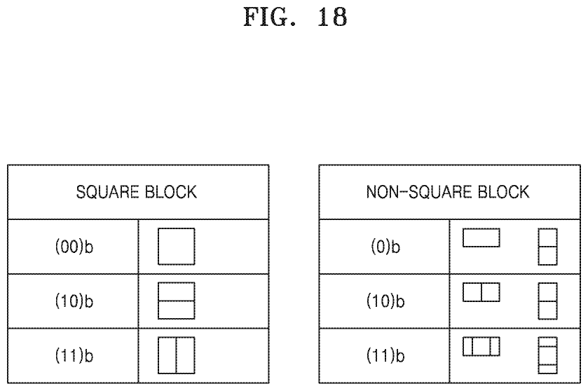

FIG. 18 illustrates other shapes of a coding unit which may be determined based on split shape mode information that may be represented in binary code, according to an embodiment.

Referring to FIG. 18, the image decoding apparatus 100 may split a square coding unit in a horizontal direction or a vertical direction, based on the split shape mode information, and may split a non-square coding unit in a horizontal direction or a vertical direction. That is, the split shape mode information may indicate that a square coding unit is split in one direction. In this case, binary code of split shape mode information indicating no split of a square coding unit may be represented as (0)b. In a case where binary code of split shape mode information indicating no split of a coding unit is set in (00)b, even when there is no split shape mode information set in (01)b, binary code of 2-bit split shape mode information has to be all used. However, as shown in FIG. 18, in a case where three split shapes for a square coding unit are used, the image decoding apparatus 100 may determine no split of a coding unit even when 1-bit binary code (0)b is used as split shape mode information, a bitstream may be efficiently used. However, it should not be interpreted that a split shape of a square coding unit which is indicated by split shape mode information is limited to three shapes shown in FIG. 18, and it should be interpreted that the split shape corresponds to various shapes including the embodiments described above.

According to an embodiment, block shape information or split shape mode information may be represented by using binary code, and such information may be immediately generated as a bitstream. Alternatively, block shape information or split shape mode information that may be represented in binary code may not be immediately generated as a bitstream and may be used as binary code to be input in context adaptive binary arithmetic coding (CABAC).

According to an embodiment, a process in which the image decoding apparatus 100 obtains syntax of block shape information or split shape mode information via CABAC will now be described. A bitstream including binary code for the syntax may be obtained via the bitstream obtainer 110. The image decoding apparatus 100 may detect a syntax element indicating block shape information or split shape mode information by inversely binarizing a bin string included in the obtained bit stream. According to an embodiment, the image decoding apparatus 100 may calculate a binary bin string set corresponding to a syntax element to be decoded, and may decode each bin by using probability information. The image decoding apparatus 100 may repeat decoding until a bin string configured with such decoded bins becomes equal to one of pre-calculated bin strings. The image decoding apparatus 100 may determine the syntax element by performing inverse binarization on the bin string.

According to an embodiment, the image decoding apparatus 100 may determine a syntax of a bin string by performing a decoding process of adaptive binary arithmetic coding. The image decoding apparatus 100 may update a probability model for bins obtained via the bitstream obtainer 110. Referring to FIG. 17, according to an embodiment, the bitstream obtainer 110 of the image decoding apparatus 100 may obtain a bitstream indicating binary code indicating split shape mode information. The image decoding apparatus 100 may determine syntax of split shape mode information by using binary code having 1 bit or 2 bits. In order to determine syntax of split shape mode information, the image decoding apparatus 100 may update probability of each bit in 2-bit binary code. That is, depending on whether a value of a first bin in 2-bit binary code is 0 or 1, the image decoding apparatus 100 may update probability that a next bit has a value of 0 or 1 in decoding.

According to an embodiment, in a process of determining syntax, the image decoding apparatus 100 may update probability of bins used in a process of decoding the bins of a bin string with respect to the syntax, the image decoding apparatus 100 may determine that probability is not updated in a particular bit of the bin string and the particular bit has the same probability.

Referring to FIG. 17, in a process of determining syntax by using a bin string indicating split shape mode information about a non-square coding unit, when the non-square coding unit is not split, the image decoding apparatus 100 may determine the syntax of the split shape mode information by using one bin having the value of 0. That is, in a case where block shape information indicates that a current coding unit has a non-square coding unit, a first bin of a bin string about split shape mode information may be 0 when the non-square coding unit is not split, and may be 1 when the non-square coding unit is split into two or three coding units. Accordingly, probability that the first bin of the bin string of the split shape mode information about the non-square coding unit is 0 may be ⅓ and the probability that the first bin is 1 may be ⅔. As described above, split shape mode information indicating that a non-square coding unit is not split may be represented by only a bin string having a zero-value 1 bit, the image decoding apparatus 100 may determine syntax of the split shape mode information by determining whether a second bin is 0 or 1 only when a first bin of the split shape mode information is 1. According to an embodiment, when the first bin of the split shape mode information is 1, the image decoding apparatus 100 may decode a bin by determining that probability that the second bin is 0 or 1 is the same.

According to an embodiment, the image decoding apparatus 100 may use various probabilities of each bin in a process of determining a bin of a bin string about split shape mode information. According to an embodiment, the image decoding apparatus 100 may determine probability of a bin about split shape mode information to differ according to directions of a non-square block. According to an embodiment, the image decoding apparatus 100 may determine probability of a bin about split shape mode information to differ according to an area or a length of a long side of a current coding unit. According to an embodiment, the image decoding apparatus 100 may determine probability of a bin about split shape mode information to differ according to at least one of a shape or a length of a long side of a current coding unit.

According to an embodiment, the image decoding apparatus 100 may determine that probability of a bin about split shape mode information is equal with respect to coding units with a predetermined size or more. For example, it may be determined that probability of a bin about split shape mode information is equal with respect to coding units with a size of 64 samples or more.

According to an embodiment, the image decoding apparatus 100 may determine initial probability of bins constituting a bin string of split shape mode information, based on a slice type (e.g., I slice, P slice, or B slice).

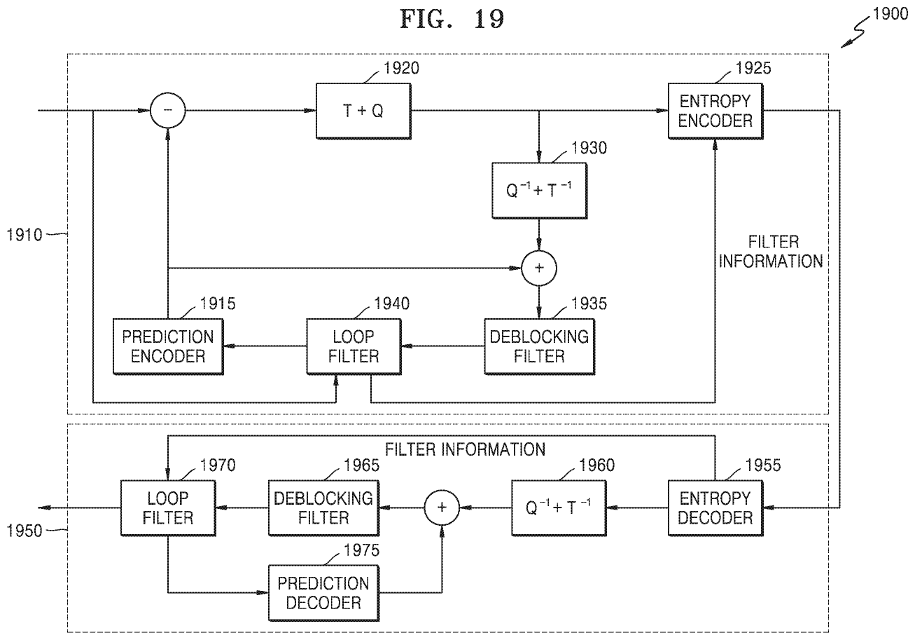

FIG. 19 is a block diagram of an image encoding and decoding system that performs loop filtering.

An encoding end 1910 of an image encoding and decoding system 1900 transmits an encoded bitstream of an image and a decoding end 1950 outputs a reconstructed image by receiving and decoding the bitstream. Here, the encoding end 1910 may have a similar configuration as the image encoding apparatus 200, and the decoding end 1950 may have a similar configuration as the image decoding apparatus 100.

At the encoding end 1910, a prediction encoder 1915 outputs a reference image via inter-prediction and intra-prediction, and a transformer and quantizer 1920 outputs a quantized transform coefficient of residual data between prediction data and a current input image. An entropy encoder 1925 transforms the quantized transform coefficient by encoding the quantized transform coefficient, and outputs the transformed quantized transform coefficient as a bitstream. The quantized transform coefficient is reconstructed as data of a spatial domain via a dequantizer and inverse transformer 1930, and the data of the spatial domain is output as a reconstructed image via a deblocking filter 1935 and a loop filter 1940. The reconstructed image may be used as a reference image of a next input image via the prediction encoder 1915.

Encoded image data among the bitstream received by the decoding end 1950 is reconstructed as residual data of a spatial domain via an entropy decoder 1955 and a dequantizer and inverse transformer 1960. Image data of a spatial domain is configured when a reference image and residual data output from a prediction decoder 1975 are combined, and a deblocking filter 1965 and a loop filter 1970 may output a reconstructed image regarding a current original image by performing filtering on the image data of the spatial domain. The reconstructed image may be used by the prediction decoder 1975 as a reference image for a next original image.

The loop filter 1940 of the encoding end 1910 performs loop filtering by using filter information input according to a user input or system setting. The filter information used by the loop filter 1940 is output to the entropy encoder 1925 and then is transmitted to the decoding end 1950 together with the encoded image data. The loop filter 1970 of the decoding end 1950 may perform loop filtering based on the filter information input from the decoding end 1950.

In various embodiments described above, an operation related to an image decoding method performed by the image decoding apparatus 100 is described. Hereinafter, an operation of the image encoding apparatus 200 that performs an image encoding method corresponding to an inverse process of the image decoding method will now be described in various embodiments.

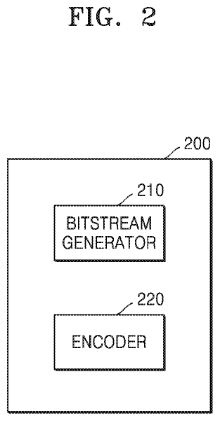

FIG. 2 illustrates a block diagram of the image encoding apparatus 200 capable of encoding an image based on at least one of block shape information or split shape mode information, according to an embodiment.

The image encoding apparatus 200 may include an encoder 220 and a bitstream generator 210. The encoder 220 and the bitstream generator 210 may include be implemented as at least one processor. Also, encoder 220 and the bitstream generator 210 may include memory storing instructions to be executed by the at least one processor.

The encoder 220 may receive an input image and then may encode the input image. The encoder 220 may obtain at least one syntax element by encoding the input image. A syntax element may include at least one of a skip flag, a prediction mode, a motion vector difference, a motion vector prediction method (or index), a transform quantized coefficient, a coded block pattern, coded block flag, an intra prediction mode, a direct flag, a merge flag, delta QP, a reference index, a prediction direction, or a transform index. The encoder 220 may determine a context model, based on block shape information including at least one of a shape, a direction, a ratio of a width and a height, or a size of a coding unit.

The bitstream generator 210 may generate a bitstream, based on the encoded input image. For example, the bitstream generator 210 may generate the bitstream by entropy encoding a syntax element, based on the context model. Also, the image encoding apparatus 200 may transmit the bitstream to the image decoding apparatus 100.

According to an embodiment, the encoder 220 of the image encoding apparatus 200 may determine a shape of a coding unit. For example, the coding unit may have a square shape or a non-square shape, and information indicating the shape may be included in the block shape information.

According to an embodiment, the encoder 220 may determine into which shape the coding unit is to be split. The encoder 220 may determine a shape of at least one coding unit included in the coding unit, and the bitstream generator 210 may generate a bitstream including split shape mode information including information about a shape of the coding unit.

According to an embodiment, the encoder 220 may determine whether the coding unit is to be split or is not to be split. When the encoder 220 determines that only one coding unit is included in the coding unit or the coding unit is not to be split, the bitstream generator 210 may generate a bitstream including split shape mode information indicating that the coding unit is not to be split. Also, the encoder 220 may split a coding unit into a plurality of coding units included in the coding unit, and the bitstream generator 210 may generate a bitstream including split shape mode information indicating that the coding unit is to be split into a plurality of coding units.

According to an embodiment, information indicating how many coding units the coding unit is split into or in which direction the coding unit is split may be included in the split shape mode information. For example, the split shape mode information may indicate a split in at least one direction of a vertical direction and a horizontal direction or may indicate no split.

The image encoding apparatus 200 may determine the split shape mode information, based on a split shape mode of the coding unit. The image encoding apparatus 200 determines a context model, based on at least one of a shape, a direction, a ratio of a width and a height, or a size of the coding unit. Then, the image encoding apparatus 200 generates, as a bitstream, the split shape mode information for splitting the coding unit, based on the context model.

In order to determine the context model, the image encoding apparatus 200 may obtain an array for corresponding at least one of a shape, a direction, a ratio of a width and a height, or a size of the coding unit and an index for the context model. The image encoding apparatus 200 may obtain, from the array, the index for the context model, based on at least one of a shape, a direction, a ratio of a width and a height, or a size of the coding unit. The image encoding apparatus 200 may determine the context model, based on the index for the context model.

In order to determine the context model, the image encoding apparatus 200 may determine the context model, further based on block shape information including at least one of a shape, a direction, a ratio of a width and a height, or a size of a neighboring coding unit adjacent to the coding unit. Also, the neighboring coding unit may include at least one of coding units located at bottom-left, left, top-left, top, top-right, right, or bottom-right of the coding unit.

Also, in order to determine the context model, the image encoding apparatus 200 may compare a length of a width of an above neighboring coding unit with a length of a width of the coding unit. Also, the image encoding apparatus 200 may compare lengths of heights of left and right neighboring coding units with a length of a height of the coding unit. Also, the image encoding apparatus 200 may determine the context model, based on results of the comparisons.

As an operation of the image encoding apparatus 200 includes similar content as an operation of the image decoding apparatus 100 described with reference to FIGS. 3 to 19, detailed descriptions thereof are not provided here.

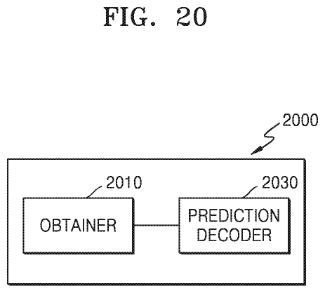

FIG. 20 is a block diagram illustrating a configuration of an image decoding apparatus 2000 according to an embodiment.

Referring to FIG. 20, the image decoding apparatus 2000 may include an obtainer 2010 and a prediction decoder 2030.

According to an embodiment, the obtainer 2010 and the prediction decoder 2030 may include or be implemented as at least one processor. In an embodiment, the obtainer 2010 and the prediction decoder 2030 may operate according to at least one instruction stored in at least one memory and executed by the at least one processor.

The image decoding apparatus 2000 may include at least one memory that stores input/output data of the obtainer 2010 and the prediction decoder 2030. Also, the image decoding apparatus 2000 may include a memory controller configured to control data input/output to/from the at least one memory.

In an embodiment, the obtainer 2010 may correspond to the entropy decoder 1955 shown in FIG. 19, and the prediction decoder 2030 may correspond to the prediction decoder 1975 shown in FIG. 19.

The obtainer 2010 may obtain a bitstream generated as an encoding result of a picture. The bitstream may include an encoding result of a current block. The current block may be a largest coding unit, a coding unit, a transform unit, or a prediction unit, which is split from a current picture to be decoded.

In an embodiment, the obtainer 2010 may receive the bitstream from an image encoding apparatus via a network.

In an embodiment, the obtainer 2010 may obtain the bitstream from a data storage medium including a magnetic medium such as a hard disk, a floppy disk, and a magnetic tape, an optical recording medium such as compact disc read only memory (CD-ROM) and digital versatile disc (DVD), a magneto-optical medium such as a floptical disk, or the like.

The obtainer 2010 may obtain, from the bitstream, syntax elements for decoding a picture. Values corresponding to the syntax elements may be included in the bitstream, according to a hierarchical structure of the picture.

The obtainer 2010 may obtain the syntax elements by entropy decoding bins included in the bitstream.

In an embodiment, the bitstream may include information about a prediction mode of a current block in a current picture. The prediction mode of the current block may be any one of a plurality of prediction modes including an intra mode and an inter mode.

The prediction decoder 2030 may generate a prediction block of a current block by performing intra prediction or inter prediction on the current block, based on a prediction mode of the current block, and may reconstruct the current block using the prediction block.

In an embodiment, when the prediction mode of the current block is the intra mode, the obtainer 2010 may obtain, from the bitstream, information about an intra prediction mode of the current block.

In an embodiment, the information about the intra prediction mode of the current block may include information indicating a method of determining an intra prediction mode. In an embodiment, the method of determining the intra prediction mode may include a method by which a decoder derives the intra prediction mode or a method of determining the intra prediction mode by using information obtained from a bitstream.

In an embodiment, the information indicating a method of determining an intra prediction mode may be included in a sequence parameter set, a picture parameter set, a slice header, or slice data of a bitstream. In an example, the slice data may include information to be signaled at a level of a coding tree, a coding unit, a transform tree, or a transform unit.

In an embodiment, the information indicating a method of determining an intra prediction mode may not be included in the bitstream, and in this case, the prediction decoder 2030 may determine an intra prediction mode of a current block according to a predetermined method.

In an embodiment, when the method of determining the intra prediction mode corresponds to a method of using information obtained from a bitstream, the prediction decoder 2030 may determine, as an intra prediction mode of a current block, an intra prediction mode that is among a plurality of intra prediction modes and is indicated by the information obtained from the bitstream. For example, information indicating the intra prediction mode of the current block may include a flag or an index indicating any one intra prediction mode among the plurality of intra prediction modes.

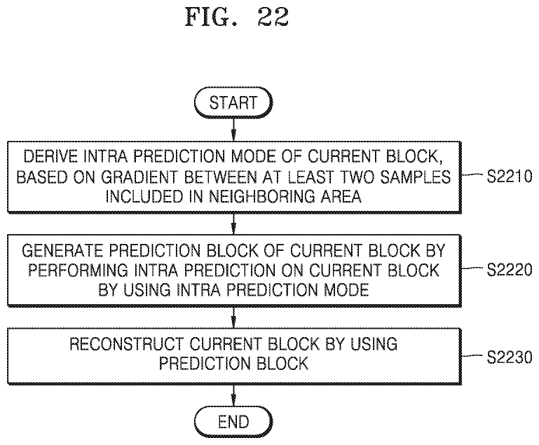

In an embodiment, when the method of determining the intra prediction mode corresponds to a method by which a decoder derives an intra prediction mode, the prediction decoder 2030 may derive the intra prediction mode of the current block, based on a gradient calculated from a neighboring area. A method of deriving an intra prediction mode, based on a gradient, will be described in detail below with reference to FIGS. 22 to 38.

When a prediction block is generated via intra prediction with respect to a current block, the prediction decoder 2030 may obtain a reconstructed current block by using the prediction block.

In an embodiment, the prediction decoder 2030 may determine the prediction block as the reconstructed current block.

In an embodiment, the prediction decoder 2030 may generate the reconstructed current block by combining the prediction block with residual data obtained from a bitstream by the obtainer 2010.

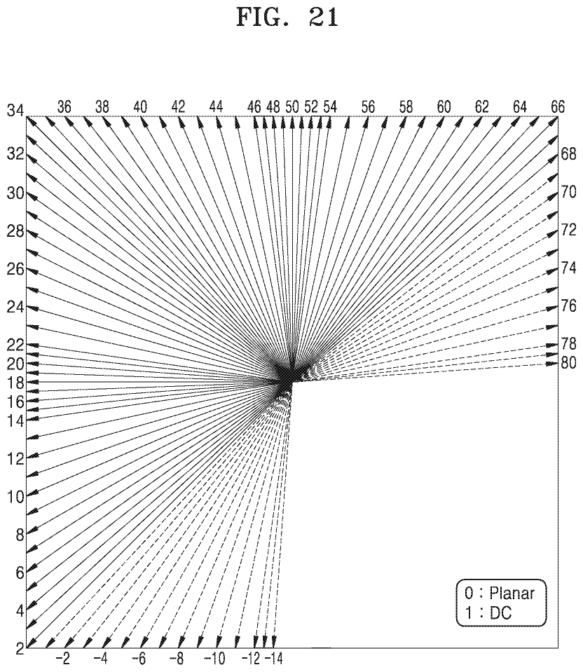

FIG. 21 is a diagram illustrating an intra prediction mode according to an embodiment.

Referring to FIG. 21, the intra prediction mode may be predefined by an image encoding apparatus and the image decoding apparatus 2000. In the present disclosure, a case in which 67 intra prediction modes are defined is assumed. However, this is merely an example, and fewer intra prediction modes than 67 may be defined, or more intra prediction modes than 67 may be defined.

The predefined intra prediction modes may include 2 non-angular modes and 65 angular modes. The non-angular modes may include a planar mode and a direct current (DC) mode. The angular modes may include mode 2 to mode 66, each having a predetermined angle.

In particular, mode 2, mode 34, and mode 66 may each be defined as a diagonal mode, intra prediction modes between mode 2 and mode 34 may each be defined as a horizontal angular mode, and intra prediction modes between mode 34 and mode 66 may each be defined as a vertical angular mode. Also, according to a block shape, a mode less than mode 2 or a mode greater than mode 66 may be used in intra prediction. For example, according to a ratio of a width of a block to a height of the block, an angular prediction mode less than 2 or greater than 66 may be used in intra prediction.

When an angular mode becomes fine, that is, when more prediction directions corresponding to the angular mode are added, various predictors may be generated, such that an accurate prediction value may be obtained whereas an amount of information to be transmitted is increased. Therefore, there may be a limit in continuous addition of an intra prediction mode, in terms of a rate-distortion performance. That is, a transmission amount of information about an intra prediction mode increases more than a gain that is obtained by decreasing a prediction error, such that a compression efficiency may be decreased.

A prediction method by which a decoder (i.e., the image decoding apparatus 2000) directly derives an intra prediction mode so as to decrease overhead with respect to intra mode information transmission so as to overcome such a limit will now be described. In the present disclosure, the prediction method by which the decoder derives an intra prediction mode may be abbreviated as decoder-side intra mode derivation (DIMD).

In the recent image compression technology, a method of increasing a size of an accessible area of a reconstructed sample is being discussed. As the accessible area of the reconstructed sample is increased, the image decoding apparatus 2000 may efficiently derive an intra prediction mode, based on information calculated from a pre-reconstructed area. As the image encoding apparatus does not signal intra prediction mode information but the image decoding apparatus 2000 generates a predictor by autonomously deriving an intra prediction mode, overhead due to signaling may be decreased and a compression efficiency may be increased.

Hereinafter, with reference to FIGS. 22 to 38, an intra prediction process in which the image decoding apparatus 2000 derives an intra prediction mode will now be described.

FIG. 22 is a flowchart of an image decoding method according to an embodiment.

In operation S2210, the image decoding apparatus 2000 may derive an intra prediction mode of a current block, based on a gradient between at least two samples included in a neighboring area of the current block.

The image decoding apparatus 2000 may calculate a gradient by using at least two samples included in a neighboring area of a current block. The image decoding apparatus 2000 may generate gradient information by accumulating a calculated gradient. In an example, an intra prediction mode of a current block may be selected among the intra prediction modes previously described with reference to FIG. 21.

The DIMD refers to a technology for directly deriving an intra prediction mode, and when a DIMD mode is applied to a current block, the image decoding apparatus 2000 may derive an angular intra prediction mode in a reconstructed area around the current block. The angular intra prediction mode may be derived by using gradient information established by collecting gradients at predefined locations in the reconstructed area around the current block.

A gradient may indicate a variable calculated by using at least two samples included in a neighboring area of a current block. In an example, the gradient may include at least one of a horizontal-direction gradient or a vertical-direction gradient. In the present disclosure, the gradient may be referred to as a slope, variance, directionality, prediction directionality, etc. Also, in the present disclosure, the gradient may refer to gradient information obtained by accumulating a calculated gradient.

The gradient information may include information about an intra prediction mode mapped to the calculated gradient and/or information about amplitude (or intensity) of the intra prediction mode. In the present disclosure, the gradient information may also be referred to as a gradient intensity, a gradient size, gradient amplitude, a histogram of gradient (HoG), a histogram intensity, a histogram size, histogram amplitude, etc.

In an embodiment, a gradient between at least two samples included in a neighboring area of a current block may be obtained by using a predefined filter. Also, gradient information of the current block may be generated based on the obtained gradient.

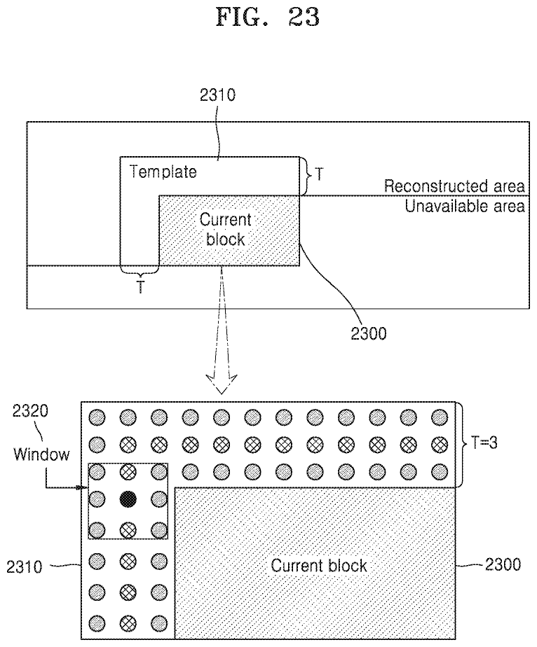

A particular embodiment of generating gradient information will be described with reference to FIGS. 23 to 26, and FIGS. 29 to 38.

In an embodiment, the image decoding apparatus 2000 may derive an intra prediction mode, based on generated gradient information. In an example, the image decoding apparatus 2000 may derive a plurality of intra prediction modes, based on the gradient information. A maximum number of intra prediction modes to be derived may be predefined. For example, the maximum number may be defined as 2, 3, 4, 5, etc. For example, a predetermined number of intra prediction modes in descending order of amplitude among intra prediction modes included in the generated gradient information may be derived as an intra prediction mode of the current block.

In S2220, the image decoding apparatus 2000 may generate a prediction block of the current block by performing intra prediction on the current block using the intra prediction mode.

The image decoding apparatus 2000 may generate a predictor by using the derived intra prediction mode. In the present disclosure, the predictor that the image decoding apparatus 2000 generates by using the derived intra prediction mode may be referred to as a prediction sample, a prediction block, a temporary prediction sample, a temporary prediction block, an initial prediction sample, or an initial prediction block.

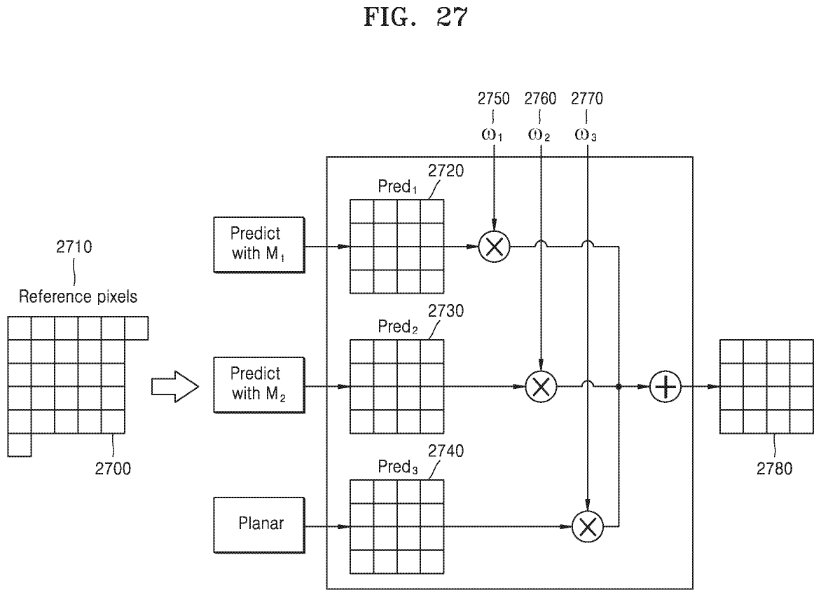

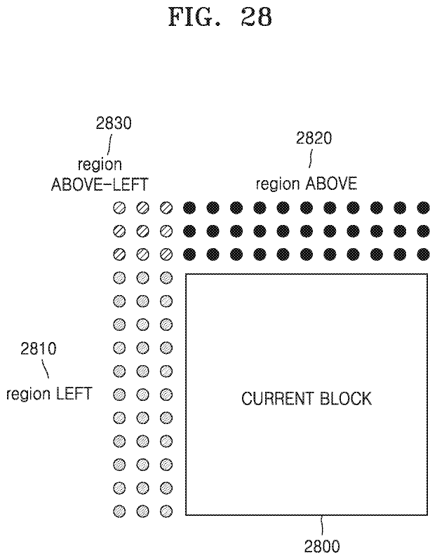

The image decoding apparatus 2000 may generate a final prediction block by performing a weighted sum of the predictor generated according to the derived intra prediction mode. In an example, the image decoding apparatus 2000 may generate the final prediction block by performing the weighted sum of the predictor generated according to the derived intra prediction mode and a predictor generated according to a predetermined intra prediction mode (e.g., a planar mode). A particular embodiment of generating a final prediction block by using a weighted sum of predictors will be described with reference to FIGS. 27 and 28.

In operation S2230, the image decoding apparatus 2000 may reconstruct the current block by using the prediction block.

In an example, the image decoding apparatus 2000 may determine the prediction block as a reconstructed current block. Alternatively, in an example, the image decoding apparatus 2000 may generate the reconstructed current block by combining residual data obtained from a bitstream with the prediction block.

FIG. 23 is a diagram illustrating an example of a method of calculating a gradient according to an embodiment.

Referring to FIG. 23, a gradient may be calculated by using pixels included in a neighboring area of a current block 2300. In an embodiment, a template 2310 may be defined for gradient information generation in a reconstructed area around the current block 2300.

The template 2310 may include left, above-left, and above areas around the current block 2300. In an example, as shown in FIG. 23, the template 2310 may be defined as an L-shape area of 3 pixel lines adjacent to the current block 2300. A gradient may be calculated by using pixels included in the template 2310 in a neighboring area of the current block 2300. In an embodiment, the number of pixel lines available for the template 2310 may vary.

In an embodiment, a gradient may be calculated via filtering with respect to pixels included in the template 2310. In an embodiment, filtering may be performed on pixels in a pixel area of 3×3 included in the template 2310. A pixel area to which filtering is to be applied may be referred to as a window.

In an example, a Sobel filter of a 3×3 size may be applied to a window 2320. In the present disclosure, a case in which the window 2320 has a 3×3 size is mainly described, but this is merely an example, and the present disclosure is not limited thereto. For example, the window 2320 may be defined to have a size of 2×2, 4×4, 5×5, etc.

In an embodiment, the window 2320 may be determined with respect to a pixel included in a center pixel line in the template 2310 of the 3 pixel lines, and filtering may be applied to the window 2320, such that the gradient may be calculated.

The gradient may include at least one of a horizontal-direction gradient or a vertical-direction gradient. An intra prediction mode may be determined based on the calculated gradient. An angle (or, a prediction direction) may be calculated based on the gradient, and the calculated angle may be mapped to an intra prediction mode being most adjacent or having a most similar angle. In other words, the intra prediction mode may be calculated from the gradient. Gradient information may be configured by using the intra prediction mode calculated from the gradient.

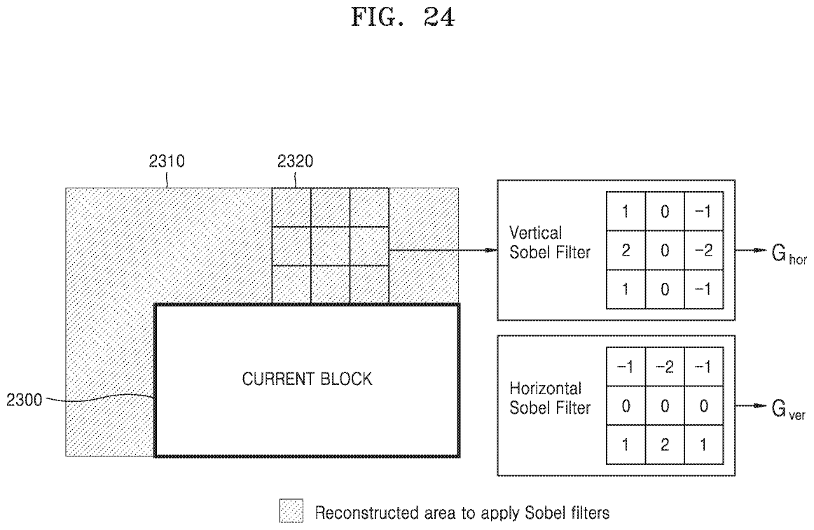

FIG. 24 is a diagram illustrating a method of calculating a gradient according to an embodiment.

Referring to FIG. 24, a Sobel filter may be used to obtain a gradient. As described above, the template 2310 of the current block 2300 may be configured of 3 pixel lines included in the left area, the above area, and the above-left area. That is, the template 2310 may be used as a reference area for intra prediction mode derivation based on a gradient.

In an embodiment, the Sobel filter may be applied to the 3×3 window 2320 in the template 2310. The Sobel filter may include at least one of a Sobel filter in a horizontal direction or a Sobel filter in a vertical direction. The Sobel filter may be applied to the 3×3 window 2320 with respect to a pixel included in a center pixel line of the template 2310.

In an example, the Sobel filter in a horizontal direction and the Sobel filter in a vertical direction may be defined as shown in FIG. 24.

In an embodiment, when the Sobel filter in a vertical direction is applied to the template 2310, a horizontal-direction gradient may be output. When the Sobel filter in a horizontal direction is applied to the template 2310, a vertical-direction gradient may be output.

In an embodiment, a Sobel filter in a vertical direction is applied to windows in the template 2310, such that gradients in a horizontal direction which respectively correspond to the windows may be output. Also, a Sobel filter in a horizontal direction is applied to the windows in the template 2310, such that gradients in a vertical direction which respectively correspond to the windows may be output.

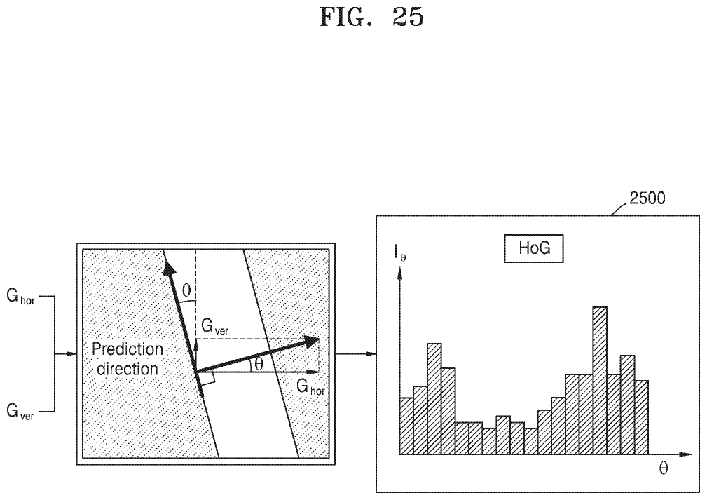

FIG. 25 is a diagram for describing a method of generating gradient information, according to an embodiment.

Referring to FIG. 25, an angle (or, a prediction direction) calculated via filtering with respect to the window 2320 may be mapped (or converted) to one of predefined intra prediction modes. The angle derived from the gradient may be a texture angle or prediction direction of the window 2320. In an example, an intra prediction mode as described with reference to FIG. 21 may be derived from the gradient. That is, the angle calculated via filtering with respect to the window 2320 may be mapped to one of 65 angular intra prediction modes.

In an embodiment, the intra prediction mode corresponding to the current window 2320 may be derived according to the description of Equation 1 below.

$$angle = arcta n ( {G}_{ver} / {G}_{hor} ) \qquad [ Equation 1 ]$$

In Equation 1, Gₕₒᵣ indicates a horizontal-direction gradient of the current window 2320, and Gᵥₑᵣ indicates a vertical-direction gradient of the current window 2320. An angle of the current window 2320 may be calculated by using the horizontal-direction gradient and the vertical-direction gradient according to Equation 1.

In an embodiment, an intra prediction mode corresponding to an angle adjacent to the angle calculated by using Equation 1 may be derived as (or mapped to) an intra prediction mode of the current window 2320.

In an embodiment, an intensity (or amplitude) of the intra prediction mode corresponding to the current window 2320 may be calculated by using Equation 2 below.

$$ampl = \vert {G}_{ver} \vert + \vert {G}_{hor} \vert \qquad [ Equation 2 ]$$

Referring to Equation 2, the intensity of the intra prediction mode may be calculated as the sum of respective absolute values of the horizontal-direction gradient of the current window 2320 and the vertical-direction gradient of the current window 2320.

In an embodiment, gradient information 2500 may be generated (or updated) based on the intra prediction mode and the intensity of the intra prediction mode. The gradient information 2500 may be generated by accumulating an intra prediction mode calculated from a gradient and amplitude (or intensity) corresponding to the intra prediction mode. In other words, the gradient information 2500 may be generated by summing respective amplitudes of intra prediction modes collected from the template 2310, based on each corresponding intra prediction mode.

In an embodiment, gradient information may include at least one intra prediction mode and amplitude corresponding to the at least one intra prediction mode.

Also, in an embodiment, the gradient information may include a first value corresponding to at least one intra prediction mode and a second value corresponding to an intensity of the first value. In this regard, the first value may indicate angle δ or the intra prediction mode. The angle may be a prediction angle, a prediction direction, a texture angle, or a texture direction. The intra prediction mode may be mapped to a calculated angle δ. The second value may indicate an intensity, amplitude, or a size. The first value and the second value may be respectively referred to as a first variable and a second variable.

FIG. 25 illustrates an example of an angle δ (or a prediction direction) and intensity Iₑ which are derived by a horizontal-direction gradient Gₕₒᵣ and a vertical-direction gradient Gᵥₑᵣ, and an example of the gradient information 2500 that is accumulation of information about the angle δ and the intensity Iₑ.

In an embodiment, an x-axis of the gradient information 2500 may indicate the angle δ or an intra prediction mode. Here, the angle may be a prediction angle, a prediction direction, a texture angle, or a texture direction. The intra prediction mode may be mapped to a calculated angle δ. In an example, the angle δ may be calculated by using Equation 1 described above.

A y-axis of the gradient information 2500 indicates the corresponding angle δ or amplitude of the intra prediction mode. Iₑ of FIG. 25 may be a variable indicating amplitude, an intensity, or a size.

In an embodiment, angles (or intra prediction modes) at all pixel locations (pixel locations included in a center pixel line) in the template 2310 may be derived, and values of intensities of the derived angles may be summed, such that respective amplitudes of the angles of the current block 2300 may be obtained.

In an embodiment, an angle calculated from the window 2320 may be mapped to an intra prediction mode according to a method below. That is, the angle calculated from the window 2320 may be mapped to an intra prediction mode, based on Equation 3 below by using 6 calculated based on Equation 1 described above.

$$\begin{matrix}tan θ = \frac{41}{32} \\ intraPredAngle = 32 tan θ \\ intraPredAngle = 41\end{matrix} \qquad [ Equation 3 ]$$

Referring to FIG. 3, it is assumed that tan θ value is 41/32 according to the angle calculated from the window 2320. The tan θ value may be represented as an integer variable intraPredAngle. Afterward, the calculated intraPredAngle value may be mapped to the most adjacent value in Table 1 below. An intra prediction mode having the corresponding value may be determined as an intra prediction mode to be mapped to the angle calculated from the window 2320.

TABLE 1

| predModeIntra | −14 | −13 | −12 | −11 | −10 | −9 | −8 | −7 | −6 | −5 | −4 | −3 | −2 | −1 | 2 | 3 | 4 |
|---|---|---|---|---|---|---|---|---|---|---|---|---|---|---|---|---|---|
| intraPredAngle | 512 | 341 | 256 | 171 | 128 | 102 | 86 | 73 | 64 | 57 | 51 | 45 | 39 | 35 | 32 | 29 | 26 |

| predModeIntra | 5 | 6 | 7 | 8 | 9 | 10 | 11 | 12 | 13 | 14 | 15 | 16 | 17 | 18 | 19 | 20 | 21 |
|---|---|---|---|---|---|---|---|---|---|---|---|---|---|---|---|---|---|
| intraPredAngle | 23 | 20 | 18 | 16 | 14 | 12 | 10 | 8 | 6 | 4 | 3 | 2 | 1 | 0 | −1 | −2 | −3 |

| predModeIntra | 22 | 23 | 24 | 25 | 26 | 27 | 28 | 29 | 30 | 31 | 32 | 33 | 34 | 35 | 36 | 37 | 38 |
|---|---|---|---|---|---|---|---|---|---|---|---|---|---|---|---|---|---|
| intraPredAngle | −4 | −6 | −8 | −10 | −12 | −14 | −16 | −18 | −20 | −23 | −26 | −29 | −32 | −29 | −26 | −23 | −20 |

| predModeIntra | 39 | 40 | 41 | 42 | 43 | 44 | 45 | 46 | 47 | 48 | 49 | 50 | 51 | 52 | 53 | 54 | 55 |
|---|---|---|---|---|---|---|---|---|---|---|---|---|---|---|---|---|---|
| intraPredAngle | −18 | −16 | −14 | −12 | −10 | −8 | −6 | −4 | −3 | −2 | −1 | 0 | 1 | 2 | 3 | 4 | 6 |

| predModeIntra | 56 | 57 | 58 | 59 | 60 | 61 | 62 | 63 | 64 | 65 | 66 | 67 | 68 | 69 | 70 | 71 | 72 |
|---|---|---|---|---|---|---|---|---|---|---|---|---|---|---|---|---|---|
| intraPredAngle | 8 | 10 | 12 | 14 | 16 | 18 | 20 | 23 | 26 | 29 | 32 | 35 | 39 | 45 | 51 | 57 | 64 |

| predModeIntra | 73 | 74 | 75 | 76 | 77 | 78 | 79 | 80 |
|---|---|---|---|---|---|---|---|---|
| intraPredAngle | 73 | 86 | 102 | 128 | 171 | 256 | 341 | 512 |

In detail, referring to Table 1, when it is assumed that intraPredAngle calculated using Equation 3 is 41, mode no. 68 having a value being most adjacent to 41 may be determined as the intra prediction mode mapped to the angle of the current window 2320. That is, intraPredAngle value calculated using Equation 3 may be mapped to adjacent intraPredAngle value, and an intra prediction mode having a corresponding intraPredAngle may be determined as the intra prediction mode mapped to the angle of the current window 2320.

A corresponding intra prediction mode for the entire window 2320 with respect to a pixel included in a center pixel line in the template 2310 may be determined, and gradient information may be generated/updated by accumulating an intensity of the corresponding intra prediction mode.

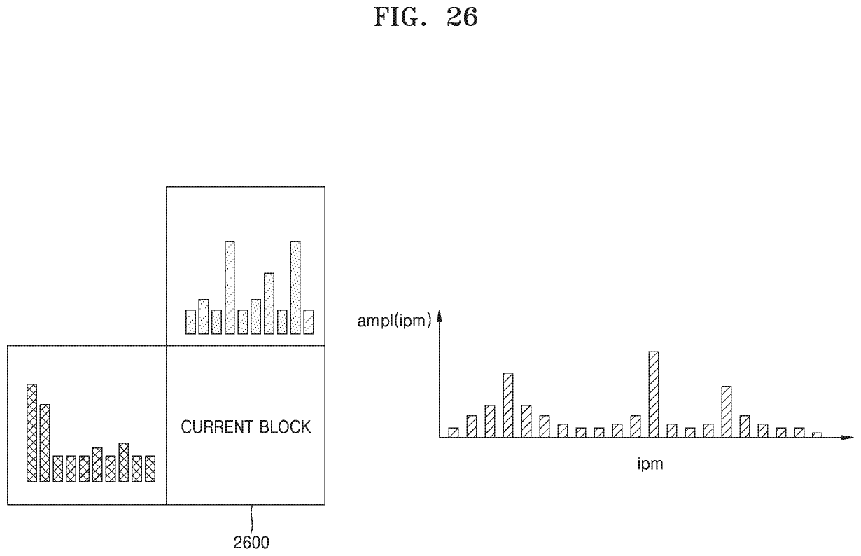

FIG. 26 is a diagram illustrating a method of deriving an intra prediction mode from a neighboring block, according to an embodiment.

Referring to FIG. 26, the image decoding apparatus 2000 may derive an intra prediction mode by using prediction information of a neighboring block of a current block 2600. In other words, the intra prediction mode of the current block 2600 may be derived by using the prediction information of the neighboring block, according to a DIMD process for the current block 2600. Here, the prediction information may include gradient information and/or DIMD mode information. Here, a DIMD mode may indicate an intra prediction mode derived via DIMD.

In an embodiment, a method of performing a DIMD process by using prediction information of a neighboring block may be referred to as a DIMD merge mode.

In an embodiment, when the DIMD merge mode is applied to the current block 2600, the intra prediction mode of the current block 2600 may be derived by using prediction information stored in a neighboring block. For example, gradient information combined with respect to the current block 2600 may be derived by combining (or averaging) gradient information obtained from the neighboring block.

Alternatively, in an embodiment, when the DIMD merge mode is applied to the current block 2600, the image decoding apparatus 2000 may derive a DIMD mode of a neighboring block as an intra prediction mode of the current block 2600.

In an embodiment, the DIMD merge mode may be allowed only when there is at least one DIMD block (or DIMD merge block) among neighboring blocks adjacent to the current block 2600. In an example, the neighboring blocks adjacent to the current block 2600 may be defined as a left block and an above block. However, the present disclosure is not limited thereto, and a block at a different location may be defined as a neighboring block. In the present disclosure, a DIMD block indicates a block encoded via DIMD, and a DIMD merge block indicates a block encoded in a DIMD merge mode.

In an embodiment, when the DIMD merge mode is allowed, a flag or an index which indicates whether to apply the DIMD merge mode may be signaled. When the DIMD merge is applied, a process of obtaining gradient information from the template 2310 which is described above with reference to FIGS. 23 to 25 may be omitted.

FIG. 27 is a diagram for describing a process of generating an intra prediction sample, according to an embodiment.

Referring to FIG. 27, the image decoding apparatus 2000 may derive an intra prediction mode of a current block 2700 by using the method described above with reference to FIGS. 22 to 26. With reference to FIG. 27, it is assumed that the current block 2700 has a 4×4 size.

In an embodiment, a maximum number of intra prediction modes to be derived may be predefined. For example, the maximum number may be defined as 2, 3, 4, 5, etc. For example, a predetermined number of intra prediction modes in descending order of amplitude among intra prediction modes included in the generated gradient information may be derived as an intra prediction mode of the current block. In other words, the image decoding apparatus 2000 may derive, as the intra prediction mode of the current block, intra prediction modes corresponding to a predetermined number of amplitudes having largest sizes among amplitudes corresponding to the intra prediction modes included in the gradient information of the current block.

With reference to FIG. 27, it is assumed that two angular intra prediction modes are derived for intra prediction of the current block 2700. Among the derived two intra prediction modes, the first intra prediction mode is referred to as M₁ and the second intra prediction mode is referred to as M₂. In an example, an order of intra prediction modes may be determined according to amplitude sizes of the intra prediction modes included in gradient information. For example, an intra prediction mode corresponding to largest amplitude among amplitudes of the intra prediction modes included in the gradient information may be determined as M₁. An intra prediction mode corresponding to second-largest amplitude among the amplitudes of the intra prediction modes included in the gradient information may be determined as M₂.

In an embodiment, the image decoding apparatus 2000 may configure reference pixels 2710 of the current block 2700 for intra prediction. The reference pixels 2710 of the current block 2700 may be configured to include a left sample line, an above sample line, and an above-left sample of the current block 2700.

The image decoding apparatus 2000 may generate a first prediction block 2720 of the current block 2700 by performing intra prediction using M₁. The image decoding apparatus 2000 may generate a second prediction block 2730 of the current block 2700 by performing intra prediction using M₂. The image decoding apparatus 2000 may generate a third prediction block 2740 of the current block 2700 by performing intra prediction using a planar mode.

The image decoding apparatus 2000 may generate a final prediction block 2780 of the current block 2700 by calculating the weighted sum of the first prediction block 2720, the second prediction block 2730, and the third prediction block 2740. In an embodiment, a weight to be used for a weighted sum may be a predefined fixed value or may be a value calculated by using a predefined method.

In an embodiment, a first weight 2750, a second weight 2760, and a third weight 2770 which are used in the weighted sum of the first prediction block 2720, the second prediction block 2730, and the third prediction block 2740 may be derived by using Equation 4 below. The first weight 2750, the second weight 2760, and the third weight 2770 may indicate weights to be respectively applied to the first prediction block 2720, the second prediction block 2730, and the third prediction block 2740.

$$\begin{matrix}{w}_{1} = a * \frac{ampl ( M 1 )}{ampl ( M 1 ) + ampl ( M 2 )} \\ {w}_{2} = b * \frac{ampl ( M 2 )}{ampl ( M 1 ) + ampl ( M 2 )} \\ {w}_{3} = c\end{matrix} \qquad [ Equation 4 ]$$

In Equation 4, w₁, w₂, w₃ respectively indicate the first weight 2750, the second weight 2760, and the third weight 2770. ampl(M1) may indicate amplitude corresponding to M1 intra prediction mode, and ampl(M2) may indicate amplitude corresponding to M2 intra prediction mode. In an example, a, b, c may be predefined constant values. For example, a:b:c may be 2:2:1. Alternatively, for example, a may be 43/64, b may be 43/64, and c may be 21/64.

Alternatively, in an embodiment, a weight to be used for a weighted sum of a prediction block may be determined based on gradient information of a neighboring block. This will now be described with reference to FIG. 28.

FIG. 28 is a diagram for describing a method of adaptively determining a weight, according to an embodiment.

Referring to FIG. 28, sample-based blending may be performed based on gradient information obtained from at least one of a left region 2810, an above region 2820, or an above-left region 2830, which are of a current block 2800. Here, the sample-based blending indicates a weighted sum method of adaptively determining a weight via region segmentation. In other words, a weight to be used for a weighted sum of a DIMD process may be adaptively determined based on the gradient information obtained from at least one of the left region 2810, the above region 2820, or the above-left region 2830 of the current block 2800.

In an embodiment, when the sample-based blending is not used, the weighted sum of a predictor may be calculated by using the same method as described in the embodiment of FIG. 27 and Equation 4.

For the sample-based blending, a neighboring block of the current block 2800 may be segmented into the left region 2810, the above region 2820, and the above-left region 2830. Local gradient information may be obtained from each of the segmented three regions. Here, the local gradient information indicates gradient information calculated from a gradient between pixels included in each of the segmented regions.

In an embodiment, the local gradient information of at least one of the left region 2810, the above region 2820, or the above-left region 2830 may be used to determine a weight for generation of a final prediction block of the current block 2800.

In an embodiment, amplitudes corresponding to a DIMD mode may be identified in the local gradient information of the left region 2810, the above region 2820, and the above-left region 2830. In this regard, the DIMD mode indicates an intra prediction mode of the current block 2800 which is derived via a DIMD process. Here, an embodiment described above with reference to FIGS. 22 to 26 may be applied.

In an embodiment, local gradient information to be used to determine a weight may be selected by comparing sizes of the identified amplitudes. For example, among the local gradient information of the left region 2810, the above region 2820, and the above-left region 2830, local gradient information of a region having largest amplitude among amplitudes corresponding to a DIMD mode may be selected. In this case, a weight to be applied to a predictor generated according to the DIMD mode may be determined by using gradient information of the selected region. In this regard, gradient information of regions other than the selected region may not be considered in determination of the weight to be applied to the predictor generated according to the DIMD mode.

Alternatively, comparison between local gradient information of the left region 2810 and local gradient information of the above region 2820 may be performed. For example, when amplitude corresponding to the DIMD mode in the local gradient information of the above region 2820 is greater than amplitude corresponding to the DIMD mode in the local gradient information of the left region 2810, the weight to be applied to the predictor generated according to the DIMD mode may be determined based on gradient information of the above region 2820. Alternatively, in an example, when amplitude corresponding to the DIMD mode in local gradient information of one of the above region 2820 or the left region 2810 is greater than amplitude corresponding to the DIMD mode in local gradient information of the other one by a predefined size or more, the weight may be determined by using the local gradient information (that has the amplitude being larger by the predefined size or more) of the corresponding region. In an example, the predefined size may be twice as large.

In an embodiment, when the sample-based blending is used, the weight may be derived without additional signaling. Therefore, an encoder may not need to perform a new rate distortion (RD) check.

According to an embodiment of the present disclosure, gradient information of a block decoded prior to a current block may be referenced to generate gradient information of the current block. In the present disclosure, a block decoded prior to a current block may be referred to as a previous block. For example, when the DIMD merge mode is applied, gradient information of the previous block may be referenced to generate gradient information of the current block.

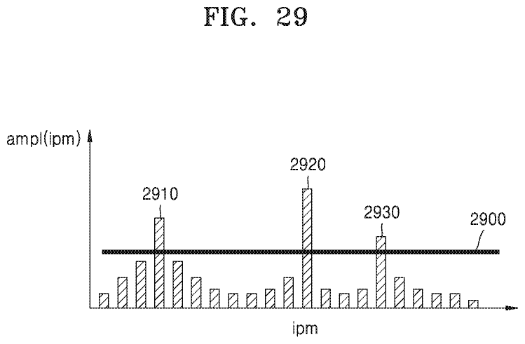

When the current block is decoded, the gradient information of the previous block has to have been stored so as to refer to the gradient information of the previous block. Hereinafter, an effective method of storing gradient information of a previous block and various methods of using stored gradient information of a previous block in prediction of a current block will now be described in detail with reference to FIGS. 29 to 38.

FIG. 29 is a diagram for describing a method of storing gradient information, according to an embodiment.

FIG. 29 illustrates an example of gradient information of a previous block of a current block. The previous block of the current block may be a block included in an area encoded/decoded prior to the current block.

In an embodiment, gradient information of a previous block may be generated from a gradient of samples included in the previous block or samples reconstructed prior to the previous block. The gradient information of the previous block may include intra prediction modes and amplitudes of the intra prediction modes.

As described above, in order to derive an intra prediction mode of the current block by using the gradient information of the previous block, the gradient information of the previous block has to have been stored when the current block is reconstructed. However, when the gradient information of the previous block is changelessly stored, a load of a memory may increase, and thus, it may be preferable to decrease an amount of information included in the gradient information of the previous block and store the decreased gradient information.

In an embodiment, when storing the gradient information of the previous block, the image decoding apparatus 2000 may not changelessly store gradient information of a corresponding block but may selectively store only information about an intra prediction mode (or an angle) of which amplitude (or intensity) exceeds a predetermined threshold 2900. Alternatively, in an embodiment, the image decoding apparatus 2000 may selectively store only information about an intra prediction mode of which amplitude is equal to or greater than the predetermined threshold 2900.

The gradient information of the previous block which may be used in decoding of the current block may include an intra prediction mode corresponding to amplitude exceeding the predefined threshold 2900, and amplitude that exceeds the predefined threshold 2900 among amplitudes corresponding to intra prediction modes calculated from a gradient between at least two samples included in the previous block or at least two samples adjacent to the previous block.

As shown in FIG. 29, when gradient information is derived from the gradient between the at least two samples included in the previous block or the at least two samples adjacent to the previous block, amplitudes exceeding the threshold 2900 and three intra prediction modes 2910, 2920, and 2930 corresponding to the amplitudes may be stored as the gradient information of the previous block.

In an embodiment, the gradient information of the previous block may include a representative intra prediction mode of which amplitude exceeds the threshold 2900 and information about the amplitude of the representative intra prediction mode. That is, in the present disclosure, the representative intra prediction mode may indicate an intra prediction mode that exceeds the threshold 2900. One or more representative intra prediction modes may exist.

In an embodiment, the image decoding apparatus 2000 may store, as a representative value of a corresponding block, an intra prediction mode of which amplitude exceeds the threshold 2900 and the amplitude of the intra prediction mode. Referring to FIG. 29, the three intra prediction modes 2910, 2920, and 2930 of which amplitudes exceed the threshold 2900 and the respective amplitudes of the intra prediction modes may be included as representative values in gradient information, and the representative value including the representative values may be stored.

In an embodiment, a unit for storing gradient information may be a coding unit (CU), a prediction unit (PU), or a transform unit (TU). Alternatively, a unit for storing gradient information may be a predefined fixed unit. That is, an intra prediction mode exceeding the predefined threshold 2900 and amplitude corresponding thereto may be stored for each predefined unit.

In an embodiment, the threshold 2900 may be determined by using various methods. In an example, the threshold 2900 may be a predetermined value. In an example, the threshold 2900 may be a fixed value. For example, the predetermined value may be a value of 1, 2, 3, 4, etc. Also, in an example, the threshold 2900 may be adaptively determined according to a bit depth of an image. For example, the threshold 2900 may be defined by using Equation 5 below.

$$Threshold = 1 ≪ ( bitDepth - N ) , ( N = 1 , 2 , 3 , … ) ) \qquad [ Equation 5 ]$$

Also, in an example, the threshold 2900 may be adaptively determined according to a channel (or a color component). The channel may indicate whether the channel is a luma component or a chroma component. When the threshold 2900 is adaptively determined according to the channel, a predetermined value of the method described above or N value in Equation 5 may be differently set according to the channel.

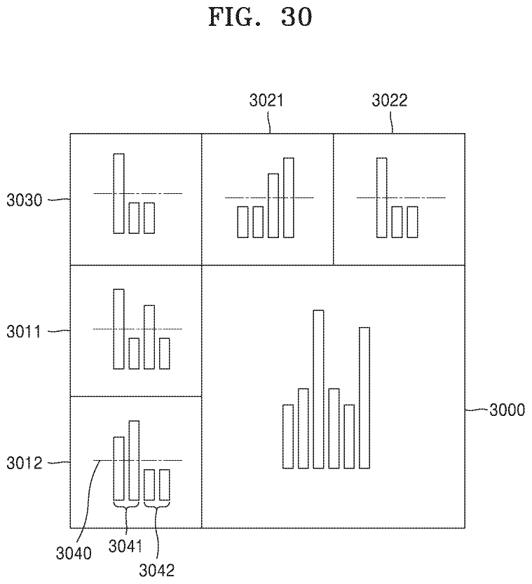

The image decoding apparatus 2000 may obtain gradient information of a current block to which an inclination of a neighboring block is reflected by accumulating stored gradient information of the neighboring block, and may derive an intra prediction mode based on the obtained gradient information. This will be described in detail below with reference to FIG. 30.

FIG. 30 is a diagram for describing a method of generating gradient information of a current block by using gradient information of a previous block, according to an embodiment.

Referring to FIG. 30, the image decoding apparatus 2000 may use prediction information of a previous block so as to derive an intra prediction mode of a current block 3000. The prediction information may include gradient information, or may include intra prediction mode information derived based on the gradient information. In other words, the prediction information may be all or part of the gradient information obtained according to embodiments described with reference to FIGS. 23 to 25, or may be the intra prediction mode information derived based on the obtained gradient information.

Referring to FIG. 30, gradient information of the current block 3000 may be generated by using the gradient information of the previous block. Referring to FIG. 30, it is assumed that the previous block used to generate the gradient information of the current block 3000 is a neighboring block adjacent to the left side, the above side, or the above-left side of the current block 3000, but the present disclosure is not limited thereto.

For example, the previous block that may be used to generate the gradient information of the current block 3000 may be a neighboring block adjacent to at least one of the left side, the above side, or the above-left side of the current block 3000 as shown in FIG. 30.

In an embodiment, the previous block that may be used to generate the gradient information of the current block 3000 may be a block that is spatially or temporally adjacent to the current block 3000.

In an embodiment, the previous block that may be used to generate the gradient information of the current block 3000 may be a not-adjacent neighboring block that is not adjacent to the current block 3000. In an example, the previous block may be a reference block specified in a current picture or a reference picture, based on motion information.

Gradient information as shown in FIG. 30 may be stored for each of left neighboring blocks 3011 and 3012, above neighboring blocks 3021 and 3022, and an above left neighboring block 3030. In this regard, an embodiment described with reference to FIG. 29 may be applied. That is, amplitude exceeding a threshold among amplitudes corresponding to intra prediction modes calculated from a gradient between at least two samples inside/outside a previous block, and gradient information including an intra prediction mode corresponding to the amplitude exceeding a threshold may be stored for each of neighboring blocks.

In an embodiment, among intra prediction modes 3041 and 3042 derived from the first left neighboring block 3012, only the intra prediction modes 3041 of which amplitudes exceed a threshold 3040 and the amplitudes corresponding thereto may be stored as gradient information of the first left neighboring block 3012.

In an embodiment, the gradient information of the current block 3000 may be generated by summing amplitudes for each intra prediction mode included in the gradient information of the left neighboring blocks 3011 and 3012, the above neighboring blocks 3021 and 3022, and the above left neighboring block 3030, based on each corresponding intra prediction mode. In other words, the gradient information of the current block 3000 may be generated by accumulating intra prediction modes included in gradient information of a neighboring block and amplitudes of the corresponding intra prediction modes. Amplitudes for each intra prediction mode may be summed. With reference to drawings below, a process of generating the gradient information of the current block 3000 will now be described in detail.

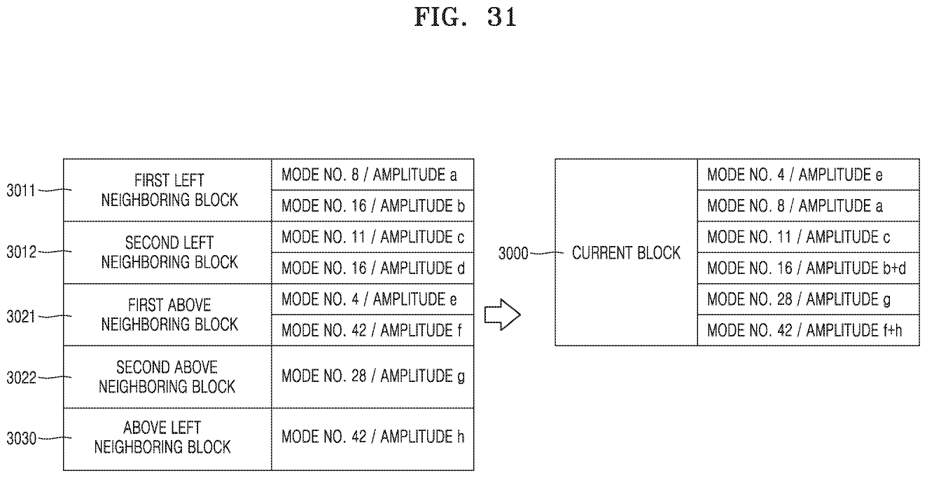

FIG. 31 is a diagram for describing a method of generating gradient information of a current block by using gradient information of a previous block, according to an embodiment.

Referring to FIG. 31, gradient information may be stored for each of the first left neighboring block 3011, the second left neighboring block 3012, the first above neighboring block 3021, the second above neighboring block 3022, and the above left neighboring block 3030 of the current block 3000 as shown in FIG. 31.

In an embodiment, the gradient information of the first left neighboring block 3011 may include an angular mode no. 8 and amplitude a corresponding thereto, and an angular mode no. 16 and amplitude b corresponding thereto. The gradient information of the second left neighboring block 3012 may include an angular mode no. 11 and amplitude c corresponding thereto, and an angular mode no. 16 and amplitude d corresponding thereto. The gradient information of the first above neighboring block 3021 may include an angular mode no. 4 and amplitude e corresponding thereto, and an angular mode no. 42 and amplitude f corresponding thereto. The gradient information of the second above neighboring block 3022 may include an angular mode no. 28 and amplitude g corresponding thereto. The gradient information of the above left neighboring block 3030 may include an angular mode no. 42 and amplitude h corresponding thereto.

As described above, the gradient information of the current block 3000 may be generated by accumulating the intra prediction modes included in the gradient information of the left neighboring blocks 3011 and 3012, the above neighboring blocks 3021 and 3022, and the above left neighboring block 3030 and amplitudes of the intra prediction modes. Amplitudes for each intra prediction mode may be summed.

For example, when it is identified that amplitude corresponding to the angular mode no. 16 is b, based on the gradient information of the first left neighboring block 3011, and amplitude corresponding to the angular mode no. 16 is d, based on the gradient information of the second left neighboring block 3012, amplitude corresponding to the angular mode no. 16 in the gradient information of the current block 3000 may be b+d.

Equally, when it is identified that amplitude corresponding to the angular mode no. 42 is f, based on the gradient information of the first above neighboring block 3021, and amplitude corresponding to the angular mode no. 42 is h, based on the gradient information of the above left neighboring block 3030, amplitude corresponding to the angular mode no. 42 in the gradient information of the current block 3000 may be f+h.

In an embodiment, the gradient information of the current block 3000 may include, without summing amplitudes, an intra prediction mode that is not redundantly included in a plurality of neighboring blocks and is among the intra prediction modes included in the gradient information of the left neighboring blocks 3011 and 3012, the above neighboring blocks 3021 and 3022, and the above left neighboring block 3030. In an embodiment, the image decoding apparatus 2000 may derive an intra prediction mode, based on the obtained gradient information.

The image decoding apparatus 2000 may derive a plurality of intra prediction modes, based on the generated gradient information. A maximum number of intra prediction modes to be derived may be predefined. For example, the maximum number may be defined as 2, 3, 4, 5, etc. For example, a predetermined number of intra prediction modes in descending order of amplitude among intra prediction modes included in the generated gradient information may be derived as an intra prediction mode of the current block.

In an embodiment, the image decoding apparatus 2000 may generate a final prediction block by combining predictors generated according to the derived intra prediction mode.

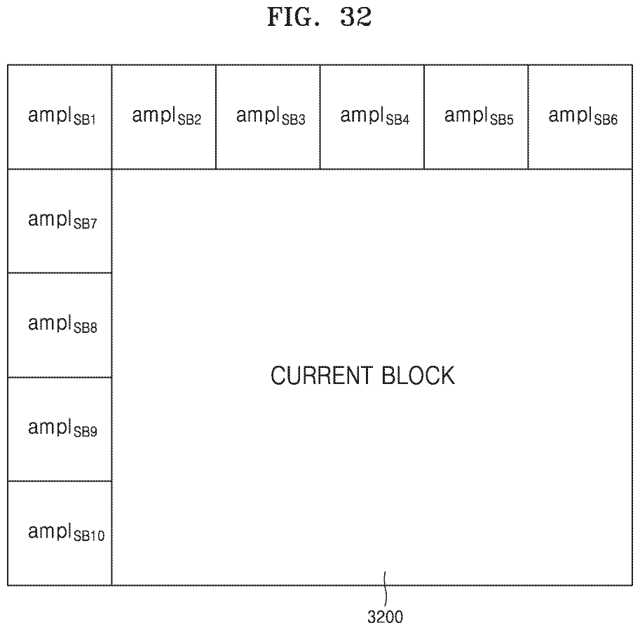

FIG. 32 is a diagram for describing an intra prediction method of referring to gradient information of a previous block, according to an embodiment.

Referring to FIG. 32, the image decoding apparatus 2000 may store, as a representative value, amplitude obtained by summing gradients calculated from all pixel areas included in a previous block. Referring to FIG. 32, it is assumed that a previous block used to generate gradient information of a current block 3200 is a neighboring block adjacent to the left side, the above side, or the above-left side of the current block 3200, but the present disclosure is not limited thereto. Referring to FIG. 32, the previous block may be expressed as a sub block. The sub block may be a unit within which gradient information is stored.

In an embodiment, amplitude stored with respect to a previous block may be calculated by finally summing a result of summing horizontal-direction gradients and a result of summing vertical-direction gradients which are calculated from all pixel areas included in the previous block. All pixel areas included in the previous block may correspond to all windows to which filtering may be applied in the previous block. In the present disclosure, a pixel area included in a previous block may be referred to as a sample set included in the previous block.

In an embodiment, the image decoding apparatus 2000 may obtain amplitude at a particular angle (or intra prediction mode) by summing gradients in all pixels in a block by using Equation 6 below. In an embodiment, the particular angle (or intra prediction mode) may be a representative intra prediction mode.

$${ampl}_{SB} = \vert {G}_{ver 1} + {G}_{ver 2} + {G}_{ver 3} + {G}_{ver 4} + … + {G}_{verN} \vert + \vert {G}_{hor 1} + {G}_{hor 2} + {G}_{hor 3} + {G}_{hor 4} + … + {G}_{horM} \vert \qquad [ Equation 6 ]$$

Referring to Equation 6, amplitude to be stored in the previous block may be obtained by summing a first result and a second result, the first result being obtained by summing horizontal-direction gradients calculated from all sample sets included in the previous block and the second result being obtained by summing vertical-direction gradients calculated from all sample sets included in the previous block.

In an embodiment, gradient information of the previous block may include amplitude ampl_{SB}, which corresponds to a third result obtained by summing the first result and the second result, and one intra prediction mode corresponding to amplitude ampl_{SB}.

In an embodiment, when a block size varies, a normalization process may be performed. For example, the normalization process may be performed by dividing a value calculated using Equation 6 by the number of all pixels. Alternatively, in an embodiment, the normalization process may be performed on the value calculated using Equation 6, based on the number of samples included in all sample sets of the previous block or the number of sample sets. For example, the normalization process may be performed by dividing the value calculated using Equation 5 by the number of samples included in all sample sets or the number of sample sets. As values to which normalization is applied are stored, accurate comparison between blocks may be possible, and prediction accuracy may be increased.

In an embodiment, a block that is a unit for storing gradient information may be CU, PU, or TU. Alternatively, the block may be a unit having a predefined fixed size. In an example, amplitude ampls_{BK} that exceeds a predetermined threshold among each of blocks may be inferred as a representative intra prediction mode, and thus, may be stored as representative amplitude with respect to the representative intra prediction mode.

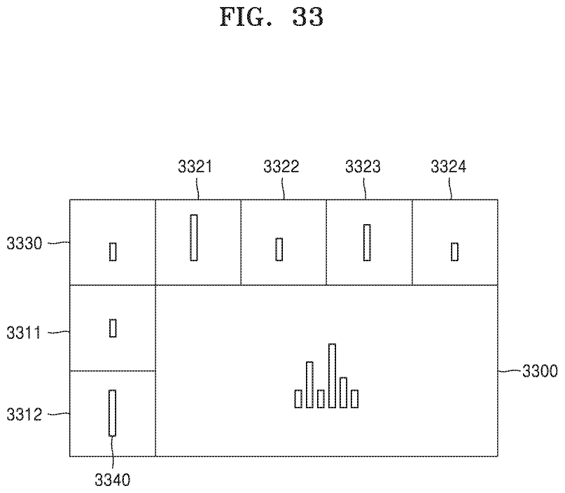

FIG. 33 is a diagram for describing a method of generating gradient information of a current block by using gradient information of a previous block, according to an embodiment.

Referring to FIG. 31, gradient information of a current block 3300 may be generated by using gradient information of a previous block. Referring to FIG. 33, it is assumed that the previous block used to generate the gradient information of the current block 3300 is a neighboring block adjacent to the left side, the above side, or the above-left side of the current block 3300, but the present disclosure is not limited thereto.

For example, the previous block to which the present embodiment is applicable may be a neighboring block adjacent to the left side, the above side, or the above-left side of the current block 3300 as shown in FIG. 33, may be a spatially or temporally adjacent block, may be a not-adjacent neighboring block that is not adjacent to the current block 3300, or may be a reference block specified in a current picture or a reference picture, based on motion information.

Gradient information as shown in FIG. 33 may be stored for each of left neighboring blocks 3311 and 3312, above neighboring blocks 3321, 3322, 3323, and 3324, and an above left neighboring block 3330. In this regard, an embodiment described with reference to FIG. 32 may be applied. That is, amplitude obtained by summing horizontal and vertical-direction gradients calculated from all sample sets included in a corresponding neighboring block, and one intra prediction mode may be stored as gradient information in the corresponding neighboring block.

In an embodiment, amplitude obtained by summing horizontal and vertical-direction gradients calculated from all sample sets included in the first left neighboring block 3312, and an intra prediction mode 3340 corresponding to the amplitude may be stored as gradient information of the first left neighboring block 3312.

In an embodiment, the gradient information of the current block 3300 may be generated by summing amplitudes for each intra prediction mode included in the gradient information of the left neighboring blocks 3311 and 3312, the above neighboring blocks 3321, 3322, 3323, and 3324, and the above left neighboring block 3330, based on each corresponding intra prediction mode. In other words, the gradient information of the current block 3300 may be generated by accumulating intra prediction modes included in gradient information of a neighboring block and amplitudes of the corresponding intra prediction modes. Amplitudes for each intra prediction mode may be summed. With reference to drawings below, a process of generating the gradient information of the current block 3300 will now be described in detail.

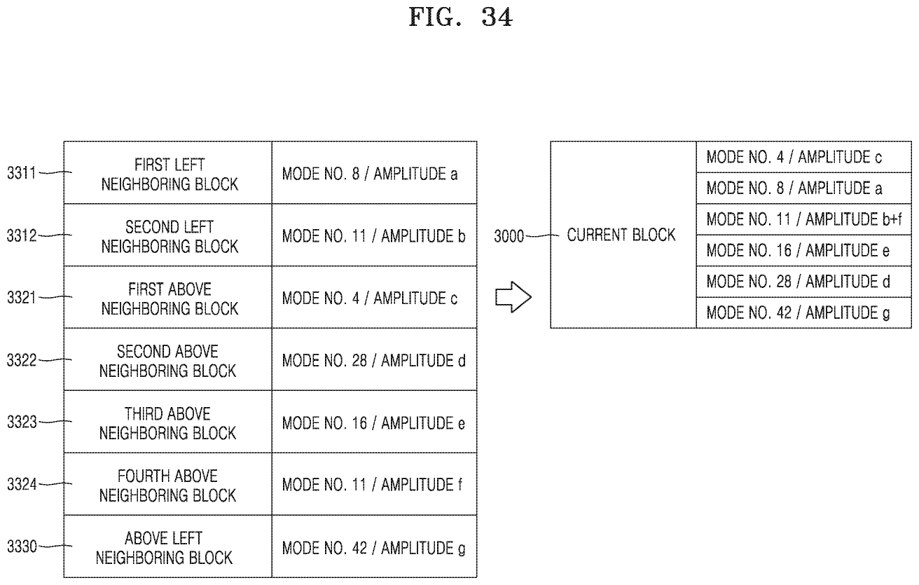

FIG. 34 is a diagram for describing a method of generating gradient information of a current block by using gradient information of a previous block, according to an embodiment.

Referring to FIG. 34, gradient information may be stored for each of the first left neighboring block 3311, the second left neighboring block 3312, the first above neighboring block 3321, the second above neighboring block 3322, the third above neighboring block 3323, the fourth above neighboring block 3324, and the above left neighboring block 3330 of the current block 3300 as shown in FIG. 31.

In an embodiment, the gradient information of the first left neighboring block 3311 may include an angular mode no. 8 and amplitude a corresponding thereto. The gradient information of the first left neighboring block 3312 may include an angular mode no. 11 and amplitude b corresponding thereto. The gradient information of the first above neighboring block 3321 may include an angular mode no. 4 and amplitude c corresponding thereto. The gradient information of the second above neighboring block 3322 may include an angular mode no. 28 and amplitude d corresponding thereto. The gradient information of the third above neighboring block 3323 may include an angular mode no. 16 and amplitude e corresponding thereto. The gradient information of the fourth above neighboring block 3324 may include an angular mode no. 11 and amplitude f corresponding thereto. The gradient information of the above left neighboring block 3330 may include an angular mode no. 42 and amplitude g corresponding thereto.

As described above, the gradient information of the current block 3300 may be generated by accumulating the intra prediction modes included in the gradient information of the left neighboring blocks 3311 and 3312, the above neighboring blocks 3321, 3322, 3323, and 3324, and the above left neighboring block 3330 and amplitudes of the intra prediction modes. Amplitudes for each intra prediction mode may be summed.

For example, when it is identified that amplitude corresponding to the angular mode no. 11 is b, based on the gradient information of the first left neighboring block 3312, and amplitude corresponding to the angular mode no. 11 is f, based on the gradient information of the second left neighboring block 3012, amplitude corresponding to the angular mode no. 11 in the gradient information of the current block 3000 may be b+f.

In an embodiment, the gradient information of the current block 3300 may include, without summing amplitudes, an intra prediction mode that is not redundantly included in a plurality of neighboring blocks and is among the intra prediction modes included in the left neighboring blocks 3311 and 3312, the above neighboring blocks 3321, 3322, 3323, and 3324, and the above left neighboring block 3330.

In an embodiment, the image decoding apparatus 2000 may derive an intra prediction mode, based on the generated gradient information. The image decoding apparatus 2000 may derive a plurality of intra prediction modes, based on the generated gradient information. A maximum number of intra prediction modes to be derived may be predefined. For example, the maximum number may be defined as 2, 3, 4, 5, etc. For example, a predetermined number of intra prediction modes in descending order of amplitude among intra prediction modes included in the generated gradient information may be derived as an intra prediction mode of the current block.

In an embodiment, the image decoding apparatus 2000 may generate a final prediction block by combining predictors generated according to the derived intra prediction mode.

Hereinafter, a previous block that may be used to generate gradient information of a current block will now be described.

In an embodiment, when the gradient information of the current block is configured, the image decoding apparatus 2000 may refer to gradient information of a reference block included in a current picture or a reference picture. That is, the image decoding apparatus 2000 may generate/update the gradient information of the current block by referring to gradient information stored in a reference block specified by a block vector (BV) in a current picture. In an example, the reference block may be specified by a block vector of the current block, in the current picture including the current block.

Alternatively, the image decoding apparatus 2000 may generate/update the gradient information of the current block by referring to gradient information stored in a reference block specified by a motion vector in a reference picture. In an example, the reference block may be specified by a motion vector of a spatial or temporal neighboring block of the current block in the reference picture of the current block.

In an embodiment, when gradient information of a current block is configured according to the embodiments described above with reference to FIGS. 23 to 25, the image decoding apparatus 2000 may refer to gradient information of a reference block. Alternatively, when gradient information of a current block is configured according to a DIMD merge mode according to the embodiment described above with reference to FIG. 26, the image decoding apparatus 2000 may refer to gradient information of a reference block.

In an embodiment, gradient information referenced from a reference block specified by a motion vector or a block vector may be gradient information stored according to the embodiments described above with reference to FIGS. 29 to 34.

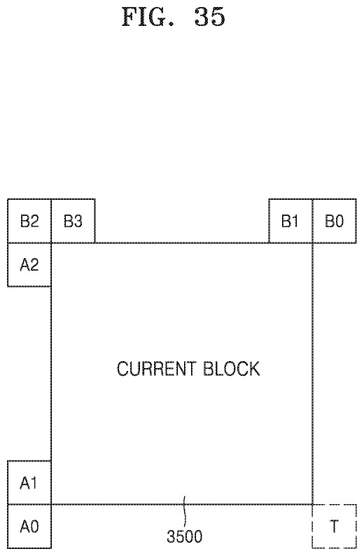

Also, in an embodiment, when gradient information of a current block is configured, the image decoding apparatus 2000 may refer to gradient information of a spatial and/or temporal neighboring block of the current block. In an example, the image decoding apparatus 2000 may configure the gradient information of the current block by referring to the gradient information of the spatial and/or temporal neighboring block for motion vector derivation. This will be described below with reference to FIG. 35.

FIG. 35 is a diagram of an example of locations of spatial and temporal neighboring blocks, according to an embodiment.

Referring to FIG. 35, the spatial and temporal neighboring blocks of a current block 3500 may be defined as blocks at various locations. In an example, the spatial and temporal neighboring blocks may be merge candidates.

In an embodiment, a spatial neighboring block of the current block 3500 may be defined as blocks at locations A0, A1, A2, B0, B1, B2, and B3 shown in FIG. 35. In this regard, blocks at some locations may be omitted or a block at a location other than the locations shown in FIG. 35 may be additionally used as a spatial neighboring block.

Also, a temporal neighboring block of the current block 3500 may be defined as a block at location T shown in FIG. 32. The temporal neighboring block may be a block included in a reference picture or a collocated picture. In an example, a block at a location other than location T may be defined as the temporal neighboring block of the current block 3500, and a block at a location in addition to location T may be defined as a temporal neighboring block of the current block 3500.

In an embodiment, when gradient information of the current block 3500 is configured, the image decoding apparatus 2000 may refer to gradient information of the current block's spatial and/or temporal neighboring blocks at the locations shown in FIG. 35. The image decoding apparatus 2000 may generate/update the gradient information of the current block by referring to the gradient information stored in the current block's spatial and/or temporal neighboring blocks at the locations shown in FIG. 35.

Also, in an embodiment, the image decoding apparatus 2000 may refer to gradient information of a block at a not-adjacent location. In this regard, the not-adjacent location may be a location of a not-adjacent merge candidate. The location of the not-adjacent merge candidate may be defined as a particular location in a grid having a predefined size.

According to the present embodiment, accuracy of DIMD-based intra prediction may be increased by updating gradient information of a current block, based on gradient information of a neighboring block used for motion prediction.

Also, when the gradient information of the current block is configured, the image decoding apparatus 2000 may refer to gradient information of a reference block in a current picture. Here, the reference block in the current picture may be specified by a block vector derived by intra template matching prediction or intra block copy.

A reference block specified by a block vector used in inter-frame prediction or a block vector used in inter-frame prediction may have high similarity to the current block. Therefore, accuracy of DIMD-based intra prediction may be increased by combining gradient information of the current block with gradient information of the reference block specified by the motion vector and block vector.

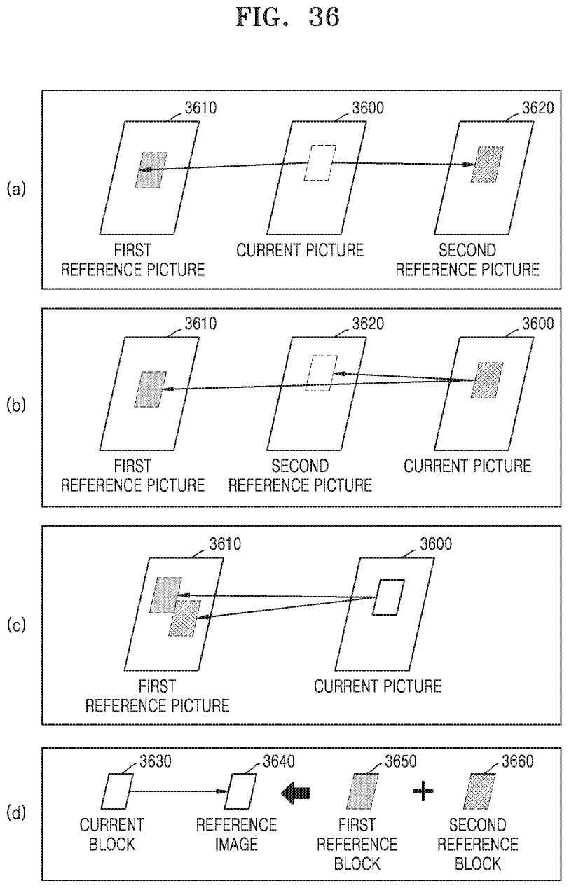

According to the conventional image compression technology, gradient information is used only to find prediction directionality in an intra mode. Aside from this, according to an embodiment of the present disclosure, the gradient information may be used in various prediction methods. This will be described below with reference to FIG. 36.

FIG. 36 is a diagram for describing a method of referring to gradient information in an inter mode, according to an embodiment.

Referring to FIG. 36, gradient information may be stored in an inter prediction process. The gradient information may be stored in a unit of a coding unit (CU), a prediction unit (PU), or a transform unit (TU). Alternatively, the gradient information may be stored in a block unit having a predefined fixed size.

In an embodiment, when performing the weighted sum of reference blocks derived from reference pictures in both directions, gradient information of the reference blocks may be used. (a) of FIG. 36 indicates bi-directional prediction in which a current picture 3600 is temporally located between a first reference picture 3610 and a second reference picture 3620. (b) of FIG. 36 indicates bi-directional prediction in which the first reference picture 3610 and the second reference picture 3620 are located in the same direction with respect to the current picture 3600. (c) of FIG. 36 indicates bi-directional prediction in which two reference blocks are derived from the first reference picture 3610 that is the same reference picture.

Referring to (d) of FIG. 36, the weighted sum of a first reference block 3650 and a second reference block 3660 which are derived via the bi-directional predictions as in (a) to (c) of FIG. 36 is calculated, such that a reference image 3640 of a current block 3630 may be generated. The reference image 3640 may be a prediction block of the current block 3630.

In an embodiment, weights used in the weighted sum of the first reference block 3650 and the second reference block 3660 may be determined based on gradient information of the first reference block 3650 and the second reference block 3660. For example, the gradient information of the first reference block 3650 and the second reference block 3660 may be compared with gradient information of the current block 3630, and a relatively large weight may be applied to a reference block having high similarity.

Also, in an embodiment, in an intra template matching prediction or intra block copy mode, prediction may be performed by referring to stored gradient information. For example, when a plurality of block vectors are found, a reference block having relatively more similar inclination to gradient information of a current block may be defined as a most similar block in a frame. In other words, when a plurality of reference blocks are specified by a block vector, a reference block having relatively similar gradient information to the gradient information of the current block may be selected.

That is, a template of which gradient information is similar may be added to a search candidate list, and an order of candidates in the search candidate list may be determined by considering similarity of gradient information. Determination on similarity of gradient information may be performed by comparing values of amplitudes according to intra prediction modes, or mapped representative intra prediction modes may be compared.

Also, in an embodiment, when a merge candidate list is configured by using spatial/temporal merge candidates, merge candidates included in the merge candidate list may be reordered. In an example, the merge candidate list may include not-adjacent merge candidates.

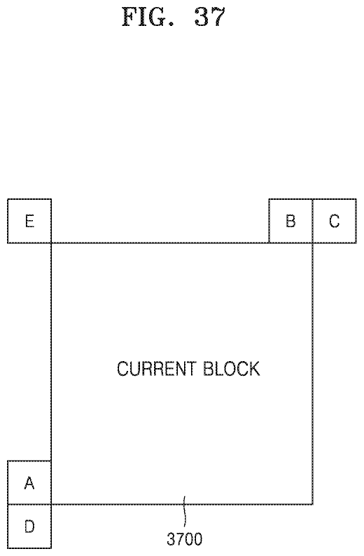

FIG. 37 is a diagram illustrating locations of neighboring blocks used in intra prediction, according to an embodiment.

Referring to FIG. 37, locations of neighboring blocks of a current block 3700 which are used as most probable mode (MPM) candidates. According to the conventional image compression technology, intra prediction mode information is signaled by using MPM so as to efficiently encode/decode 67 intra prediction modes. The neighboring blocks of the current block 3700 may include blocks at locations of A, B, C, D, and E. In this regard, blocks at some locations may be omitted, or a block at a location other than the location shown in FIG. 37 may be additionally used as an MPM candidate.

6 MPM candidates may be configured based on intra prediction modes of neighboring blocks of the current block 3700 by using a feature in which, when blocks are encoded/decoded via intra prediction, an intra prediction mode of the neighboring blocks is similarity determined. Such configured 6 MPM candidates may be included in the MPM list. In an example, the MPM list may be configured by excluding a particular candidate from all MPM lists. For example, the particular candidate may be a planar mode, a DC mode, etc.

When an intra prediction mode of the current block 3700 is included in the MPM list, i.e., when an MPM is used in intra prediction of the current block 3700, an MPM index may be signaled. The MPM index may indicate a candidate to be used in intra prediction of the current block 3700 among MPM candidates included in the MPM list. When the intra prediction mode of the current block 3700 is not included in the MPM list, i.e., when the MPM is not used in intra prediction of the current block 3700, intra prediction mode encoding with respect to the current block 3700 in an intra prediction mode group configured while excluding 6 MPM candidates may be performed.

In an embodiment, when gradient information of the current block 3700 is configured, the image decoding apparatus 2000 may refer to gradient information of an MPM candidate block. That is, the gradient information of the current block 3700 may be generated/updated based on gradient information stored in a neighboring block of the current block 37000 which is used as an MPM candidate. As gradient information of blocks at locations of neighboring MPM candidates of the current block 3700 is combined with the gradient information of the current block 3700, accuracy of DIMD prediction with respect to the current block 3700 may be increased.

Also, in an embodiment, when an MPM list with respect to the current block 3700 is configured, the image decoding apparatus 2000 may add, as an MPM candidate, a DIMD mode of the current block 3700 to the MPM list. Here, the DIMD mode indicates an intra prediction mode derived by a decoder via a DIMD process. The DIMD mode may correspond to one intra prediction mode or may correspond to a plurality of intra prediction modes. In the present disclosure, the DIMD mode may be referred to as a representative intra prediction mode. The number of DIMD modes added to the MPM list may be predefined. Alternatively, when the DIMD mode corresponds to the plurality of intra prediction modes, the DIMD mode may be added to the MPM list until a maximum number in the MPM list is satisfied.

Also, in an embodiment, the image decoding apparatus 2000 may add, as an MPM candidate, a DIMD mode of a MPM candidate block of the current block 3700 to the MPM list.

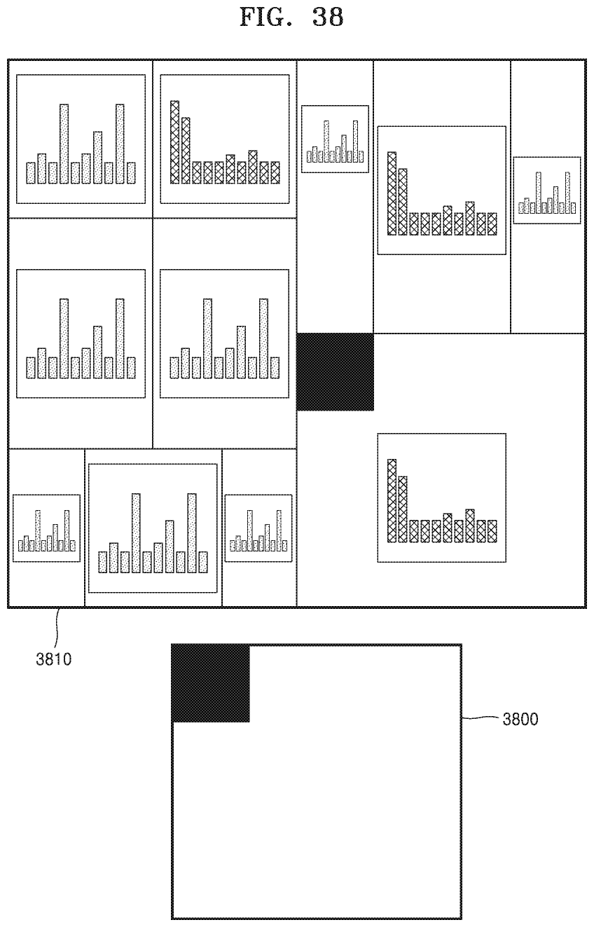

FIG. 38 is a diagram illustrating an example of an intra prediction method for a chroma block, according to an embodiment.

Referring to FIG. 38, a DIMD process may be performed on a chroma block. When DIMD is applied to a current chroma block 3800, the image decoding apparatus 2000 may refer to gradient information of a corresponding luma block 3810 of the current chroma block 3800. That is, gradient information of the current chroma block 3800 may be generated/updated by using gradient information of the corresponding luma block 3810 of the current chroma block 3800.

In an embodiment, a location of the corresponding luma block 3810 referenced in a DIMD process with respect to the current chroma block 3800 may be defined as various locations in the corresponding luma block 3810. For example, the location of the corresponding luma block 3810 referenced in the DIMD process with respect to the current chroma block 3800 may be defined as a center location in the corresponding luma block 3810. Here, the center location may be defined as a luma block including a center below right pixel as shown in FIG. 38, or may be defined as a luma block including a center below left pixel, an above right pixel, and an above left pixel. In an example, a block at the center location in the corresponding luma block 3810 may be referred to as the corresponding luma block 3810.

Also, in an embodiment, the location of the corresponding luma block 3810 of the current chroma block 3800 which is referenced in the DIMD process with respect to the current chroma block 3800 may be defined as above-left, above-right, below-left, and below-right locations in the corresponding luma block 3810. Also, neighboring blocks around the center location block in the corresponding luma block 3810 may be referenced in the DIMD process with respect to the current chroma block 3800. In an example, gradient information of the current chroma block 3800 may be generated/updated by referring to gradient information of all luma blocks in the corresponding luma block 3810.

In a case of I-slice, a luma component block and a chroma component block may have coding trees that are independent of each other (i.e., dual tree structure). Here, there may be one or more luma component blocks which correspond to a chroma component block. Accordingly, not only corresponding luma blocks but also neighboring blocks of a corresponding block may be referenced in DIMD prediction. That is, as DIMD prediction information about one or more luma component blocks which correspond to the chroma component block is referenced, accuracy of DIMD prediction with respect to the chroma component block may be increased.

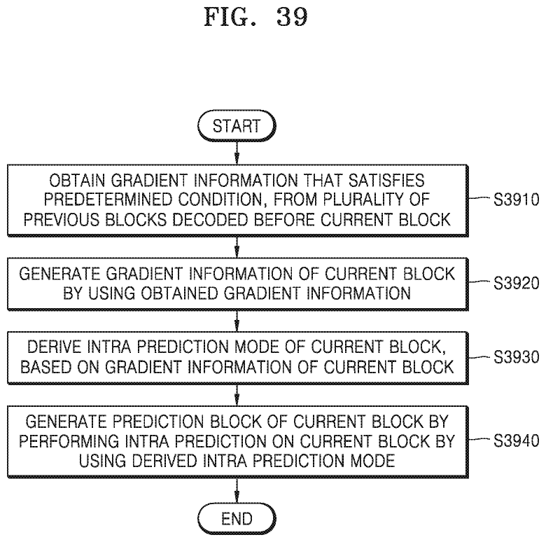

FIG. 39 is a flowchart of an image decoding method, according to an embodiment.

In operation S3910, the image decoding apparatus 2000 may obtain gradient information from a plurality of previous blocks decoded prior to a current block. Here, the gradient information may include a first value corresponding to at least one intra prediction mode, and a second value corresponding to the first value.

In an embodiment, the gradient information that satisfies a predetermined condition may be obtained from a first previous block among the plurality of previous blocks. The gradient information that satisfies the predetermined condition and is obtained from the first previous block may include a second value exceeding a predefined threshold among second values calculated from a gradient between at least two samples included in the first previous block or between at least two samples adjacent to the first previous block, and a first value corresponding to the second value exceeding the threshold.

In an embodiment, the threshold may be predefined as a fixed value or a value determined according to a bit depth.

In an embodiment, the gradient information that satisfies the predetermined condition may be obtained from a second previous block among the plurality of previous blocks. The gradient information that satisfies the predetermined condition and is obtained from the second previous block may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value. In an example, as described above with reference to FIGS. 32 to 34, the gradient information of the second previous block may include one first value.

Alternatively, in an embodiment, the gradient information that satisfies the predetermined condition may be obtained from a third previous block among the plurality of previous blocks. The gradient information that satisfies the predetermined condition and is obtained from the third previous block may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value. In an example, as described above with reference to FIGS. 32 to 34, the gradient information of the third previous block may include one first value.

In an embodiment, a previous block may include a reference block that is specified in a reference picture of a current block according to motion information of a spatial or temporal neighboring block of the current block.

In an embodiment, the previous block may include a reference block that is specified by a block vector of the current block in a current picture including the current block.

In operation S3920, the image decoding apparatus 2000 may generate gradient information of the current block by using the obtained gradient information.

In an embodiment, the image decoding apparatus 2000 may generate the gradient information of the current block by summing amplitudes for each intra prediction mode included in gradient information of a plurality of previous blocks, based on each corresponding intra prediction mode. In other words, the image decoding apparatus 2000 may generate the gradient information of the current block by summing second values included in the gradient information of the plurality of previous blocks, based on each corresponding intra prediction mode.

In operation S3930, the image decoding apparatus 2000 may derive an intra prediction mode of the current block, based on the gradient information of the current block.

In an embodiment, the image decoding apparatus 2000 may derive, as the intra prediction mode of the current block, intra prediction modes corresponding to a predetermined number of amplitudes having largest sizes among amplitudes corresponding to the intra prediction modes included in the gradient information of the current block. In other words, the image decoding apparatus 2000 may derive, as the intra prediction mode of the current block, intra prediction modes corresponding to a predetermined number of largest second values among second values included in the gradient information of the plurality of previous blocks.

In operation S3940, the image decoding apparatus 2000 may generate a prediction block of the current block by performing intra prediction on the current block using the derived intra prediction mode.

In an embodiment, when a plurality of intra prediction modes are derived by using the gradient information of the current block, the image decoding apparatus 2000 may generate temporary prediction blocks, based on each of the derived plurality of intra prediction modes and a planar mode. The image decoding apparatus 2000 may generate the prediction block of the current block by performing the weighted sum of the temporary prediction blocks.

In an embodiment, the image decoding apparatus 2000 may reconstruct the current block by using the prediction block.

In an embodiment, the image decoding apparatus 2000 may determine the prediction block as the reconstructed current block.

In an embodiment, the image decoding apparatus 2000 may generate the reconstructed current block by combining residual data obtained from a bitstream with the prediction block.

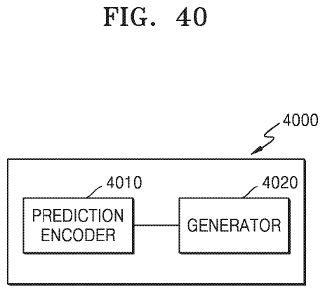

FIG. 40 is a block diagram illustrating a configuration of an image encoding apparatus according to an embodiment.

Referring to FIG. 40, an image encoding apparatus 4000 may include a prediction encoder 4010 and a generator 4020.

According to an embodiment, the prediction encoder 4010 and the generator 4020 may include or be implemented as at least one processor. In an embodiment, the prediction encoder 4010 and the generator 4020 may operate according to at least one instruction stored in at least one memory and executed by the at least one processor.

The image encoding apparatus 4000 may include at least one memory that stores input/output data of the prediction encoder 4010 and the generator 4020. Also, the image encoding apparatus 4000 may include a memory controller configured to control data input/output to/from the at least one memory.

In an embodiment, the prediction encoder 4010 may correspond to the prediction encoder 1915 shown in FIG. 19, and the generator 4020 may correspond to the entropy encoder 1925 shown in FIG. 19.

The prediction encoder 4010 may determine a prediction mode of a current block. The current block may be a largest coding unit, a coding unit, a transform unit, or a prediction unit, which is split from a current picture to be encoded.

In an embodiment, the prediction mode of the current block may be determined as one of a plurality of prediction modes including an intra mode and an inter mode.

In an embodiment, when the prediction mode of the current block is the intra mode, the prediction encoder 4010 may determine an intra prediction mode of the current block.

The intra prediction mode of the current block may be one of a plurality of intra prediction modes. As described with reference to FIG. 21, the plurality of intra prediction modes may include a non-angular intra mode and an angular intra mode.

In an embodiment, the prediction encoder 4010 may perform intra prediction or inter prediction on the current block according to the prediction mode of the current block, and may encode the current block by using a prediction block generated as a result of performing the intra prediction or the inter prediction.

In an embodiment, encoding of the current block may indicate a process of generating information for allowing the image decoding apparatus 2000 to reconstruct the current block. The information generated via encoding may be included in a bitstream.

In an embodiment, the prediction encoder 4010 may generate residual data corresponding to a difference between the prediction block and the current block. When the prediction block is determined as the current block, the residual data may not be generated.

According to an embodiment, when the prediction mode of the current block is the intra mode, the prediction encoder 4010 may determine a method of determining an intra prediction mode. Information indicating a method of determining an intra mode may be included in the bitstream via the generator 4020.

In an embodiment, the method of determining an intra prediction mode may include a method of deriving an intra prediction mode based on a gradient or a method of selecting any one intra prediction mode among a plurality of intra prediction modes based on costs. In terms of a rate-distortion, the prediction encoder 4010 may select one method among the method of deriving an intra prediction mode based on a gradient or the method of selecting any one intra prediction mode among a plurality of intra prediction modes based on costs.

In an embodiment, the information indicating a method of determining an intra prediction mode may be included in a sequence parameter set, a picture parameter set, a slice header, or slice data of the bitstream. In an example, the slice data may include information to be signaled at a level of a coding tree, a coding unit, a transform tree, or a transform unit.

In an embodiment, the prediction encoder 4010 may determine an intra prediction mode of the current block, according to a predetermined any one method.

In an embodiment, when the method of determining an intra prediction mode corresponds to the method of selecting any one intra prediction mode among a plurality of intra prediction modes based on costs, the prediction encoder 4010 may select, among the plurality of intra prediction modes, an intra prediction mode that causes the least costs in encoding the current block. Information indicating the selected intra prediction mode may be included in the bitstream. For example, the information indicating an intra prediction mode of a current block may include a flag or an index which indicates any one intra prediction mode among the plurality of intra prediction modes.

When the method determining an intra prediction mode corresponds to the method of deriving an intra prediction mode based on a gradient, the prediction encoder 4010 may derive an intra prediction mode by using the same method by the image decoding apparatus 2000.

When a prediction block is generated via intra prediction with respect to the current block, the prediction encoder 4010 may encode the current block by using the prediction block.

In an embodiment, the prediction encoder 4010 may generate residual data corresponding to a difference between the prediction block and the current block. The residual data may be included in the bitstream.

In an embodiment, the prediction encoder 4010 may derive an intra prediction mode of the current block, based on a gradient between at least two samples included in a neighboring area of the current block. The prediction encoder 4010 may calculate the gradient by using at least two samples included in the neighboring area of the current block. The prediction encoder 4010 may generate gradient information by accumulating the calculated gradient.

In an embodiment, the prediction encoder 4010 may obtain the gradient between at least two samples included in the neighboring area of the current block, by using a predefined filter. Also, the prediction encoder 4010 may generate the gradient information of the current block, based on the obtained gradient.

Also, in an embodiment, the prediction encoder 4010 may obtain gradient information of a previous block encoded prior to the current block, and may generate gradient information of the current block by using the obtained gradient information.

The embodiments of configuring gradient information which are described above with reference to FIGS. 23 to 26 and FIGS. 29 to 38 may be applied as the substantially same method by the prediction encoder 4010. In this regard, redundant descriptions are not provided here.

In an embodiment, the prediction encoder 4010 may obtain the gradient information of the previous block which includes a second value exceeding a predefined threshold among second values corresponding to intra prediction modes calculated from a gradient between at least two samples included in the previous block or between at least two samples adjacent to the previous block, and a first value corresponding to the second value exceeding the predefined threshold.

In an embodiment, the threshold may be predefined as a fixed value or a value determined according to a bit depth.

In an embodiment, the prediction encoder 4010 may obtain the gradient information of the previous block which includes a second value corresponding to a third value that is a summation of a first result obtained by summing horizontal-direction gradients calculated from all sample sets included in the previous block and a second result obtained by summing vertical-direction gradients calculated from all sample sets included in the previous block, and a first value corresponding to the second value.

Also, in an embodiment, the prediction encoder 4010 may obtain the gradient information of the previous block which includes a value obtained by performing, based on the number of samples included in all sample sets, normalization on a second value corresponding to a third result that is a summation of a first result obtained by summing horizontal-direction gradients calculated from all sample sets included in the previous block and a second result obtained by summing vertical-direction gradients calculated from all sample sets included in the previous block, and a first value corresponding to the corresponding value.

In an embodiment, a previous block may include a reference block that is specified in a reference picture of a current block according to motion information of a spatial or temporal neighboring block of the current block.

In an embodiment, the previous block may include the reference block that is specified by a block vector of the current block in a current picture including the current block.

In an embodiment, the prediction encoder 4010 may generate the gradient information of the current block by using the obtained gradient information.

In an embodiment, the prediction encoder 4010 may generate the gradient information of the current block by summing amplitudes for each intra prediction mode included in gradient information of a plurality of previous blocks, based on each corresponding intra prediction mode. In other words, the prediction encoder 4010 may generate the gradient information of the current block by summing second values included in the gradient information of a plurality of previous blocks, based on each corresponding intra prediction mode.

In an embodiment, the prediction encoder 4010 may derive an intra prediction mode based on the generated gradient information. In an example, the prediction encoder 4010 may derive a plurality of intra prediction modes, based on the gradient information. A maximum number of intra prediction modes to be derived may be predefined. For example, the maximum number may be defined as 2, 3, 4, 5, etc. For example, a predetermined number of intra prediction modes in descending order of amplitude among intra prediction modes included in the generated gradient information may be derived as an intra prediction mode of the current block.

In an embodiment, the prediction encoder 4010 may generate the prediction block of the current block by performing intra prediction on the current block using the intra prediction mode. The prediction encoder 4010 may generate a predictor by using the derived intra prediction mode.

In an embodiment, the prediction encoder 4010 may generate a final prediction block by combining predictors generated according to the derived intra prediction mode. In an example, the prediction encoder 4010 may generate the final prediction block by performing the weighted sum of the predictor generated according to the derived intra prediction mode and a predictor generated according to a planar mode. The embodiment of generating a final prediction block by using the weighted sum of a predictor which is described with reference to FIGS. 27 and 28 may be substantially equally applied to the present embodiment, and in this regard, redundant descriptions are not provided here.

In an embodiment, the prediction encoder 4010 may encode the current block by using the prediction block. A bitstream may be generated as a result of encoding the current block. In an embodiment, the image encoding apparatus 4000 may obtain residual data corresponding to a difference between the prediction block and an original block, and information about the residual data may be included in the bitstream.

In an embodiment, an operation of the prediction encoder 4010 of the image encoding apparatus 4000 may be equal to an operation of the prediction decoder 2030 of the image decoding apparatus 2000, and thus, descriptions of the operation of the prediction decoder 2030 may be equally applied to the prediction encoder 4010.

The generator 4020 may generate the bitstream including a result of encoding a picture. The bitstream may include a result of encoding a current block.

In an embodiment, the generator 4020 may transmit the bitstream to the image decoding apparatus 2000 via a network.

In an embodiment, the generator 4020 may store the bitstream in a data storage medium including a magnetic medium such as a hard disk, a floppy disk, and a magnetic tape, an optical recording medium such as CD-ROM and DVD, a magneto-optical medium such as a floptical disk, or the like.

The generator 4020 may generate the bitstream including syntax elements generated by encoding a picture. Values corresponding to the syntax elements may be included in the bitstream, according to a hierarchical structure of the picture.

The generator 4020 may obtain bins included in the bitstream, by entropy encoding the syntax elements.

In an embodiment, the bitstream may include information about a prediction mode of a current block in a current picture.

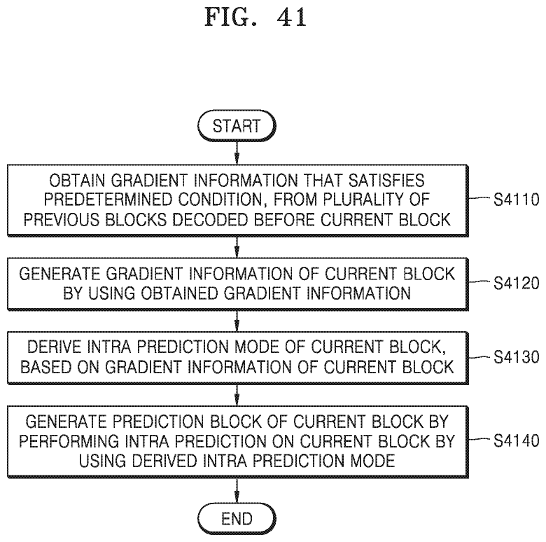

FIG. 41 is a flowchart of an image encoding method according to an embodiment.

In operation S4110, the image encoding apparatus 4000 may obtain gradient information from a plurality of previous blocks encoded prior to a current block. Here, the gradient information may include a first value corresponding to at least one intra prediction mode, and a second value corresponding to the first value.

In an embodiment, gradient information that satisfies a predetermined condition may be obtained from a first previous block among the plurality of previous blocks. The gradient information that satisfies the predetermined condition and is obtained from the first previous block may include a second value exceeding a predefined threshold among amplitudes corresponding to intra prediction mode and being calculated from a gradient between at least two samples included in the first previous block or between at least two samples adjacent to the first previous block, and a first value corresponding to the second value exceeding the threshold.

In an embodiment, the threshold may be predefined as a fixed value or a value determined according to a bit depth.

In an embodiment, the gradient information that satisfies the predetermined condition may be obtained from a second previous block among the plurality of previous blocks. The gradient information that satisfies the predetermined condition and is obtained from the second previous block may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value. In an example, as described above with reference to FIGS. 32 to 34, the gradient information of the second previous block may include one first value.

Alternatively, in an embodiment, the gradient information that satisfies the predetermined condition may be obtained from a third previous block among the plurality of previous blocks. The gradient information that satisfies the predetermined condition and is obtained from the third previous block may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value. In an example, as described above with reference to FIGS. 32 to 34, the gradient information of the third previous block may include one first value.

In an embodiment, a previous block may include a reference block that is specified in a reference picture of a current block according to motion information of a spatial or temporal neighboring block of the current block.

In an embodiment, the previous block may include the reference block that is specified by a block vector of the current block in a current picture including the current block.

In operation S4120, the image encoding apparatus 4000 may generate gradient information of the current block by using the obtained gradient information.

The embodiments of configuring gradient information which are described above with reference to FIGS. 23 to 26, and FIGS. 29 to 38 may be applied as the substantially same method by the image encoding apparatus 4000. In this regard, redundant descriptions are not provided here.

In an embodiment, the image encoding apparatus 4000 may generate the gradient information of the current block by summing amplitudes for each intra prediction mode included in gradient information of a plurality of previous blocks, based on each corresponding intra prediction mode. In other words, the image encoding apparatus 4000 may generate the gradient information of the current block by summing second values included in the gradient information of a plurality of previous blocks, based on each corresponding intra prediction mode.

In operation S4130, the image encoding apparatus 4000 may derive an intra prediction mode of the current block, based on the gradient information of the current block.

In an embodiment, the image encoding apparatus 4000 may derive, as the intra prediction mode of the current block, intra prediction modes corresponding to a predetermined number of amplitudes having largest sizes among amplitudes corresponding to the intra prediction modes included in the gradient information of the current block. In other words, the image encoding apparatus 4000 may derive, as the intra prediction mode of the current block, intra prediction modes corresponding to a predetermined number of largest second values among second values included in the gradient information of the plurality of previous blocks.

In operation S4140, the image encoding apparatus 4000 may generate a prediction block of the current block by performing intra prediction on the current block using the derived intra prediction mode.

In an embodiment, when a plurality of intra prediction modes are derived by using the gradient information of the current block, the image encoding apparatus 4000 may generate temporary prediction blocks, based on each of the derived plurality of intra prediction modes and a planar mode. The image encoding apparatus 4000 may generate the prediction block of the current block by performing the weighted sum of the temporary prediction blocks.

In an embodiment, the image encoding apparatus 4000 may encode the current block by using the prediction block. A bitstream may be generated as a result of encoding the current block.

In an embodiment, the image encoding apparatus 4000 may determine the prediction block as a reconstructed current block.

In an embodiment, the image encoding apparatus 4000 may obtain residual data corresponding to a difference between the prediction block and an original block, and information about the residual data may be included in the bitstream.

According to an embodiment, the image encoding method and apparatus 4000 and the image decoding method and apparatus 2000 may improve performance of prediction encoding and prediction decoding with respect to a current block.

According to an embodiment, the image encoding method and apparatus 4000 and the image decoding method and apparatus 2000 may decrease the amount of data required to signal an intra prediction mode.

According to an embodiment, the image encoding method and apparatus 4000 and the image decoding method and apparatus 2000 may decrease a bitrate of a bitstream.

The technical features aimed to be achieved in the present disclosure are not limited to the aforementioned technical features, and other unstated technical features will be clearly understood by one of ordinary skill in the art in view of descriptions below.

According to an embodiment, an image decoding method may include obtaining gradient information from a plurality of previous blocks decoded prior to a current block.

According to an embodiment, the gradient information may include at least one intra prediction mode and amplitude corresponding to the at least one intra prediction mode.

According to an embodiment, the gradient information may include a first value corresponding to the at least one intra prediction mode, and a second value corresponding to an intensity of the first value.

According to an embodiment, the image decoding method may include generating gradient information of the current block by using the obtained gradient information.

According to an embodiment, the image decoding method may include deriving an intra prediction mode of the current block, based on at least one amplitude corresponding to the at least one intra prediction mode included in the gradient information of the current block.

According to an embodiment, the image decoding method may include generating a prediction block of the current block by performing intra prediction on the current block using the derived intra prediction mode.

According to an embodiment, gradient information that satisfies a predetermined condition and is obtained from a first previous block among the plurality of previous blocks may include a second value exceeding a predefined threshold among second values calculated from a gradient between at least two samples included in the first previous block or between at least two samples adjacent to the first previous block, and a first value corresponding to the second value exceeding the threshold.

According to an embodiment, the threshold may be predefined as a fixed value or a value determined according to a bit depth.

According to an embodiment, a previous block may be provided in plural.

According to an embodiment, the image decoding method may include generating the gradient information of the current block by summing amplitudes for each intra prediction mode included in gradient information of a plurality of previous blocks, based on each corresponding intra prediction mode.

According to an embodiment, the image decoding method may include generating the gradient information of the current block by summing second values included in the gradient information of the plurality of previous blocks, based on each corresponding intra prediction mode.

According to an embodiment, the image decoding method may include deriving, as the intra prediction mode of the current block, intra prediction modes corresponding to a predetermined number of largest second values among second values included in the gradient information of the current block.

According to an embodiment, the gradient information that satisfies the predetermined condition and is obtained from a second previous block among the plurality of previous blocks may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value.

According to an embodiment, the gradient information that satisfies the predetermined condition and is obtained from a third previous block among the plurality of previous blocks may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value.

According to an embodiment, a previous block may include a reference block that is specified in a reference picture of the current block according to motion information of a spatial or temporal neighboring block of the current block.

According to an embodiment, the previous block may include a reference block that is specified by a block vector of the current block in a current picture including the current block.

According to an embodiment, the block vector may be derived based on an intra block copy mode or an intra template matching mode.

According to an embodiment, the image decoding method may include generating, when a plurality of intra prediction modes are derived by using the gradient information of the current block, temporary prediction blocks, based on each of the derived plurality of intra prediction modes and a planar mode.

According to an embodiment, the image decoding method may include generating the prediction block of the current block by performing the weighted sum of the temporary prediction blocks.

According to an embodiment, an image decoding apparatus may include at least one memory storing at least one instruction; and at least one processor configured to operate according to the at least one instruction.

In an embodiment, the at least one processor may be configured to obtain gradient information that satisfies a predetermined condition, from a plurality of previous blocks decoded prior to a current block.

According to an embodiment, the gradient information may include at least one intra prediction mode, and amplitude corresponding to the at least one intra prediction mode.

According to an embodiment, the gradient information may include a first value corresponding to at least one intra prediction mode, and a second value corresponding to an intensity of the first value.

In an embodiment, the at least one processor may be configured to generate gradient information of the current block using the obtained gradient information.

In an embodiment, the at least one processor may be configured to derive an intra prediction mode of the current block, based on at least one amplitude corresponding to the at least one intra prediction mode which is included in the gradient information of the current block.

In an embodiment, the at least one processor may be configured to generate a prediction block of the current block by performing intra prediction on the current block using the derived intra prediction mode.

According to an embodiment, gradient information that satisfies a predetermined condition and is obtained from a first previous block among the plurality of previous blocks may include a second value exceeding a predefined threshold among second values calculated from a gradient between at least two samples included in the first previous block or between at least two samples adjacent to the first previous block, and a first value corresponding to the second value exceeding the threshold.

According to an embodiment, the threshold may be predefined as a fixed value or a value determined according to a bit depth.

According to an embodiment, a previous block may be provided in plural.

In an embodiment, the at least one processor may be configured to generate the gradient information of the current block by summing amplitudes for each intra prediction mode included in gradient information of a plurality of previous blocks, based on each corresponding intra prediction mode.

In an embodiment, the at least one processor may be configured to generate the gradient information of the current block by summing second values included in the gradient information of the plurality of previous blocks, based on each corresponding intra prediction mode.

In an embodiment, the at least one processor may be configured to derive, as the intra prediction mode of the current block, intra prediction modes corresponding to a predetermined number of largest second values among second values included in the gradient information of the current block.

According to an embodiment, the gradient information that satisfies the predetermined condition and is obtained from a second previous block among the plurality of previous blocks may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value.

According to an embodiment, the gradient information that satisfies the predetermined condition and is obtained from a third previous block among the plurality of previous blocks may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value.

According to an embodiment, a previous block may include a reference block that is specified in a reference picture of the current block according to motion information of a spatial or temporal neighboring block of the current block.

According to an embodiment, the previous block may include a reference block that is specified by a block vector of the current block in a current picture including the current block.

According to an embodiment, the block vector may be derived based on an intra block copy mode or an intra template matching mode.

In an embodiment, the at least one processor may be configured to generate, when a plurality of intra prediction modes are derived by using the gradient information of the current block, temporary prediction blocks, based on each of the derived plurality of intra prediction modes and a planar mode.

In an embodiment, the at least one processor may be configured to generate the prediction block of the current block by performing the weighted sum of the temporary prediction blocks.

According to an embodiment, an image encoding method may include obtaining gradient information from a plurality of previous blocks encoded prior to a current block.

According to an embodiment, the gradient information may include at least one intra prediction mode, and amplitude corresponding to the at least one intra prediction mode.

According to an embodiment, the gradient information may include a first value corresponding to at least one intra prediction mode, and a second value corresponding to an intensity of the first value.

According to an embodiment, the image encoding method may include generating gradient information of the current block by using the obtained gradient information.

According to an embodiment, the image encoding method may include deriving an intra prediction mode of the current block, based on at least one amplitude corresponding to the at least one intra prediction mode which is included in the gradient information of the current block.

According to an embodiment, the image encoding method may include generating a prediction block of the current block by performing intra prediction on the current block using the derived intra prediction mode.

According to an embodiment, gradient information that satisfies a predetermined condition and is obtained from a first previous block among the plurality of previous blocks may include a second value exceeding a predefined threshold among second values calculated from a gradient between at least two samples included in the first previous block or between at least two samples adjacent to the first previous block, and a first value corresponding to the second value exceeding the threshold.

According to an embodiment, the threshold may be predefined as a fixed value or a value determined according to a bit depth.

According to an embodiment, a previous block may be provided in plural.

According to an embodiment, the image encoding method may include generating the gradient information of the current block by summing amplitudes for each intra prediction mode included in gradient information of a plurality of previous blocks, based on each corresponding intra prediction mode.

According to an embodiment, the image encoding method may include generating the gradient information of the current block by summing second values included in the gradient information of the plurality of previous blocks, based on each corresponding intra prediction mode.

According to an embodiment, the image encoding method may include deriving, as the intra prediction mode of the current block, intra prediction modes corresponding to a predetermined number of largest second values among second values included in the gradient information of the current block.

According to an embodiment, the gradient information that satisfies the predetermined condition and is obtained from a second previous block among the plurality of previous blocks may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value.

According to an embodiment, the gradient information that satisfies the predetermined condition and is obtained from a third previous block among the plurality of previous blocks may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value.

According to an embodiment, a previous block may include a reference block that is specified in a reference picture of the current block according to motion information of a spatial or temporal neighboring block of the current block.

According to an embodiment, the previous block may include a reference block that is specified by a block vector of the current block in a current picture including the current block.

According to an embodiment, the block vector may be derived based on an intra block copy mode or an intra template matching mode.

According to an embodiment, the image encoding method may include generating, when a plurality of intra prediction modes are derived by using the gradient information of the current block, temporary prediction blocks, based on each of the derived plurality of intra prediction modes and a planar mode.

According to an embodiment, the image encoding method may include generating the prediction block of the current block by performing the weighted sum of the temporary prediction blocks.

According to an embodiment, the image encoding method may include encoding the current block by using the prediction block.

According to an embodiment, an intra prediction mode may be derived from a neighboring area, and thus, a bitrate of a bitstream may be decreased.

According to an embodiment, an image encoding apparatus may include at least one memory storing at least one instruction; and at least one processor configured to operate according to the at least one instruction.

In an embodiment, the at least one processor may be configured to obtain gradient information that satisfies a predetermined condition, from a plurality of previous blocks encoded prior to a current block.

According to an embodiment, the gradient information may include at least one intra prediction mode, and amplitude corresponding to the at least one intra prediction mode.

According to an embodiment, the gradient information may include a first value corresponding to at least one intra prediction mode, and a second value corresponding to an intensity of the first value.

In an embodiment, the at least one processor may be configured to generate gradient information of the current block using the obtained gradient information.

In an embodiment, the at least one processor may be configured to derive an intra prediction mode of the current block, based on at least one amplitude corresponding to the at least one intra prediction mode which is included in the gradient information of the current block.

In an embodiment, the at least one processor may be configured to generate a prediction block of the current block by performing intra prediction on the current block using the derived intra prediction mode.

According to an embodiment, gradient information that satisfies a predetermined condition and is obtained from a first previous block among the plurality of previous blocks may include a second value exceeding a predefined threshold among second values calculated from a gradient between at least two samples included in the first previous block or between at least two samples adjacent to the first previous block, and a first value corresponding to the second value exceeding the threshold.

According to an embodiment, the threshold may be predefined as a fixed value or a value determined according to a bit depth.

According to an embodiment, a previous block may be provided in plural.

In an embodiment, the at least one processor may be configured to generate the gradient information of the current block by summing amplitudes for each intra prediction mode included in gradient information of a plurality of previous blocks, based on each corresponding intra prediction mode.

In an embodiment, the at least one processor may be configured to generate the gradient information of the current block by summing second values included in the gradient information of the plurality of previous blocks, based on each corresponding intra prediction mode.

In an embodiment, the at least one processor may be configured to derive, as the intra prediction mode of the current block, intra prediction modes corresponding to a predetermined number of largest second values among second values corresponding to intra prediction modes included in the gradient information of the current block.

According to an embodiment, the gradient information that satisfies the predetermined condition and is obtained from a second previous block among the plurality of previous blocks may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value.

According to an embodiment, the gradient information that satisfies the predetermined condition and is obtained from a third previous block among the plurality of previous blocks may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value.

According to an embodiment, a previous block may include a reference block that is specified in a reference picture of the current block according to motion information of a spatial or temporal neighboring block of the current block.

According to an embodiment, the previous block may include a reference block that is specified by a block vector of the current block in a current picture including the current block.

According to an embodiment, the block vector may be derived based on an intra block copy mode or an intra template matching mode.

In an embodiment, the at least one processor may be configured to generate, when a plurality of intra prediction modes are derived by using the gradient information of the current block, temporary prediction blocks, based on each of the derived plurality of intra prediction modes and a planar mode.

In an embodiment, the at least one processor may be configured to generate the prediction block of the current block by performing the weighted sum of the temporary prediction blocks.

In an embodiment, the at least one processor may be configured to encode the current block by using the prediction block.

According to an embodiment, in a computer-readable recording medium having recorded thereon a bitstream, the bitstream may include an encoding result of a current block.

In an embodiment, the encoding result of the current block may be generated by obtaining gradient information from a plurality of previous blocks encoded prior to the current block.

According to an embodiment, the gradient information may include at least one intra prediction mode, and amplitude corresponding to the at least one intra prediction mode.

According to an embodiment, the gradient information may include a first value corresponding to at least one intra prediction mode, and a second value corresponding to an intensity of the first value.

In an embodiment, the encoding result of the current block may be generated by generating gradient information of the current block by using the obtained gradient information.

In an embodiment, the encoding result of the current block may be generated by deriving an intra prediction mode of the current block, based on at least one amplitude corresponding to the at least one intra prediction mode included in the gradient information of the current block.

In an embodiment, the encoding result of the current block may be generated by generating a prediction block of the current block by performing intra prediction on the current block using the derived intra prediction mode.

According to an embodiment, gradient information that satisfies a predetermined condition and is obtained from a first previous block among the plurality of previous blocks may include a second value exceeding a predefined threshold among second values calculated from a gradient between at least two samples included in the first previous block or between at least two samples adjacent to the first previous block, and a first value corresponding to the second value exceeding the threshold.

According to an embodiment, the threshold may be predefined as a fixed value or a value determined according to a bit depth.

According to an embodiment, a previous block may be provided in plural.

According to an embodiment, the encoding result of the current block may be generated by generating the gradient information of the current block by summing amplitudes for each intra prediction mode included in gradient information of a plurality of previous blocks, based on each corresponding intra prediction mode.

According to an embodiment, the encoding result of the current block may be generated by generating the gradient information of the current block by summing second values included in the gradient information of the plurality of previous blocks, based on each corresponding intra prediction mode.

In an embodiment, the encoding result of the current block may be generated by deriving, as the intra prediction mode of the current block, intra prediction modes corresponding to a predetermined number of largest second values among second values corresponding to intra prediction modes included in the gradient information of the current block.

According to an embodiment, the gradient information that satisfies the predetermined condition and is obtained from a second previous block among the plurality of previous blocks may include a second value corresponding to a third result that is a summation of a first result obtained by summing horizontal-direction gradients calculated from all sample sets included in the second previous block and a second result obtained by summing vertical-direction gradients calculated from all sample sets included in the second previous block, and a first value corresponding to the second value.

According to an embodiment, the gradient information that satisfies the predetermined condition and is obtained from a second previous block among the plurality of previous blocks may include a value obtained by performing, based on the number of samples included in all sample sets, normalization on a second value corresponding to a third result that is a summation of a first result obtained by summing horizontal-direction gradients calculated from all sample sets included in the third previous block and a second result obtained by summing vertical-direction gradients calculated from all sample sets included in the third previous block, and a first value corresponding to the corresponding value.

According to an embodiment, a previous block may include a reference block that is specified in a reference picture of the current block according to motion information of a spatial or temporal neighboring block of the current block.

According to an embodiment, the previous block may include a reference block that is specified by a block vector of the current block in a current picture including the current block.

According to an embodiment, the block vector may be derived based on an intra block copy mode or an intra template matching mode.

In an embodiment, the encoding result of the current block may be generated by generating, when a plurality of intra prediction modes are derived by using the gradient information of the current block, temporary prediction blocks, based on each of the derived plurality of intra prediction modes and a planar mode.

In an embodiment, the encoding result of the current block may be generated by generating the prediction block of the current block by performing the weighted sum of the temporary prediction blocks.

In an embodiment, the encoding result of the current block may be generated by encoding the current block by using the prediction block.

According to an embodiment, the image encoding method and apparatus 4000 and the image decoding method and apparatus 2000 may improve performance of prediction encoding and prediction decoding with respect to a current block.

According to an embodiment, the image encoding method and apparatus 4000 and the image decoding method and apparatus 2000 may decrease the amount of data required to signal an intra prediction mode.

According to an embodiment, the image encoding method and apparatus 4000 and the image decoding method and apparatus 2000 may decrease a bitrate of a bitstream.

The effects aimed to be achieved in the present disclosure are not limited to the aforementioned effects, and other unstated effects will be clearly understood by one of ordinary skill in the art in view of descriptions below.

The embodiments of the present disclosure described above may be written as computer-executable programs that may be stored in a machine-readable storage medium.

A machine-readable storage medium may be provided in a form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment, a method according to various embodiments disclosed in the present specification may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

While embodiments of the present disclosure are described in detail with reference to exemplary embodiments above, it will be understood by one of ordinary skill in the art that the present disclosure is not limited to the embodiments, and various changes in form and details may be made therein without departing from the spirit and scope of the present disclosure.

What is claimed is:

1. An image decoding method comprising:
obtaining gradient information that satisfies a predetermined condition, from a plurality of previous blocks of an image decoded prior to a current block of the image, wherein the gradient information comprises a first value corresponding to at least one intra prediction mode, and a second value corresponding to an intensity of the first value;
generating gradient information of the current block based on the gradient information that satisfies the predetermined condition;
deriving an intra prediction mode of the current block, based on the gradient information of the current block;
generating a prediction block of the current block by performing intra prediction on the current block using the intra prediction mode of the current block; and
reconstructing the current block based on the prediction block.

2. The image decoding method of claim 1, wherein the obtaining the gradient information that satisfies the predetermined condition comprises obtaining the gradient information from a first previous block among the plurality of previous blocks, and
wherein the second value exceeds a predefined threshold among second values calculated from a gradient between at least two samples comprised in the first previous block or between at least two samples adjacent to the first previous block, and the first value corresponds to the second value exceeding the predefined threshold.

3. The image decoding method of claim 2, wherein the predefined threshold is predefined as a fixed value or a value determined according to a bit depth.

4. The image decoding method of claim 2, wherein the generating the gradient information of the current block comprises generating the gradient information of the current block by summing second values comprised in the gradient information of the plurality of previous blocks, based on each corresponding intra prediction mode.

5. The image decoding method of claim 4, wherein the deriving the intra prediction mode of the current block comprises deriving, as the intra prediction mode of the current block, intra prediction modes corresponding to a predetermined number of largest second values among second values comprised in the gradient information of the current block.

6. The image decoding method of claim 1, wherein the obtaining the gradient information that satisfies the predetermined condition comprises obtaining the gradient information from a second previous block among the plurality of previous blocks, and
wherein the second value corresponds to a third result that is a summation of a first result obtained by summing horizontal-direction gradients calculated from all sample sets comprised in the second previous block and a second result obtained by summing vertical-direction gradients calculated from all sample sets comprised in the second previous block, and the first value corresponds to the second value.

7. The image decoding method of claim 1, wherein the obtaining the gradient information that satisfies the predetermined condition comprises obtaining the gradient information from a third previous block among the plurality of previous blocks, and
wherein the gradient information comprises a value obtained by performing, based on a number of samples comprised in all sample sets, normalization on a second value corresponding to a third result that is a summation of a first result obtained by summing horizontal-direction gradients calculated from all sample sets comprised in the third previous block and a second result obtained by summing vertical-direction gradients calculated from all sample sets comprised in the third previous block, and the first value corresponds to the value.

8. The image decoding method of claim 1, wherein the plurality of previous blocks comprises a reference block specified in a reference picture of the current block according to motion information of a spatial or temporal neighboring block of the current block.

9. The image decoding method of claim 1, wherein the plurality of previous blocks comprises a reference block specified by a block vector of the current block in a current picture comprising the current block.

10. The image decoding method of claim 1, wherein the generating the prediction block of the current block comprises:
based on a plurality of intra prediction modes being determined based on the gradient information of the current block, generating temporary prediction blocks, based on each of the plurality of intra prediction modes and a planar mode; and
generating the prediction block of the current block by performing a weighted sum of the temporary prediction blocks.

11. An image decoding apparatus comprising:
at least one memory storing at least one instruction; and
at least one processor,
wherein the at least one instruction, when executed by the at least one processor individually or collectively, causes the image decoding apparatus to:
obtain gradient information that satisfies a predetermined condition, from a plurality of previous blocks of an image decoded prior to a current block of the image, wherein the gradient information comprises a first value corresponding to at least one intra prediction mode, and a second value corresponding to an intensity of the first value,
generate gradient information of the current block based on the gradient information that satisfies the predetermined condition,
derive an intra prediction mode of the current block, based on the gradient information of the current block,
generate a prediction block of the current block by performing intra prediction on the current block using the intra prediction mode of the current block, and
reconstruct the current block based on the prediction block.

12. An image encoding method comprising:
obtaining gradient information that satisfies a predetermined condition, from a plurality of previous blocks of an image encoded prior to a current block of the image, wherein the gradient information comprises a first value corresponding to at least one intra prediction mode, and a second value corresponding to an intensity of the first value;
generating gradient information of the current block based on the gradient information that satisfies the predetermined condition;
determining an intra prediction mode of the current block, based on the gradient information of the current block;
generating a prediction block of the current block by performing intra prediction on the current block using the intra prediction mode of the current block; and
encoding the current block based on the prediction block of the current block.

13. An image encoding apparatus comprising:
at least one memory storing at least one instruction; and
at least one processor,
wherein the at least one instruction, when executed by the at least one processor individually or collectively, causes the image encoding apparatus to:
obtain gradient information that satisfies a predetermined condition, from a plurality of previous blocks of an image encoded prior to a current block of the image, wherein the gradient information comprises a first value corresponding to at least one intra prediction mode, and a second value corresponding to an intensity of the first value,
generate gradient information of the current block based on the gradient information that satisfies the predetermined condition,
determine an intra prediction mode of the current block, based on the gradient information of the current block,
generate a prediction block of the current block by performing intra prediction on the current block using the intra prediction mode of the current block, and
encode the current block based on the prediction block of the current block.

14. A non-transitory computer-readable storage medium recording a bitstream generated by an image encoding method, wherein the image encoding method comprising:
obtaining gradient information that satisfies a predetermined condition, from a plurality of previous blocks of an image encoded prior to a current block of the image, wherein the gradient information that satisfies the predetermined condition comprises a first value corresponding to at least one intra prediction mode, and a second value corresponding to an intensity of the first value,
generating gradient information of the current block based the gradient information that satisfies the predetermined condition,
determining an intra prediction mode of the current block, based on the gradient information of the current block,
generating a prediction block of the current block by performing intra prediction on the current block using the intra prediction mode of the current block, and
encoding the current block based on the prediction block.
